(19) United States
(12) Patent Application Publication
(10) Pub. No.: US 2014/0039136 A1
(43) Pub. Date: Feb. 6, 2014

(54) THERMOSET CROSS-LINKED NETWORK

(71) Applicants: Tamara Dikic, Bergen op Zoom (NL); Tom Verbrugge, Mariakerke (BE); Matteo Traina, Tenno (IT); Jocelyne Galy, Villeurbanne (FR); Jean-Francois Gerard, Bron (FR); Ludo Aerts, Mariakerke (BE)

(72) Inventors: Tamara Dikic, Bergen op Zoom (NL); Tom Verbrugge, Mariakerke (BE); Matteo Traina, Tenno (IT); Jocelyne Galy, Villeurbanne (FR); Jean-Francois Gerard, Bron (FR); Ludo Aerts, Mariakerke (BE)

(73) Assignee: DOW GLOBAL TECHNOLOGIES LLC, MIDLAND, MI (US)

(21) Appl. No.: 14/111,744

(22) PCT Filed: Apr. 16, 2012
(86) PCT No.: PCT/US12/33763

§ 371 Date: Oct. 14, 2013

Related U.S. Application Data
(60) Provisional application No. 61/476,104, filed on Apr. 15, 2011.

(51) Int. Cl. C08G 59/14

(52) U.S. Cl. CPC C08G 59/1494
USPC 525/526

(57) ABSTRACT

Embodiments of the present disclosure include a thermoset cross-linked network and a method of producing the thermoset cross-linked network from a reaction product of a curable epoxy system in a liquid phase and cross-linked reactive polymer microparticles in a solid phase. For the various embodiments, the cross-linked reactive polymer microparticles have a cross-link density and reactive groups that covalently react with the curable epoxy system to provide the thermoset cross-linked network in a single contiguous phase having a topological heterogeneity.

### CROSS-REFERENCE TO RELATED APPLICATIONS

This application claims the benefit under 35 U.S.C. §119(e) of U.S. Provisional Patent Application No. 61/476,104, filed Apr. 15, 2011, which is incorporated herein by reference in its entirety.

### FIELD OF DISCLOSURE

This disclosure relates to polymers and in particular to thermoset cross-linked networks.

### BACKGROUND

Toughness is the ability of a material to absorb energy and plastically deform without rupture and as a consequence the material will resist fracture when under stress. Polymers are often modified to improve their toughness. This is especially true with glassy polymers, such as thermosets with high cross-link densities. Such modifications can include the incorporation of a second phase consisting of particles that are usually spherical and of a rubbery polymer having a glass transition temperature, Tg, which is below the glassy polymers. The addition of this second phase can lead to improvements in the mechanical behavior of the glassy polymer.

In addition to having a lower Tg, the rubbery particles also typically have a modulus that is lower than the glassy polymers, which leads to stress concentrations at the equators of the particles during mechanical deformation. These stress concentrations can lead to shear yielding or crazing around the particles and throughout a large volume of the material. In this way, the glassy polymer can absorb a large amount of energy during deformation and is toughened.

In addition to rubber polymers, crosslinked particles having chemistries varying from acrylic to epoxy to urethane are also utilized as toughening agents. They are mainly produced by dispersion polymerization and stabilized by surfactants. Theses surfactants are either chemically or physically bounded to the particle surface. Once the toughening agents are incorporated into the final product, the interface created by the presence of surfactant between particles and the surrounding network is usually the place of the mechanical breakdown thus the toughening is achieved.

The presence of an interface, however, can also be a cause of premature, degradation and poor barrier properties, among other issues. In addition, formulations containing toughening particles, often need to be reformulated with the compatibilizer that will provide better wetting of the particles with the formulation. The presence of a surface active compound in the formulation can often result in its migration to the surface, which impacts the coatability of these networks. Therefore a number of applications, such as coatings and composites, would benefit from fully integrating the toughening agents.

### SUMMARY

Embodiments of the present disclosure provide for a thermoset cross-linked network having toughening agents fully integrated into a curable epoxy system, as discussed herein. Specifically, embodiments of the present disclosure include a thermoset cross-linked network formed as a reaction product of a curable epoxy system in a liquid phase and cross-linked reactive polymer microparticles in a solid phase. The cross-linked reactive polymer microparticles have a cross-link density and reactive groups that covalently react with the curable epoxy system to provide the thermoset cross-linked network in a single contiguous phase having a topological heterogeneity.

For the various embodiments, the curable epoxy system includes an epoxy resin and an amine hardener. For the various embodiments, the reactive groups of the cross-linked reactive polymer microparticles are amine groups that react with the epoxy resin of the curable epoxy system.

For the various embodiments, the topological heterogeneity of the thermoset cross-linked network includes a cross-link density of the reaction product of the curable epoxy system that is different than the cross-link density of the cross-linked reactive polymer microparticles. For the various embodiments, the cross-linked reactive polymer microparticles and the curable epoxy system are formed from the epoxy resin and the amine hardener. For the various embodiments, the epoxy resin and the amine hardener of the cross-linked reactive polymer microparticles and the epoxy curable epoxy system can be the same. In an alternative embodiment, the epoxy resin and the amine hardener of the cross-linked reactive polymer microparticles can be different than the epoxy resin and the amine hardener of the epoxy curable epoxy system. For the various embodiments, the thermoset cross-linked network includes 1 to 70 weight percent of the cross-linked reactive polymer microparticles. So, the thermoset cross-linked network includes 1 to 70 weight percent of the cross-linked reactive polymer microparticles based on the total weight of the thermoset cross-linked network.

For the various embodiments, the cross-linked reactive polymer microparticles are a reaction product of an epoxy resin and an amine curing agent reacted in a dispersing media at a temperature of 50° C. to 120° C. for a reaction time of no greater than 17 hours. During the reaction the cross-linked reactive polymer microparticles phase separate in a discrete non-agglomerated form from the dispersing media. The dispersing media bound to the cross-linked reactive polymer microparticles is at a concentration of no greater than 0.001 weight percent based on the weight of the cross-linked reactive polymer microparticles. So, the dispersing media bound to the cross-linked reactive polymer microparticles is no greater than 0.001 weight percent of the cross-linked reactive polymer microparticles based on the total weight of the cross-linked reactive polymer microparticles. For the various embodiments, the cross-linked reactive polymer microparticles are formed with an excess of the amine curing agent or the epoxy resin as expressed in an equivalent weight ratio. So, for example, the reaction product is formed with an excess of the amine curing agent or the epoxy resin as expressed in the equivalent weight ratio. Equivalent weight ratio, as used herein, uses the moles of amine hydrogen (from the amine curing agent) and the moles of epoxy groups (from the epoxy resin). For example, forming the cross-linked reactive polymer microparticles can be with an excess of the amine curing agent expressed using an equivalent weight ratio of 1.35 amine curing agent to 1 of the epoxy resin (e.g., a 0.35 excess moles of amine hydrogen to moles of epoxy groups, which is provided herein as the amine to epoxy ratio or “a/e ratio”).

For the various embodiments, the epoxy resin and the amine curing agent each have a concentration in the dispersing media of 5 to 30 weight percent based on the total weight of the dispersing media, the epoxy resin and the amine curing agent.

For the various embodiments, the cross-linked reactive polymer microparticles of the present disclosure include no surfactant.

The embodiments of the present disclosure also include a method of producing a thermoset cross-linked network. The method includes forming cross-linked reactive polymer microparticles by reacting an epoxy resin with an amine curing agent in a dispersing media at a temperature of 50° C. to 120° C. for a reaction time of no greater than 17 hours so that the cross-linked reactive polymer microparticles have no greater than 0.001 weight percent of the dispersing media bound to the cross-linked reactive polymer microparticles; phase separating the cross-linked reactive polymer microparticles and the dispersing media; and reacting a curable epoxy system in a liquid phase with the cross-linked reactive polymer microparticles in a solid phase, the cross-linked reactive polymer microparticles having a cross-link density and reactive groups that covalently react with the curable epoxy system to provide the thermoset cross-linked network in a single contiguous phase having a topological heterogeneity. The basis for the no greater than 0.001 weight percent of the dispersing media bound to the cross-linked reactive polymer microparticles is the total weight of the reactive polymer microparticles. The dispersing media bound to the cross-linked reactive polymer microparticles can be chemically bound so that the cross-linked reactive polymer microparticles have no greater than 0.001 weight percent of the dispersing media chemically bound to the cross-linked reactive polymer microparticles.

For the various embodiments, the method includes removing the dispersing media from the cross-linked reactive polymer microparticles to leave no greater than 0.001 weight, percent of the dispersing media bound to the cross-linked reactive polymer microparticles. The dispersing media bound to the cross-linked reactive polymer microparticles can be chemically bound so that the cross-linked reactive polymer microparticles have no greater than 0.001 weight percent of the dispersing media chemically bound to the cross-linked reactive polymer microparticles. For the various embodiments, reacting the epoxy resin with the amine curing agent includes forming the cross-linked reactive polymer microparticles with an excess of one of the amine curing agent and the epoxy resin as expressed in an equivalent weight ratio. For the various embodiments, the curable epoxy system includes an epoxy resin and an amine hardener.

For the various embodiments, the reactive groups of the cross-linked reactive polymer microparticles are amine groups that react with the epoxy resin of the curable epoxy system. For the various embodiments, the cross-linked reactive polymer microparticles can be formed with an excess of one of the amine curing agent or the epoxy resin. For the various embodiments, this excess can be expressed using an equivalent weight ratio, where, for example, the excess of the amine curing agent can be 1.35 to 1 (e.g., a 0.35 excess equivalent reactivity of the amine curing agent relative the epoxy resin). In other words, the equivalent weight ratio of 1.35 of the amine curing agent to 1 of the epoxy resin provides a 0.35 excess of moles of amine hydrogen in the amine curing agent relative to 1 mole of epoxy groups in the epoxy resin. For the various embodiments, using a solvent to remove the dispersing media from the cross-linked reactive polymer microparticles to leave no greater than 0.001 weight percent of the dispersing media bound to the cross-linked reactive polymer microparticles. The basis for the no greater than 0.001 weight percent of the dispersing media bound to the cross-linked reactive polymer microparticles is the total weight of the reactive polymer microparticles.

For the various embodiments, the epoxy resin and the amine curing agent each can have a concentration in the dispersing media of 5 to 30 weight percent based on the total weight of the dispersing media, the epoxy resin and the amine curing agent. For the various embodiments, the dispersing media is selected from the group consisting of poly(oxypropylene), dodecane, aliphatic ketone, cyclic ketone, alkene aliphatic, aromatic alkene, polyethers and combinations thereof.

For the various embodiments, the cross-linked reactive polymer microparticles of the present disclosure include no surfactant.

### BRIEF DESCRIPTION OF THE DRAWINGS

In the following Figures, the use of the abbreviation “CPM” represents the cross-linked reactive polymer microparticles.

FIG. 1A provides a DSC thermogram of DGEBA+DAT system (a/e ratio=1.35) according to the present disclosure.

FIG. 1B provides a glass transition temperature of a DGEBA+DAT system (a/e ratio=1.35) versus a/e ratio according to the present disclosure.

FIG. 2A provides a DSC thermogram of DGEBA+IPDA system (a/e ratio=1.35) according to the present disclosure.

FIG. 2B provides a glass transition temperature (Tg) DGEBA+IPDA system (a/e ratio=1.35) versus a/e ratio according to the present disclosure.

FIG. 3 provides a phase separation measurement, T=130° C., according to the present disclosure.

FIG. 4A-4C provide a SEC—where FIG. 4A: initial compounds (PPG-1000: D.E.R. 331: and DAT) c=3 mg/ml, RI signal; FIG. 4B: final residual solution and PPG-1000 at c=5 mg/ml, RI signal; and FIG. 4C: residual solution at c=5 mg/ml and DAT at c=0.01 mg/ml, according to the present disclosure.

FIG. 5 provides a thermogram of cross-linked reactive polymer microparticles, 1st scan and 2nd scan after 15 hours at 130° C., according to the present disclosure.

FIGS. 6A-6D: MDSC and TGA-MS Results for cross-linked reactive polymer microparticles (17 hours at 80° C.).

FIGS. 7A-7D: MDSC and TGA-MS Results for cross-linked reactive polymer microparticles (5 hours at 100° C.).

FIGS. 8A-8D: MDSC and TGA-MS Results for cross-linked reactive polymer microparticles (17 hours at 100° C.)

FIGS. 9A-9D: MDSC and TGA-MS Results for cross-linked reactive polymer microparticles (5 hours at 120° C.)

FIGS. 10A-10D: MDSC and TGA-MS Results for cross-linked reactive polymer microparticles (17 hours at 120° C.)

FIGS. 11A-11B: Overlay Plots for First Heating Results of Examples 14-18.

FIGS. 12A-12B: Overlay Plots for Second Heating Results of Examples 14-18.

FIGS. 13A-13B: An Overlay Plot for Second Heating Results of Examples 14-18.

FIGS. 14A-14D: MDSC and TGA-MS Results for dried cross-linked reactive polymer microparticles (17 hours at 80° C.).

FIGS. 15A-15D: MDSC and TGA-MS Results for dried cross-linked reactive polymer microparticles (17 hours at 100° C.).

FIGS. 16A-16D: MDSC and TGA-MS Results for dried cross-linked reactive polymer microparticles (5 hours at 120° C.).

FIGS. 17A-17D: MDSC and TGA-MS Results for dried cross-linked reactive polymer microparticles (17 hours at 120° C.).

FIGS. 18A-18B: Overlay of MDSC Results for First Heating Results of Examples 14-18, dried.

FIGS. 19A-19B: Overlay Plots for Second Heating Results of Examples 14-18, dried.

FIGS. 20A-20B: Comparison of TGA-MS Results for PPG, Cross-Linked Reactive Polymer Microparticles and Epoxy matrix.

FIGS. 21A-21B: Comparison of TGA-MS Results for PPG, Cross-Linked Reactive Polymer Microparticles and Epoxy matrix.

FIGS. 22A-22B: Identification of Evolving Species at Low Temperature: Cross-Linked Reactive Polymer Microparticles produced over 17 hrs at 80° C.

FIGS. 23A-23B: Identification of Evolving Species at Low Temperature: Cross-Linked Reactive Polymer Microparticles produced over 5 hrs at 100° C.

FIGS. 24A-24B: Identification of Evolving Species at Low Temperature: Cross-Linked Reactive Polymer Microparticles produced over 17 first at 100° C.

FIGS. 25A-25B: Identification of Evolving Species at Low Temperature: Cross-Linked Reactive Polymer Microparticles produced over 5 hrs at 120° C.

FIGS. 26A-26B: Identification of Evolving Species at Low Temperature: Cross-Linked Reactive Polymer Microparticles produced over 17 hrs at 120° C.

FIG. 27 provides a SEM micrographs of Cross-Linked Reactive Polymer Microparticles as a function of reaction time at 130° C. according to the present disclosure.

FIG. 28 provides a particle size distribution as a function of reaction time (line: Gaussian fitting curves), according to the present disclosure.

FIG. 29 provides a cloud point as a function of monomer concentration (T=130° C.) according to the present disclosure.

FIG. 30 provides a comparison of Cross-Linked Reactive Polymer Microparticles diameter and yield as a function of reaction time according to the present disclosure.

FIG. 31 provides a Tg (2^{nd} scan, long reaction time) versus monomer concentration according to the present disclosure.

FIG. 32 provides a SEM micrographs obtained from solution of different monomer concentration according to the present disclosure.

FIGS. 33A and 33B provide an average diameter as a function of time and monomer concentration according to the present disclosure.

FIG. 34 provides a SEM micrographs of Cross-Linked Reactive Polymer Microparticles having different stoichiometry according to the present disclosure.

FIGS. 35A and 35B provide an average diameter as a function of molar ratio and reaction time according to the present disclosure.

FIG. 36 provides a cloud point as a function of temperature (full dots: light transmittance measurement, empty dots: visual observation) according to the present disclosure.

FIG. 37 provides SEM micrographs of cross-linked reactive polymer microparticles reacted at different temperature according to the present disclosure.

FIGS. 38A and 38B provide an average diameter as a function of time and temperature of reaction according to the present disclosure.

FIG. 39 provides SEM micrographs of cross-linked reactive polymer microparticles synthesized in a mixture of PPG and dodecane according to the present disclosure.

FIGS. 40A and 40B provides a cross-linked reactive polymer microparticles diameter as a function of reaction time and weight percent (wt %) of dodecane in the solvent mixture according to the present disclosure.

FIGS. 41A and 41B provide a thermograms of IPDA-based cross-linked reactive polymer microparticles, top: 17 hours at 80° C., bottom: 24 hours at 80° C. according to the present disclosure.

FIG. 42 provides SEM micrographs of cross-linked reactive polymer microparticles as a function of reaction time at 80° C.: 4.5 hours and 24 hours according to the present disclosure.

FIG. 43 provides diameter as a function of reaction time at 80° C. according to the present disclosure.

FIGS. 44A and 44B provide a SEM micrograph of cross-linked reactive polymer microparticles based on IPDA and variation of diameter as a function of temperature and time of reaction according to the present disclosure.

FIG. 45 provides a plot of the variation of viscosity (η) during an isothermal curing at 80° C. for three neat formulations of the curable epoxy system differing by the a/e ratio.

FIG. 46 provides a plot of viscosity (η) during an isothermal curing at 80° C. for the curable epoxy system where amine to epoxy ratio a/e ratio=0.7.

FIG. 47 provides a plot of evolution of complex viscosity for different loadings of the cross-linked reactive polymer microparticles, ranging from 1 wt % to 40 wt %, which where added in the curable epoxy system (DGEBA-IPDA formulation with an a/e ratio=1.35).

FIG. 48 provides a plot of gel times obtained from multi-frequency experiments.

FIG. 49 provides a plot of the evolution of the IR spectra for neat epoxy matrix (a/e ratio=1), T=80° C. as a function of the reaction time.

FIG. 50 provides a conversion as a function of reaction time at 80° C., for neat DGEBA-IPDA system.

FIG. 51 provides an IR spectra in the hydroxyl area for Example 45.

FIG. 52 illustrates the influence of the addition of the cross-linked reactive polymer microparticles on the cure kinetics of the thermoset cross-linked network.

FIGS. 53A and 53B provide a comparison of DSC signals obtained on a thermoset cross-linked network (FIG. 53A) systems (10 wt %), for different a/e ratio in the film and on neat curable epoxy system (53B).

FIG. 54 provides a plot of ΔH as a function of the amount of the cross-linked reactive polymer microparticles for two series of formulations.

FIG. 55 provides an illustration of two glass transition for content of cross-linked reactive polymer microparticles above 10 wt %, observed on DSC thermograms.

FIGS. 56A and 56B provides a plot of the variation of Tg by changing the formulation and the cross-linked reactive polymer microparticles load. FIGS. 57A-57C are SEM images of (57A) Example 35, (57B) Example 39, (57C) Example 44, which provides an illustration of the effect of the a/e ratio of the thermoset cross-linked network on the fracture surface (thermoset cross-linked networks have a 10 wt cross-linked reactive polymer microparticles loading).

FIGS. 58A-58C provides SEM micrographs obtained for (58A) Example 36 (58B) Example 37 and (58C) Example 37 (zoom).

FIG. 59 provides an illustration of the storage modulus (E′), loss modulus (E″) and loss factor (tan δ) plotted as a function of temperature for IPDA-DGEBA matrix, a/e ratio=1.

FIG. 60 provides an illustration of the influence the a/e ratio of the curable epoxy system has on the δ (delta) transition.

FIG. 61 provides an illustration of the influence of the addition of 10 wt % of cross-linked reactive polymer microparticles in the curable epoxy systems with the a/e ratio.

FIGS. 62A-62B provide graphs of tan δ (delta) versus temperature that illustrates the transition due to the cross-linked reactive polymer microparticles.

FIG. 63 provides an illustration for the network Example 33 in which are also reported the variations of E′ and E″ as function of Temperature.

FIG. 64 illustrates the influence of the cross-linked reactive polymer microparticles weight fraction in epoxy network for Examples 41-45 and 47.

FIG. 65 provides an illustration that when the cross-linked reactive polymer microparticles reacted at lower temperature and for shorter reaction time are utilized, the tan delta transition broadens.

### DETAILED DESCRIPTION

Embodiments of the present disclosure provide for a thermoset cross-linked network that is a reaction product of a curable epoxy system and cross-linked reactive polymer microparticles. For the various embodiments, the cross-linked reactive polymer microparticles of the present disclosure have a cross-link density and reactive groups that covalently react with the curable epoxy system to provide the thermoset cross-linked network in a single contiguous phase having a topological heterogeneity. For the various embodiments, the cross-linked reactive polymer microparticles of the present disclosure react with at least one of the epoxy resins and/or the hardener of the curable epoxy system so as to fully integrate into the curable epoxy system as it cures. In other words, the cross-linked reactive polymer microparticles of the present disclosure do not form discrete interfaces with the surrounding curable epoxy system, but are rather chemically integrated therein as a contiguous part of the curable epoxy system.

As discussed herein, the curable epoxy system of the present system can produce cross-linked reactive polymer microparticles separate from the curable epoxy system. For the various embodiments, the cross-linked reactive polymer microparticles can be generated ex situ or in situ of the curable epoxy system. Among other things, this allows the cross-link density of the cross-linked reactive polymer microparticles to be predetermined independent of the cross-link density of the curable epoxy system. The cross-linked reactive polymer microparticles can then be dispersed in the curable epoxy system. For the various embodiments, this allows for the thermoset cross-linked network to have the topological heterogeneity, as discussed herein.

A co-pending U.S. patent application Ser. No. ______, entitled “CROSS-LINKED REACTIVE POLYMER MICROPARTICLES” (Atty. Dkt. Nos. 70566 and 1402.0719990) documents the preparation of the cross-linked reactive polymer microparticles, without the use of a surfactant, which is incorporated herein by reference in its entirety. Embodiments of the present disclosure illustrate the impact of adding these cross-linked reactive polymer microparticles on cure behavior and mechanical properties of the thermoset cross-linked network of the present disclosure. In particular, the influence of the composition and/or amount of the cross-linked reactive polymer microparticles used with the curable epoxy system of the thermoset cross-linked network. Of interest is the ability to produce a thermoset cross-linked network with the curable epoxy system and the cross-linked reactive polymer microparticles that produces a clear fracture surface, which demonstrate that the cross-linked reactive polymer microparticles are fully embedded in the curable epoxy system. Furthermore, the use of the cross-linked reactive polymer microparticles with the curable epoxy system helps to move the Tg transition of the thermoset cross-linked network to higher temperature ranges relative those of the curable epoxy system alone.

For the various embodiments, the cross-linked reactive polymer microparticles of the present disclosure can be synthesized via precipitation polymerization and subsequently stored and dispersed with an epoxy resin and a hardener of a curable epoxy system. As provided herein, the reaction conditions used in forming the cross-linked reactive polymer microparticles allow the microparticles to be formed without a surfactant. In addition, the reaction conditions used in forming the cross-linked reactive polymer microparticles also allows the microparticles to be essentially free of a dispersing agent, or agents, used in the synthesis of the microparticles. As such, the surface of the microparticles of the present disclosure does not include a surfactant or a significant amount of the dispersing agent(s) used in the reaction mixture (e.g., polyethers, as discussed herein). Rather, as discussed herein, the reaction conditions used in forming the microparticles can be used to preferentially present either epoxy reactive groups and/or amine reactive groups at the surface of the microparticles.

For the various embodiments, the presence of either the epoxy reactive group and/or the amine reactive group at the surface of the microparticles allows for the microparticles to be chemically integrated in a contiguous fashion into the cured curable epoxy system. As such, when the microparticles of the present disclosure are used with a curable epoxy system having the same epoxy resin and hardener of the microparticles, the resulting cured curable epoxy system can be compositionally homogeneous.

In addition, the microparticles of the present disclosure also allow for the resulting curable epoxy system to be morphologically heterogeneous. For example, the cross-linked reactive polymer microparticles can have a cross-link density that is different than a cross-link density of the curable epoxy system in which they are chemically integrated. It is also possible that the cross-linked reactive polymer microparticles can have two or more cross-link densities that are different than a cross-link density of the curable epoxy system in which they are chemically integrated. The curable epoxy system with the chemically integrated cross-linked reactive polymer microparticles could be compositionally homogeneous, but morphologically and topologically heterogeneous. This is because the reaction composition and the reaction conditions of the cross-linked reactive polymer microparticles can be controlled independent of those of a curable epoxy system.

So, ‘heterogeneities’ can be imparted into the curable epoxy system in which the microparticles are added, while still maintaining compositional homogeneity (e.g., when the microparticles, or a mixture of microparticles, can have a cross-link density that is different than the remainder of the curable epoxy system). This integration of the cross-linked reactive polymer microparticles into the curable epoxy system can allow for the curable epoxy system to have a heterogeneous morphology, which may help in improving the toughness of the curable epoxy system. Possible applications for such curable epoxy system can include wind mill blades and automotive panels.

As discussed herein, the cross-linked reactive polymer microparticles of the present disclosure can be fully integrated (e.g., covalently integrated) in the curable epoxy system network by virtue of having unreacted amine and/or epoxy groups present at the surface and/or within the microparticles. For example, they can interact with the curable epoxy system network via surface active groups or within its volume if the microparticles are swollen by formulation ingredients and are not fully crosslinked. These microparticles can be employed as toughening agents, or simply as additives to the curable epoxy system. If the compositions of both the microparticles and the curable epoxy system are identical, the integration can be full without identifiable interfaces being present.

For the various embodiments, the composition of cross-linked reactive polymer microparticles can be the reaction product of at least one epoxy resin and at least one amine curing agent in the presence of a dispersing media, where the reaction conditions (e.g., reaction temperature, reaction time, epoxy to amine ratio, among others) allow for the cross-linked reactive polymer microparticles to phase separate in a discrete non-agglomerated form with little or no dispersing media bound to the cross-linked reactive polymer microparticles.

The cross-linked reactive polymer microparticles can be produced by reacting the epoxy resin with the amine curing agent in the dispersing media. The reaction can proceed without stirring and, depending on the choice of the epoxy resin, the amine curing agent and/or the dispersing media, at a point along the reaction, a phase separation occurs in which the cross-linked reactive polymer microparticles are formed. Parameters that potentially have an influence on the structure (e.g., the size, the polydispersity, the surface chemistry, and the Tg, among others), the yield and the phase separation of the cross-linked reactive polymer microparticles include the concentration of the monomers dissolved (expressed as a weight percent of the monomer); the amine/epoxy molar ratio; the reaction temperature and reaction time; the dispersing media and the chemical structure of the amine curing agent.

More specifically, embodiments of the present disclosure include a composition of cross-linked reactive polymer microparticles that is a reaction product of the epoxy resin and the amine curing agent reacted in the dispersing media at a temperature of 50° C. to 120° C. for a reaction time of no greater than 17 hours, during which the cross-linked reactive polymer microparticles phase separate in a discrete non-agglomerated form from the dispersing media. For the various embodiments, the dispersing media can be bound to the cross-linked reactive polymer microparticles at a concentration of no greater than 0.001 weight percent based on the weight of the cross-linked reactive polymer microparticles. So, the dispersing media bound to the cross-linked reactive polymer microparticles is no greater than 0.001 weight percent of the cross-linked reactive polymer microparticles based on the weight of the cross-linked reactive polymer microparticles.

For the various embodiments, the cross-linked reactive polymer microparticles can be formed via precipitation polymerization process without the use of a surfactant. Precipitation polymerization is a polymerization process that begins initially as a homogeneous system in a continuous phase, where the monomers (e.g., epoxy resin and amine curing agent) are completely soluble in the dispersion media, but upon initiation the formed polymer microparticle become insoluble and precipitate. Precipitation polymerization allows the cross-linked reactive polymer microparticles to be formed in a micron-size range. The cross-linked reactive polymer microparticles of the present disclosure can be produced via the precipitation polymerization method without the need for and/or the use of a surfactant.

Surprisingly, the microparticles of the present disclosure are relatively monodisperse. In addition, in some specific cases (like the presence of a nonsolvent, as provided herein) a bimodal distribution with the submicron diameter particles is also possible. As such, the cross-linked reactive polymer microparticles of the present disclosure are less likely to form an interface, as discussed herein, with the curable epoxy system as there is no surfactant on the surface of the microparticles. For the various embodiments, no surfactant is present on the surface of the microparticles because no surfactant was used in producing the cross-linked reactive polymer microparticles.

For the precipitation polymerization, the dispersing media can be either a neat solvent or a mixture of solvents, as long as the solubility parameters of the dispersing media can be matched to those of the epoxy resin and hardener monomers so as to provide a phase separation of the cross-linked reactive polymer microparticles. For the various embodiments, a variety of dispersion media can be used in the dispersion polymerization of the present disclosure. For example, the dispersing media can be selected from the group consisting of polyethers (e.g., polypropylene glycol (PPG) and/or polyisobutylene ether), poly(oxypropylene), polybutylene oxide, aliphatic ketone, cyclic ketone such as cyclohexane and/or cyclohexanone, polyethers and combinations thereof. Preferably, the dispersing media is polypropylene glycol.

For the various embodiments, a nonsolvent can also be used with the dispersing media. Examples of suitable nonsolvents include, but are not limited to, alkenes (either aliphatic (dodecane) or cyclic), aromatic alkene, orthopthalates, alkyl azelates, other alkyl capped-esters and ethers, and combinations thereof.

For the various embodiments, the cross-linked reactive polymer microparticles can be produced by dissolving the epoxy resins and the amine curing agent in the dispersing media such that each has a concentration in the dispersing media of 5 to 30 weight percent based on the total weight of the dispersing media, the epoxy resin and the amine curing agent. Preferably, the epoxy resins and the amine curing agent in the dispersing media have a concentration in the dispersing media of 10 to 30 weight percent based on the total weight of the dispersing media, the epoxy resin and the amine curing agent. Most preferably, the epoxy resins and the amine curing agent in the dispersing media have a concentration in the dispersing media of 10 weight percent based on the total weight of the dispersing media, the epoxy resin and the amine curing agent.

The epoxy resin and the amine curing agent can be dissolved individually or together in the dispersing media. The reaction is allowed to proceed at a rate of reaction which can be adjusted by means of the reaction temperature. During this process, the initially clear solution changes into a dispersion as the microparticles precipitate out of the dispersing media. The size of the polymer particles in the dispersing media dispersion can be influenced by the selection of the raw materials as well as their concentration in the dispersing media, the reaction time, and the reaction temperature.

For the various embodiments, the reaction temperatures can be from 50° C. to 170° C., preferably 80° C. to 120° C. The reaction times are a function of the temperature, the amine/epoxy molar ratio; the dispersing media, the use of a catalyst (among others) and are dependent upon the chemical structure of the epoxy resins and the amine curing agent. When using polyamines as the amine curing agent, for instance, the rate of the polyaddition reaction can be influenced by the amine's basicity as well as by steric factors. For the various embodiments, the reaction time in fanning the composition of cross-linked reactive polymer microparticles can be no greater than 17 hours. Other suitable reaction times can include, but are not limited to, a time of 5 to 17 hours. Preferably, the reaction time can be no greater than 5 hours. Again this depends on the temperature, the amine/epoxy molar ratio; the dispersing media, the use of a catalyst and the chemical structure of the epoxy resins and the amine curing agent.

It is also possible to use a catalyst in forming the cross-linked reactive polymer microparticles of the present disclosure. Such catalysts are known in the art. Suitable catalysts are, for example, amines, preferably ethylene diamine, diethylene triamine, triethylene tetraamine, aminoethyl piperazine, organic acids, e.g. dicarboxylic acids, phenol compounds, imidazole and its derivatives, and calcium nitrate.

For the various embodiments, the choice of the reaction temperature, the dispersing media and the amine curing agent, as provided herein, influence the solubility of the cross-linked reactive polymer microparticles. These choices allow for a phase separation of the cross-linked reactive polymer microparticles from the dispersing media to occur before a significant amount of the dispersing media has an opportunity to react with either of the amine curing agent and/or the epoxy resin. For example, with a rapid phase separation of the microparticles due to the choice of reaction temperature, the amine curing agent, and the solubility parameters of the dispersing media, the opportunity for the dispersing media to react with the epoxy resin can be greatly reduced. In other words, the less solubility the cross-linked reactive polymer microparticles have at a given reaction temperature and time, the less likely they are to react or interact with the dispersing media. It is appreciated that not all dispersing media reacts with the epoxy and/or amine groups, where most dispersants do not react at all

A wide variety of epoxy resins are useful for the purpose of the present disclosure. The epoxy resins are organic materials having an average of at least 1.5, generally at least 2, reactive 1,2-epoxy groups per molecule. These epoxy resins can have an average of up to 6, preferably up to 4, most preferably up to 3, reactive 1,2-epoxy groups per molecule. These epoxy resins can be monomeric or polymeric, saturated or unsaturated, aliphatic, cyclo-aliphatic, aromatic or heterocyclic and may be substituted, if desired, with other substituents in addition to the epoxy groups, e.g. hydroxyl groups, alkoxyl groups or halogen atoms.

Suitable examples include epoxy resins from the reaction of polyphenols and epihalohydrins, polyalcohols and epihalohydrins, amines and epihalohydrins, sulfur-containing compounds and epihalohydrins, polycarboxylic acids and epihalohydrins, polyisocyanates and 2,3-epoxy-1-propanol (glycide) and from epoxidation of olefinically unsaturated compounds.

Preferred epoxy resins are the reaction products of polyphenols and epihalohydrins, of polyalcohols and epihalohydrins or of polycarboxylic acids and epihalohydrins. Mixtures of polyphenols, polyalcohols, amines, sulfur-containing compounds, polycarboxylic acids and/or polyisocyanates can also be reacted with epihalohydrins. Illustrative examples of epoxy resins useful herein are described in The Handbook of Epoxy Resins by H. Lee and K. Neville, published in 1967 by McGraw-Hill, New York, in appendix 4-1, pgs 4-56, which is incorporated herein by reference.

For bisphenol A type epoxy resin the average epoxy equivalent weight is advantageously from about 170 up to about 3000, preferably from about 170 up to about 1500. The average epoxy equivalent weight is the average molecular weight of the resin divided by the number of epoxy groups per molecule. The molecular weight is a weight average molecular weight.

Preferred examples of epoxy resins are bisphenol A type epoxy resins having an average epoxy equivalent weight of from about 170 to about 200. Such resins are commercially available from The Dow Chemical Company, as D.E.R. 330, D.E.R. 331 and D.E.R. 332 epoxy resins. Further preferred examples are resins with higher epoxide equivalent weight, such as D.E.R. 667, D.E.R. 669 and D.E.R. 732, all of which are commercially available from The Dow Chemical Company.

Another class of polymeric epoxy resins which are useful for the purpose of the present disclosure includes the epoxy novolac resins. The epoxy novolac resins can be obtained by reacting, preferably in the presence of a basic catalyst, e.g. sodium or potassium hydroxide, an epihalohydrin, such as epichlorohydrin, with the resinous condensate of an aldehyde, e.g. formaldehyde, and either a monohydric phenol, e.g. phenol itself, or a polyhydric phenol. Further details concerning the nature and preparation of these epoxy novolac resins can be obtained in Lee, H. and Neville, K., Handbook of Epoxy Resins, McGraw Hill Book Co. New York, 1967, which is incorporated herein by reference. Other useful epoxy novolac resins include those commercially available from The Dow Chemical Company as D.E.N. 431, D.E.N. 438 and D.E.N. 439 resins, respectively.

For the various embodiments, a variety of amine curing agents can be used in preparing the cross-linked reactive polymer microparticles of the present disclosure. Those amine curing agents which may be employed are primarily the multifunctional, preferably di- to hexafunctional, and particularly di- to tetrafunctional primary amines. Examples of such amine curing agents include, but are not limited to, isophorone diamine (IPDA), ethylene diamine, tetraethyle amine and 2,4-diaminotoluene (DAT) diamines. Mixtures of two or more of the amine curing agents can also be used. Also modified hardeners where amines are reacted in vast excess with epoxy resin can be good candidates as amine curing agents.

For the various embodiments, the reaction product of the composition of cross-linked reactive polymer microparticles can be formed with a molar excess of one of the amine curing agent or the epoxy resin. For example, a molar excess of the amine curing agent, relative the epoxy resin, can be used in forming the cross-linked reactive polymer microparticles. In other words, a molar excess of the amine hydrogens, relative the epoxy groups, can be used in forming the cross-linked reactive polymer microparticles. Alternatively, a molar excess of the epoxy groups, relative the amine hydrogens, can be used in forming the cross-linked reactive polymer microparticles. For the various embodiments, this molar excess can be expressed as an equivalent weight ratio of the amine curing agent used in reacting with the epoxy resin. For example, the equivalent weight ratio of amine to epoxy, or epoxy to amine, can be from 0.7 to 1.35. For the various embodiments, the equivalent weight ratio could also be 1. Equivalent weight ratio, as used herein, use the moles of amine hydrogen (from the amine curing agent) and the moles of epoxy groups (from the epoxy resin).

A further aspect of the present disclosure is a method of producing the cross-linked reactive polymer microparticles by reacting the epoxy resin and the amine curing agent, as discussed herein. For the various embodiments, the method of producing the cross-linked reactive polymer microparticles includes reacting the epoxy resin with the amine curing agent in the dispersing media at a temperature as provided herein (e.g., a temperature of 50° C. to 120° C.).

As discussed herein, the epoxy resin can be mixed with the amine curing agent to provide a molar excess of one of the amine curing agent or the epoxy resin in preparing the cross-linked reactive polymer microparticles of the present disclosure. The mixture can be heated to the reaction temperature to allow the reaction between the epoxy and amine to proceed for the reaction time. For the various embodiments, stirring the reaction mixture is not necessary.

As discussed herein, the reaction time for the method of preparing the cross-linked reactive polymer microparticles of the present disclosure can be of no greater than 17 hours. The cross-linked reactive polymer microparticles produced according to this method have no greater than 0.001 weight percent of the dispersing media bound to the cross-linked reactive polymer microparticles. This is achieved, in part, through the reaction temperature, the reaction time, and the phase inversion that is facilitated by the choice of dispersing agent provided herein. The dispersing media bound to the cross-linked reactive polymer microparticles can be chemically bound so that the cross-linked reactive polymer microparticles have no greater than 0.001 weight percent of the dispersing media chemically bound to the cross-linked reactive polymer microparticles. As discussed herein, a surfactant is not used in the method of forming the microparticles of the present disclosure.

For the various embodiments, the method may further include phase separating the cross-linked reactive polymer microparticles and the dispersing media. For the various embodiments, the microparticles can also undergo one or more washings so as to remove the dispersing media from the cross-linked reactive polymer microparticles to leave no greater than 0.001 weight percent of the dispersing media bound to the cross-linked reactive polymer microparticles. The dispersing media bound to the cross-linked reactive polymer microparticles can be chemically bound so that the cross-linked reactive polymer microparticles have no greater than 0.001 weight percent of the dispersing media chemically bound to the cross-linked reactive polymer microparticles. This may be especially preferred when it is desired to remove more of the dispersing media from the cross-linked reactive polymer microparticles than would be possible by evaporation alone. For example, following the formation of the microparticles, the dispersing media and the microparticles can be separated (e.g., by centrifugation followed by decanting). The microparticles can then be re-suspended in a washing liquid at room temperature (e.g., 23° C.). The microparticles can then be separated from the washing liquid (e.g., by centrifugation followed by decanting). The microparticles can be washed more than once.

As variety of washing liquids are possible. Examples of such washing liquids include, but are not limited to, acetone, ethanol, tetrahydrofuran, ketones such as methylethyl ketone, end capped ethers, and combinations thereof. The solvent(s) provided herein can also be used as the washing liquid.

For the various embodiments, the cross-linked reactive polymer microparticles of the present disclosure can have a number average diameter for a monomodial distribution of 10 nm to 10000 nm, preferably of 50 nm to 5000 nm, most preferably of 100 nm to 3000 nm. For the various embodiments, when the dispersing media includes polybutylene oxide, the cross-linked reactive polymer microparticles can have a bimodal size distribution of a first diameter and a second diameter, the first number average diameter being from 100 to 300 nanometers and the second number average diameter being from 0.5 to 10 μm.

As more fully illustrated in the Examples section below, the reaction conditions (e.g., reaction temperature, reaction time, epoxy to amine ratio, among others) discussed herein influence at least the dimensional, morphological, thermal and surface properties of the cross-linked reactive polymer microparticles. In addition, the surface chemistry of the microparticles is also dependent upon the reaction conditions and the molar ratios of the amine curing agent and the epoxy resin, as discussed herein.

As discussed herein, the thermoset cross-linked network of the present disclosure includes, in addition to the cross-linked reactive polymer microparticles, the curable epoxy system. For the various embodiments, the curable epoxy system is in a liquid phase at least initially as the reaction product of the curable epoxy system and cross-linked reactive polymer microparticles in a solid phase begins to form. As discussed herein, the cross-linked reactive polymer microparticles having a cross-link density and reactive groups that covalently react with the curable epoxy system to provide the thermoset cross-linked network in a single contiguous phase having a topological heterogeneity.

For the various embodiments, the curable epoxy system includes an epoxy resin and an amine hardener. For the various embodiments, a wide variety of epoxy resins are useful for the purpose of the present disclosure. Examples of such epoxy resins include those discussed herein in connection with the cross-linked reactive polymer microparticles. Other epoxy resins are also possible. Such epoxy resins can be selected from the group consisting of aromatic epoxy resins, alicyclic epoxy resins, aliphatic epoxy resins, and combinations thereof.

Examples of aromatic epoxy resins include, but are not limited to, glycidyl ether compounds of polyphenols, such as hydroquinone, resorcinol, bisphenol A, bisphenol F, 4,4′-dihydroxybiphenyl, phenol novolac, cresol novolac, trisphenol (tris-(4-hydroxyphenyl)methane), 1,1,2,2-tetra(4-hydroxyphenyl)ethane, tetrabromobisphenol A, 2,2-bis(4-hydroxyphenyl)-1,1,1,3,3,3-hexafluoropropane, 1,6-dihydroxynaphthalene, and combinations thereof.

Examples of alicyclic epoxy resins include, but are not limited to, polyglycidyl ethers of polyols having at least one alicyclic ring, or compounds including cyclohexene oxide or cyclopentene oxide obtained by epoxidizing compounds including a cyclohexene ring or cyclopentene ring with an oxidizer. Some particular examples include, but are not limited to, hydrogenated bisphenol A diglycidyl ether; 3,4-epoxycyclohexylmethyl-3,4-epoxycyclohexyl carboxylate; 3,4-epoxy-1-methylcyclohexyl-3,4-epoxy-1-methylhexane carboxylate; 6-methyl-3,4-epoxycyclohexylmethyl-6-methyl-3,4-epoxycyclohexane carboxylate; 3,4-epoxy-3-methylcyclohexylmethyl-3,4-epoxy-3-methylcyclohexane carboxylate; 3,4-epoxy-5-methylcyclohexylmethyl-3,4-epoxy-5-methylcyclohexane carboxylate; bis(3,4-epoxycyclohexylmethyl)adipate; methylene-bis(3,4-epoxycyclohexane); 2,2-bis(3,4-epoxycyclohexyl)propane; dicyclopentadiene diepoxide; ethylene-bis(3,4-epoxycyclohexane carboxylate); dioctyl epoxyhexahydrophthalate; di-2-ethylhexyl epoxyhexahydrophthalate; and combinations thereof.

Examples of aliphatic epoxy resins include, but are not limited to, polyglycidyl ethers of aliphatic polyols or alkylene-oxide adducts thereof, polyglycidyl esters of aliphatic long-chain polybasic acids, homopolymers synthesized by vinyl-polymerizing glycidyl acrylate or glycidyl methacrylate, and copolymers synthesized by vinyl-polymerizing glycidyl acrylate or glycidyl methacrylate and other vinyl monomers. Some particular examples include, but are not limited to glycidyl ethers of polyols, such as 1,4-butanediol diglycidyl ether; 1,6-hexanediol diglycidyl ether; a triglycidyl ether of glycerin; a triglycidyl ether of trimethylol propane; a tetraglycidyl ether of sorbitol; a hexaglycidyl ether of dipentaerythritol; a diglycidyl ether of polyethylene glycol; and a diglycidyl ether of polypropylene glycol; polyglycidyl ethers of polyether polyols obtained by adding one type, or two or more types, of alkylene oxide to aliphatic polyols such as propylene glycol, trimethylol propane, and glycerin; diglycidyl esters of aliphatic long-chain dibasic acids; and combinations thereof.

Similarly, a wide variety of amine curing agents can be used in preparing the curable epoxy system of the present disclosure. Amines include compounds that contain an N—H moiety, e.g. primary amines and secondary amines. Examples of such amine curing agents include those discussed herein in connection with the cross-linked reactive polymer microparticles. Other amine curing agents are also possible. Such amine curing agents can be selected from the group consisting of aliphatic polyamines, arylaliphatic polyamines, cycloaliphatic polyamines, aromatic polyamines, heterocyclic polyamines, polyalkoxy polyamines, dicyandiamide and derivatives thereof, aminoamides, amidines, ketimines, and combinations thereof.

Examples of aliphatic polyamines include, but are not limited to, ethylenediamine (EDA), diethylenetriamine (DETA), triethylenetetramine (TETA), trimethyl hexane diamine (TMDA), hexamethylenediamine (HMDA), N-(2-aminoethyl)-1,3-propanediamine (N₃-Amine), N,N′-1,2-ethanediylbis-1,3-propanediamine (N₄-amine), dipropylenetriamine, and reaction products of an excess of these amines with an epoxy resin, such as bisphenol A diglycidyl ether, and combinations thereof.

Examples of arylaliphatic polyamines include, but are not limited to, m-xylylenediamine (mXDA), and p-xylylenediamine. Examples of cycloaliphatic polyamines include, but are not limited to, 1,3-bisaminocyclohexylamine (1,3-BAC), isophorone diamine (IPDA), and 4,4′-methylenebiscyclohexaneamine. Examples of aromatic polyamines include, but are not limited to, m-phenylenediamine, diaminodiphenylmethane (DDM), and diaminodiphenylsulfone (DDS). Examples of heterocyclic polyamines include, but are not limited to, N-aminoethylpiperazine (NAEP), 3,9-bis(3-aminopropyl) 2,4,8,10-tetraoxaspiro(5,5)undecane, and combinations thereof.

Examples of polyalkoxy polyamines include, but are not limited to, 4,7-dioxadecane-1,10-diamine; 1-propanamine; (2,1-ethanediyloxy)-bis-(diaminopropylated diethylene glycol) (ANCAMINE® 1922A); poly(oxy(methyl-1,2-ethanediyl)), alpha-(2-aminomethylethyl)omega-(2-aminomethylethoxy) (JEFFAMINE® D-230, D-400); triethyleneglycoldiamine; and oligomers (JEFFAMINE® XTJ-504, JEFFAMINE® XTJ-512); poly(oxy(methyl-1,2-ethanediyl)), alpha,alpha′-(oxydi-2,1-etha nediyl)bis(omega-(aminomethylethoxy)) (JEFFAMINE® XTJ-511); bis(3-aminopropyl)polytetrahydrofuran 350; bis(3-aminopropyl)polytetrahydrofuran 750; poly(oxy(methyl-1,2-ethanediyl)); α-hydro- ω̅-(2-aminomethylethoxy) ether with 2-ethyl-2-(hydroxymethyl)-1,3-propanediol (JEFFAMINE® T-403); diaminopropyl dipropylene glycol; and combinations thereof.

For the various embodiments, the epoxy resin(s) and the amine curing agent(s) of the curable epoxy system can have a variety of weight percentages relative the thermoset cross-linked network. For example, the curable epoxy system can have from 10 weight percent (wt %) to 90 wt % of epoxy resin relative the relative the thermoset cross-linked network. It is also possible that the curable epoxy system can have from 20 wt % to 80 wt % of epoxy resin relative the relative the thermoset cross-linked network. It is also possible that the curable epoxy system can have from 30 wt % to 70 wt % of epoxy resin relative the relative the thermoset cross-linked network. The amine curing agent can be from 1 wt % to 70 wt % relative the thermoset cross-linked network. It is also possible that the amine curing agent can be from 5 wt % to 45 wt % relative the thermoset cross-linked network. It is also possible that the amine curing agent can be from 10 wt % to 40 wt % relative the thermoset cross-linked network.

For the various embodiments, the cross-linked reactive polymer microparticles and the curable epoxy system of the thermoset cross-linked network can be formed from the same or different epoxy resin and the amine hardener. So, for example, the cross-linked reactive polymer microparticles can be formed from a first predefined combination of epoxy resin and the amine hardener and the curable epoxy system can be formed from a second predefined combination of epoxy resin and the amine hardener that is different than the first predefined combination.

As discussed herein, the cross-linked reactive polymer microparticles help to introduce a heterogeneous network topology to the thermoset cross-linked network. For the various embodiments, the topological heterogeneity can be imparted to the thermoset cross-linked network by a cross-link density of the reaction product of the curable epoxy system that is different than the cross-link density of the cross-linked reactive polymer microparticles. In addition, the cross-link density difference allows for differences in the Tg of the cross-linked reactive polymer microparticles (e.g., higher than or lower than) relative the curable epoxy system, where the microparticles can then provide the loci of the topological heterogeneity.

This heterogeneous network topology can help to add toughness to the thermoset cross-linked network due at least in part to the cross-link density and reactive groups of the cross-linked reactive polymer microparticles that covalently react with the curable epoxy system to provide the thermoset cross-linked network in a single contiguous phase. Since the cross-linked reactive polymer microparticles contain reactive groups at their surface, they covalently bond with the surrounding network of the curable epoxy system thereby minimizing or eliminating the interface between the cross-linked reactive polymer microparticles and the curable epoxy system. Evidence of such integrated cross-linked reactive polymer microparticles into the curable epoxy system can be shown by fracture surfaces of the thermoset cross-linked network (provided no fillers are being used) being “clear,” as provided in the Examples section below.

Unlike other systems, however, the cross-linked reactive polymer microparticles and the cross-linked reactive polymer microparticles of the cross-linked reactive polymer microparticles can fully integrate as the curable epoxy system cures. For the various embodiments, the cross-linked reactive polymer microparticles of the present disclosure have a cross-link density and reactive groups that covalently react with the curable epoxy system to provide the thermoset cross-linked network in a single contiguous phase having a topological heterogeneity. For the various embodiments, the cross-linked reactive polymer microparticles of the present disclosure react with at least one of the epoxy resins and/or the hardener of the curable epoxy system so as to fully integrate into the curable epoxy system as it cures. In other words, the cross-linked reactive polymer microparticles of the present disclosure do not form discrete interfaces with the surrounding curable epoxy system, but are rather chemically integrated therein as a contiguous part of the curable epoxy system.

For the various embodiments, the reactive groups of the cross-linked reactive polymer microparticles can be amine groups that react with the epoxy resin of the curable epoxy system. For the various embodiments, the reactive groups of the cross-linked reactive polymer microparticles can be epoxy groups that react with the amine groups of the curable epoxy system. As discussed herein, as the cross-linked reactive polymer microparticles are in a solid phase and as they do not include a surfactant, their presence will not impede the formation of the thermoset cross-linked network, nor do they add additional compounds to the curable epoxy system. The cross-linked reactive polymer microparticles can also act as heat-sinks for the exothermic reaction of the curable epoxy system, since a majority of the cross-linked reactive polymer microparticles are already cross-linked. This also helps to reduce cure shrinkage that is often present in thermosets.

For the various embodiments, the cross-linked reactive polymer microparticles can be dispersed in the curable epoxy system without need for or use of a surfactant. For the various embodiments, the cross-linked reactive polymer microparticles can be added with and/or to the amine curing agent, the epoxy resin and/or both in preparing the thermoset cross-linked network. For the various embodiments, the thermoset cross-linked network can include 1 to 70 weight percent of the cross-linked reactive polymer microparticles. So, the thermoset cross-linked network includes 1 to 70 weight percent of the cross-linked reactive polymer microparticles based on the total weight of the thermoset cross-linked network.

For the various embodiments, the cross-linked reactive polymer microparticles can be generated ex situ, as discussed herein. It is also possible to generate the cross-linked reactive polymer microparticles in situ of the curable epoxy system. For example, the solvent, or solvent mixture, used in the precipitation polymerization and phase separation of the cross-linked reactive polymer microparticles can also be used with the epoxy resin(s) and/or the amine curing agent(s) of the curable epoxy system, where the solvent or solvent mixture can be evaporated from developing thermoset cross-linked network.

A further aspect of the present disclosure is a method of producing the thermoset cross-linked network. For the various embodiments, the method includes reacting the epoxy resin with the amine curing agent in the dispersing media at a temperature of 50° C. to 120° C. for a reaction time of no greater than 17 hours so that the cross-linked reactive polymer microparticles have no greater than 0.001 weight percent of the dispersing media bound to the cross-linked reactive polymer microparticles, as discussed herein. The dispersing media bound to the cross-linked reactive polymer microparticles can be chemically bound so that the cross-linked reactive polymer microparticles have no greater than 0.001 weight percent of the dispersing media chemically bound to the cross-linked reactive polymer microparticles. The method further includes phase separating the cross-linked reactive polymer microparticles and the dispersing media, as discussed herein. The method further includes reacting the curable epoxy system in the liquid phase with the cross-linked reactive polymer microparticles in the solid phase, where the cross-linked reactive polymer microparticles have a cross-link density and reactive groups that covalently react with the curable epoxy system to provide the thermoset cross-linked network in a single contiguous phase having the topological heterogeneity, as discussed herein.

For the various embodiments, the cross-linked reactive polymer microparticles can be washed to remove the dispersing media so as to leave no greater than 0.001 weight percent of the dispersing media bound to the cross-linked reactive polymer microparticles. The dispersing media bound to the cross-linked reactive polymer microparticles can be chemically bound so that the cross-linked reactive polymer microparticles have no greater than 0.001 weight percent of the dispersing media chemically bound to the cross-linked reactive polymer microparticles. For the various embodiments, this can allow the reactive groups of the cross-linked reactive polymer microparticles the amine groups (and/or the epoxy groups) to react with the epoxy resin (and/or the amine groups) of the curable epoxy system.

The following examples illustrate the present disclosure. Unless otherwise mentioned, all parts and percentages are weight parts and weight percentages. The examples should not be construed to limit the present disclosure.

### EXAMPLES

The following examples are given to illustrate, but not limit, the scope of this invention. The examples provide methods and specific embodiments of both the cross-linked reactive polymer microparticles and the thermoset cross-linked network that include the cross-linked reactive polymer microparticles and the curable epoxy system of the present disclosure. As provided herein, the cross-linked reactive polymer microparticles can provide, among other things, the ability to impart an increase in the heterogeneity of the thermoset cross-linked network. Embodiments provided herein illustrate the impact of the cross-linked reactive polymer microparticles on the overall mechanical properties as well as cure behavior of the thermoset cross-linked network.

### Materials

Diglycidyl ether of Bisphenol A (DGEBA, D.E.R. 331™, The Dow Chemical Company).

2,4-Diaminotoluene (DAT), an aromatic curing agent (Aldrich, used as received).

Isophorone diamine (IPDA), a cycloaliphatic curing agent (Aldrich, used as received).

Poly(propylene glycol) (PPG), two different molecular weights (PPG-1000 and PPG-3500), a solvent (Aldrich, used as received).

Dodecane, a solvent (Aldrich, used as received).

Acetone (Aldrich, used as received).

Tetrahydrofuran (Sigma Aldrich, analytic grade, used as received).

Table 1 lists the chemical structures and characteristics of the above compounds.

TABLE 1
Characteristics of the compounds used.

| | | | | Solubility |
|---|---|---|---|---|
| | | | Mn | parameter |
| Name | | Chemical structure (reference) | (g/mol) | (MPa½) |
| Diglycidyl ether of Bisphenol A (D.E.R. 331 ™) | DGEBA | 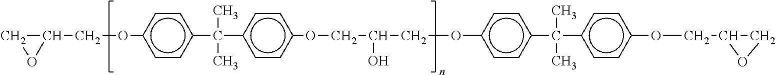 | | |
| | | | 374 | |
| 2,4- diamino- toluene | DAT | 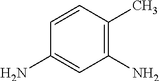 | 122 | |
| Isophorone diamine | IPDA | 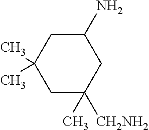 | 170 | |
| Poly (propylene glycol) | PPG | 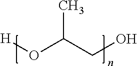 | 1000 3500 | 18.9 |
| Dodecane | | H₃C—(—CH₂—)₁₀—CH₃ | | 17.1 |

### Examples 1-18

### Preparation Based on DGEBA and DAT of the Cross-Linked Reactive Polymer Microparticles

Table 2 provides the experimental conditions to use in preparing Reference A and Examples 1-18 of cross-linked reactive polymer microparticles based on the reaction between DGEBA and DAT, as discussed herein. The cross-linked reactive polymer microparticles of Reference A and Examples 1-18 were produced via a dispersion polymerization method without the use of a surfactant. Polypropylene glycol (PPG) was utilized as the dispersing media, either alone or with the addition of a nonsolvent (dodecane).

For each of the Reference A and Examples 1-18, dissolve DGEBA and DAT separately in the solvent, as provided in Table 2, at T=40 degrees Celsius (° C.) for 20 minutes (min) and T=40° C. for 30 min, respectively, to obtain a homogeneous solution for each monomer having a monomer concentration as provided in Table 2. Mix the DGEBA solution and the DAT solution to prepare the different molar ratios of amine to epoxy (a/e ratio), as provided in Table 2. Place the mixtures in a pre-heated oven (from 80° C. to 160° C., as provided in Table 2) to allow the reaction between epoxy and amine to proceed for the reaction time provided in Table 2 without stirring and with periodic sampling.

Separate each sample of the cross-linked reactive polymer microparticles from the solvent by centrifugation at 4000 rotations per minute (rpms) for 20 minutes (min) to remove most of the solvent. Wash the cross-linked reactive polymer microparticles with an excess of acetone at room temp (23° C.) and repeat centrifugation. Dry the cross-linked reactive polymer microparticles in vacuo at room temperature (23° C.). The details concerning the experimental conditions are reported in Table 2.

Reference cross-linked reactive polymer microparticles (referred to as “Reference A” in Table 2) provide an amine to epoxy molar ratio of 1.35 a/e ratio, monomer concentration of 10 weight percent (wt %), PPG-1000 solvent, reaction temperature: 130° C. and reaction time: 15 hours.

TABLE 2
Experimental conditions used for Examples 1-12 of cross-linked
reactive polymer microparticles based on DGEBA-DAT

| | | Amine | | | |
|---|---|---|---|---|---|
| | | to | | | |
| | | Epoxy | | | |
| | | Molar | | Monomer | |
| | | ratio | | Concen- | Reaction |
| | | (a/e | Temperature | tration | time |
| Example | Solvent | ratio) | (° C.) | (wt %) | (hours) |
| Reference | PPG-1000 | 1.35 | 130 | 10 | 15 |
| A | | | | | |
| 1 | | 0.7 | | | |
| 2 | | 1 | | | |
| 3 | | 2 | | | |
| 4 | | 1.35 | 80 | | 100 |
| 5 | | | 100 | | 50 |
| 6 | | | 160 | | 15 |
| 7 | | | 130 | 5 | 20 |
| 8 | | | | 30 | 5 |
| 9 | PPG-1000 + | | 80 | 10 | 100 |
| 10 | 10 wt % | | 130 | | 15 |
| 11 | dodecane | | | 30 | 20 |
| 12 | | | | 10 | 10 |
| 13 | | | 80 | | 5 |
| 14 | | | | | 17 |
| 15 | | | 100 | | 5 |
| 16 | | | | | 17 |
| 17 | | | 120 | | 5 |
| 18 | | | | | 17 |

### Examples 19-32

### Preparation Based on DGEBA and IPDA of the Cross-Linked Reactive Polymer Microparticles

Table 3 provides the experimental conditions to use in preparing Reference B and Examples 19-32 of cross-linked reactive polymer microparticles based on the reaction between DGEBA and IPDA, as discussed herein. The cross-linked reactive polymer microparticles of Examples 19-32 were produced via a dispersion polymerization method without the use of a surfactant. PPG was utilized as the dispersing media, either alone or with the addition of a nonsolvent (dodecane).

For each of the Reference B and Examples 19-32, dissolve DGEBA and IPDA separately in the solvent, as provided in Table 3, at T=40° C. for 20 min and T=80° C. for 30 min, respectively, to obtain a homogeneous solution having a monomer concentration as provided in Table 3. Mix the DGEBA solution and the IPDA to prepare the different molar ratios of amine to epoxy (a/e ratio), as provided in Table 3. Place the mixtures in a pre-heated oven (from 80° C. to 130° C., as provided in Table 3) to allow the reaction between epoxy and amine to proceed for the reaction time provided in Table 3, without stirring and with periodic sampling.

Separate each sample of the cross-linked reactive polymer microparticles as discussed above for example 1-18. Sample 25 was further washed with THF before being dried in vacuo at room temperature (23° C.).

The details concerning the experimental conditions are reported in Table 3. Reference cross-linked reactive polymer microparticles (Reference B in Table 3) provides an amine to epoxy molar ratio of 1.35 de ratio, monomer concentration of 10 weight percent (%). PPG-1000 solvent, reaction temperature: 80° C. and reaction time: 17 hours.

TABLE 3
Experimental conditions used for Examples 19-32 of cross-linked
reactive polymer microparticles based on DGEBA-IPDA.

| | | Amine to | | | |
|---|---|---|---|---|---|
| | | Epoxy | | Monomer | |
| | | Molar | Temper- | Concen- | Reaction |
| | | ratio | ature | tration | time |
| Example | Solvent | (a/e ratio) | (° C.) | (wt %) | (hours) |
| Reference | PPG-1000 | 1.35 | 80 | 10 | 17 |
| B | | | | | |
| 19 | | 1 | | | |
| 20 | PPG-1000 + | 1.35 | | | 5 |
| 21 | 10 wt % | | 100 | | |
| 22 | dodecane | | 130 | | |
| 23 | | | 100 | | 17 |
| 24 | | | 130 | | |
| 25 | | | 120 | | |
| 26 | | 0.7 | 130 | | |
| 27 | | 1.35 | 80 | | |
| 28 | | | 100 | | 4.5 |
| 29 | | | | | 17 |
| 30 | | | 130 | | 4.5 |
| 31 | | | | | 17 |
| 32 | PPG-1000 | 0.7 | 80 | | |

### Bulk Epoxy Networks

Bulk epoxy networks prepared with DGEBA and DAT (Comparative Epoxy Example A), and DGEBA and IPDA (Comparative Epoxy Example B) were synthesized at different amine/epoxy molar ratios with a curing cycle in a pre-heated oven at 130° C. for 4 hours and then in a pre-heated oven at 180° C. for 4 hours. DSC was used to determine the enthalpy of the reactions and the glass transition temperature for each of the Comparative Epoxy Examples A and B. These values were used for comparison with the values obtained for Examples 1-26. Comparative Epoxy Examples A and B are also used to validate other data such as elemental analysis and XPS as provided herein.

### Characterization Methods

Light Transmittance Measurements (Cloud Point Measurements)

Light transmittance was measured through the solution during the synthesis of the cross-linked reactive polymer microparticles. Light transmittance was measured using an instrument composed of an electrical heating device, a temperature control for the heating device, a glass test tube attached to the electrical heating device, where the tube is filled with the sample to be analysed, a light source and sensor (Zeiss KL1500 LCD) and a computer for the data (e.g., light intensity) acquisition.

Cloud points were determined with the light transmittance device described above. With this technique the intensity of a light through a sample is recorded as a function of temperature or as a function of time. When the sample turns from transparent to cloudy/opaque (or the opposite) the intensity of the light transmitted through the sample shows a decrease (or an increase respectively). The beginning of this decrease is called the cloud point, it corresponds to the appearance of particles (by a phase separation process) having a diameter in the order of 0.1 μm.

Size Exclusion Chromatography (SEC)

SEC was used to separate and calculate the content of DGEBA, DAT and PPG monomers in the reaction solution at the end of the reaction. Calibration was previously realized for each compound, using different concentrations. The elution media used was tetrahydrofuran (THF), the flow rate was 1 millilitre/minute (ml/min), and three columns (Waters HR0.5, HR1 and HR2) were used for the separation; the detection was done using a refractive index detector and a UV-Vis detector (λ=254 nm).

Modulated Differential Scanning Calorimetry (MDSC) Experiments Thermal Properties

MDSC experiments were performed on a TA Instruments model Q2000 DSC equipped with a refrigerated cooling system. Data were collected using the Thermal Advantage for Q series (version 2.7.0.380) software package and reduced using version 4.4A of the Universal Analysis 2000 software package. The calorimeter was calibrated for temperature with Adamantane (Mp=−64.53° C.), n-Octadecane (Mp=28.24° C.), Indium (Mp=156.60° C.) and Zinc (Mp=419.47° C.) at a scan rate of 10° C./min. The enthalpy signal was calibrated from the Indium (ΔH=28.71 J/g) analysis. Circa 7 mg samples were accurately weighed using a Mettler analytical balance. Light-weight (ca 25 mg) Al pans were employed for the experiments on the cross-linked reactive polymer microparticles. The pans were crimped to improve sample/pan contact but the seal is not hermetic. Prior to a second analysis of the cross-linked reactive polymer microparticles the samples were dried at 40° C. in a vacuum oven (pressure: 10 mbar) for about 64 hours. T-zero pans with hermetic lid were employed to study the curing of the Comparative Epoxy (DER 331 plus IPDA) matrix. The same temperature profile was employed as for the cross-linked reactive polymer microparticle samples.

TABLE 4
Experimental conditions used for the MDSC Analysis of the cross-linked reactive
polymer microparticles
MDSC Method

| | | | | | |
|---|---|---|---|---|---|
| Temperature Scan Rate | 5 | ° C./Min | Sample Container | See text | Closed |
| Minimum Test Temperature | 0 | ° C. | Sample Weight | 7-10 | mg |
| Maximum Test Temperature | 200 | ° C. | Period | 40 | sec |
| Amplitude | +/−0.5 | ° C. | | | |

Thermal Gravimetric Analysis Coupled with Mass Spectroscopy (TGA-MS) Experiments

The TGA-MS experiments were performed via a TA Instruments model Q5000 TGA coupled to a Balzer Thermostar GSD 300 MS. Data were collected using the Thermal Advantage for Q series (version 2.7.0.380) software package and reduced using version 4.4A of the Universal Analysis 2000 software package for the TGA data and Quadstar 422 software (Version 6.0) for the MS data. The MS data were exported in ASCII format and further reduced in the Universal Analysis package. The samples were placed on a Pt-pan and accurately weighed by the calibrated TGA-balance.

TABLE 5
Experimental conditions used for the TGA-MS Analysis of the cross-linked
reactive polymer microparticles
TGA-MS Method

| | | | | | |
|---|---|---|---|---|---|
| Temperature Scan Rate | 10 | ° C./Min | Sample Container Material | Pt | Open |
| Minimum Test Temperature | 25 | ° C. | Sample Weight | ~5 | mg |
| Maximum Test Temperature | 380 | ° C. | Atmosphere | He | |

| | | | | |
|---|---|---|---|---|
| Detector | Channeltron | Mass range | 10-120 | amu |

| | | |
|---|---|---|
| Scan speed | 0.2 | sec |

Differential Scanning Calorimetry (DSC)

The dried cross-linked reactive polymer microparticles powders were analyzed by using DSC in order to obtain the residual enthalpy of reaction (if any) and the glass transition temperature of the cross-linked reactive polymer microparticles. DSC was also used to obtain the residual enthalpy of reaction (if any) and the glass transition temperature of the curable epoxy system.

DSC measurements were performed with Q20 (TA) and Mettler DSC 30 (Mettler Toledo GmbH) calorimeters. A first heating ramp (10° C./min) from −60 up to 250° C. was followed by a cooling stage down to 0° C. (50° C./min) and by a second heating ramp up to 200° C. All the tests were conducted under helium (25 ml/min, TA Q20 calorimeter) or argon (25 ml/min, Mettler DSC 30 calorimeter). The data was analyzed with Universal Analysis 2000 v.4.2E (Q20) and STARe v.8.10 (Mettler DSC 30). DSC was also used to characterize the bulk networks. The materials were characterized in terms of the enthalpy of the cross-linking reaction (obtained during the first heating scan) and in terms of glass transition temperature for a cured network (obtained during the second heating scan).

Microscopy

Optical Microscopy

Optical microscopy was used in order to asses the dispersion of the cross-linked reactive polymer microparticles in the curable epoxy system. Micrographs were acquired by using an Ortholux II microscope (Zeiss) in transmittance mode both for uncured and cured thermoset cross-linked networks. In the case of the cured thermoset cross-linked networks, the films were observed without additional preparation treatment.

Scanning Electron Microscopy (SEM)

SEM was carried out to study the morphology of the cross-linked reactive polymer microparticles and to evaluate their size. The dried cross-linked reactive polymer microparticles were observed with a Philips XL20 SEM. Preparation of the sample was as follows: the cross-linked reactive polymer microparticle powder was put on a metal stub covered with a conductive graphite adhesive and then gold coated by sputtering. Micrographs were collected at several magnifications by applying typically a voltage of 15 kV. The SEM micrographs were used to determine the particle size distribution. The particle size distribution was calculated by using a not-weighted counting procedure of the cross-linked reactive polymer microparticles. This fact practically means that the two tails of the particle distribution has the same weight even if the tail at smaller dimension represents a smaller weight (or volume) fraction of the system. The measurements were conducted by using the open source software ImageJ (Version 1.42q. Available at http://rsb.info.nih.gov/ij): for each sample at least 300 particles were measured in order to have statistical meaning of the data.

Films of the thermoset cross-linked network were cryo-fractured by using liquid nitrogen and the fracture surfaces were observed with the Philips XL20 SEM. The samples were put on a metal stub covered with a conductive graphite adhesive and then gold coated by sputtering. Micrographs were collected at several magnifications by applying a voltage of 15 kV.

### Chemorheology

Chemorheological experiments were carried out on the neat curable epoxy system (i.e. without cross-linked reactive polymer microparticles) and on the thermoset cross-linked network (the curable epoxy system and the cross-linked reactive polymer microparticles) using an ARES rheometer (TA) in order to investigate the gelation behaviour of the systems. The experiments were conducted in dynamic mode at 80° C., using parallel plate geometry with an average gap between the plates of 1 mm. Two types of experiments were employed: (1) monofrequency test at 30 rad/s and a strain of 30%; (2) multifrequency test at 1, 3, 10, 30, 100 rad/s and strains of 0.8%, 0.6%, 0.3%, 0.15%, 0.08%, respectively.

In both the cases, the physical properties of the materials (i.e. modulus of the complex viscosity and loss factor) were monitored as a function of time, until to reach the maximum torque allowed by the instrument (i.e. about 2000 g·cm).

### Infrared Spectroscopy (FT-IR)

The kinetic of the cross-linking of the neat curable epoxy system and of the thermoset cross-linked network was investigated using infrared spectroscopy. Infrared spectra were acquired by using Magna-IR 550 spectrometer (Nicolet) in transmission mode: a small drop of unreacted curable epoxy system was put between two KBr pellets and maintained at a temperature of 80° C. The data were analyzed by using the software OMNIC v.7.3.

### Dynamic Mechanical Analysis (DMA)

DMA experiments were conducted in tensile mode on a small strip of the thermoset cross-linked network with a nominal width of 5 mm and a length of 22.32 mm by using a RSA II instrument (Rheometrics). The curable epoxy system sample was heated from 30 to 200° C. at 3° C./min and a sinusoidal strain of 0.05% at a frequency of 1 Hz was applied. Storage modulus, loss modulus and loss factor were recorded during the experiment.

### Results and Discussion

The Examples 1-26 provide non-agglomerated cross-linked reactive polymer microparticles with narrow size distribution. The diameter was in the micrometer-size range although in some specific cases (like the presence of a nonsolvent) bimodal distribution with the submicron diameter particles was observed. The reaction conditions used in the reactions influence the size, yield and phase separation of the cross-linked reactive polymer microparticles. Hence, effective amine to epoxy ratio, temperature of the reaction and reaction time were considered as parameters of the cross-linked reactive polymer microparticles synthesis. DAT/D.E.R. 331™ in a PPG formulation were used to establish some relationships between the reaction parameters and cross-linked reactive polymer microparticles properties. These relationships include the observation that as the epoxy to amine ratio increases, the diameter of the cross-linked reactive polymer microparticles decreases. As the reaction time increases, the diameter of the cross-linked reactive polymer microparticles increases. As the reaction temperature increases, the rate of reaction increases and the cross-linked reactive polymer microparticles had a smaller diameter. Finally, as the monomer content increases, the diameter of the cross-linked reactive polymer microparticles increases while the polydispersity remains relatively constant.

The weight percent (wt. %) of the monomers used in forming the cross-linked reactive polymer microparticles (e.g., epoxy resin and diamine) also has an impact on the reaction yield. In case of 50 wt % monomer loading, cross-linked reactive polymer microparticles were phase separating faster as the reaction progressed and were agglomerated. Hence a 10 wt % of monomer loading was used to better ensure a sufficiently high yield and prevent agglomeration of particles. The reaction yield in the PPG was above 90% (as determined by SEC).

Reference Cross-Linked Reactive Polymer Microparticles

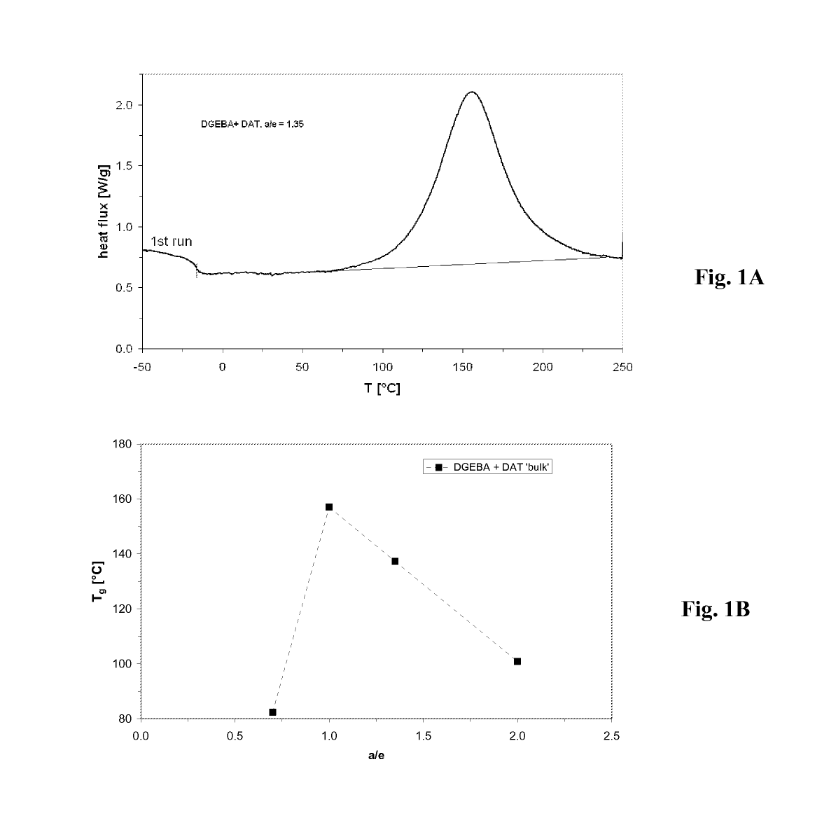

An example of a DSC thermogram obtained on Reference A (Table 1, DGEBA+DAT, a/e ratio=1.35) is shown in FIG. 1A. The glass transition temperature (Tg₀) of the epoxy compound of Reference A before reaction and the exothermic peak of reaction are observed. This peak has a maximum at about 160° C. and an enthalpy of reaction ΔH=378 J/g. The results of the Tg values (on cured samples) as function of a/e ratio are shown in FIG. 1B. A trend with a maximum Tg=157° C. for a/e ratio=1 is obtained. This plot is useful for comparison with the Tg values of the cross-linked reactive polymer microparticles of Examples 1-12.

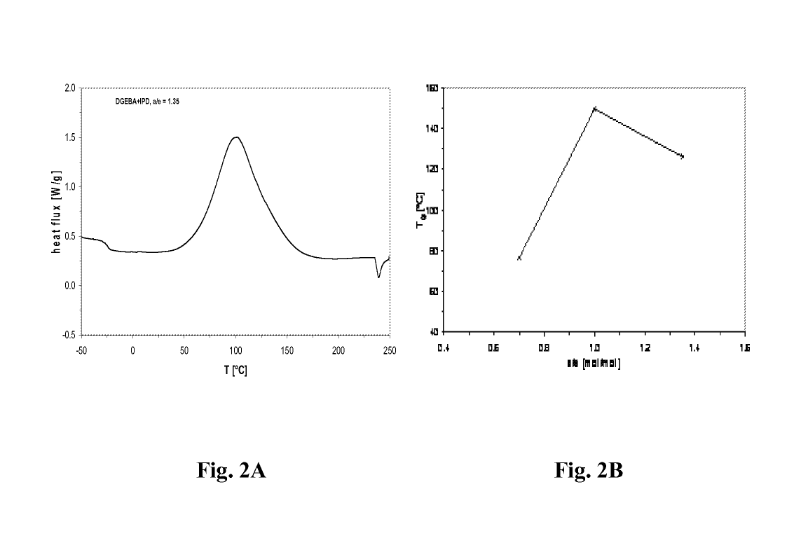

Similar experiments were done on Reference B (Table 2, DGEBA+IPDA, a/e ratio=1.35). FIG. 2A shows the IPDA reacting at a lower temperature, the temperature at the maximum of the exothermic peak is about 100° C. and the enthalpy of reaction is equal to ΔH=390 J/g. The variation of Tg versus a/e ratio follows the trend, i.e. maximum of Tg for a/e ratio=1, as shown in FIG. 2B.

Characterization of Reference A

The cross-linked reactive polymer microparticles of Reference A having a molar ratio a/e ratio=1.35 (i.e. an excess of amine) were expected to favour the presence of amino groups on the surface of the cross-linked reactive polymer microparticles. The solvent was PPG-1000 due to its high boiling point (the reaction temperature was 130° C.) in order to have reasonable reaction time using DAT, the monomer concentration was 10 wt %. The structure of the cross-linked reactive polymer microparticles was explored by employing several techniques.

Synthesis of Reference A

During the progress of the reaction, the initially colourless transparent homogenous monomer solution became cloudy and slightly yellowish. After centrifugation, washing and drying, as discussed above, a yellowish/brown powder was obtained.

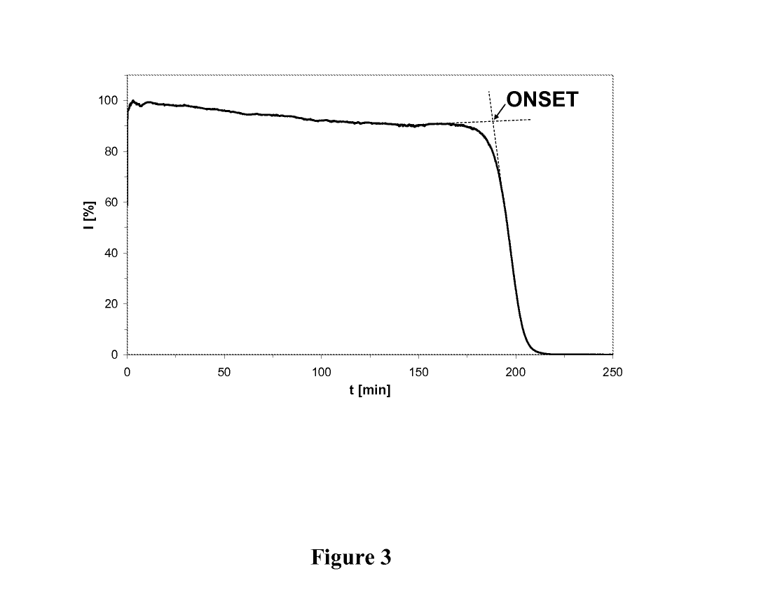

Phase separation occurred in less than 4 hours of reaction; in order to have more precise value of the phase separation kinetics, the light transmittance through the solution was monitored at 130° C. and presented in the plot in FIG. 3: for the given reaction conditions, the phase separation occurs after 187 min (3.1 hours).

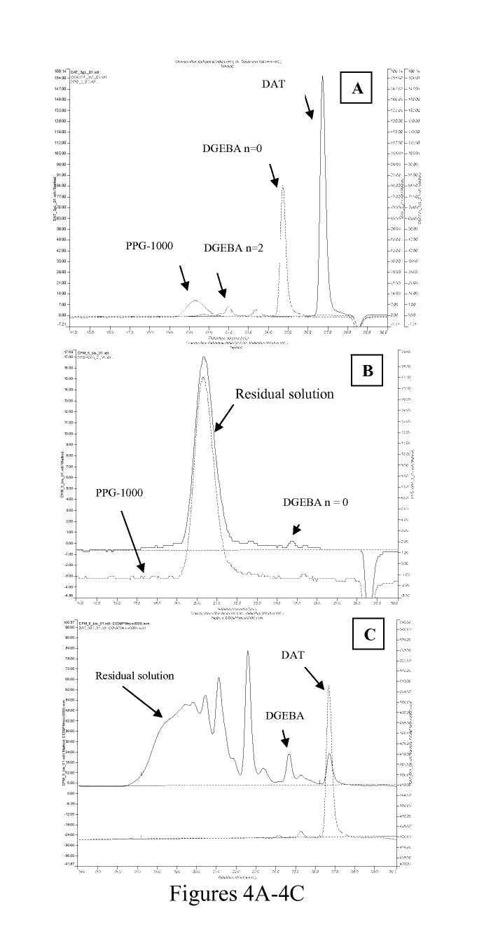

The residual solutions are also analyzed by SEC (by diluting the residual solution with THF (3 milligram/millilitre (mg/ml) and 5 mg/ml, 2 times)). Examples of typical chromatograms obtained on the initial compounds (DGEBA/DAT/PPG-1000) and at the end product of the reaction (reaction time=15 hours) are shown in FIG. 4. The elution volumes of PPG-1000, DGEBA and DAT are Ve=20.3 millilitre (ml), 24.7 ml and 26.7 ml respectively (FIG. 4A). All compounds are very well separated. In FIG. 4b, a main peak (RI signal) corresponding to PPG-1000 is observed and a very small peak corresponding to unreacted DGEBA (n=0). There is no peak corresponding to DAT at 26.7 ml, but this is a very small amount that can be in the limits of detection of the refractive index detector. The UV signal at 254 nm (FIG. 4C) was also utilized to detect end products of the reaction since it is more sensitive to DEGBA and DAT (due to the presence of aromatic rings). A DAT peak is observed as well as the presence of oligomers.

From calibration curves established for each component, it is possible to deduce the amount of DGEBA and DAT present in the residual solution. Twelve percent (12%) of the initial DGEBA and 2% of the initial DAT remain in the solution (average value over the three tests) so it gives a yield of 86% for the epoxy+amine reaction (if the oligomers which remain in the solution are neglected). The yield by SEC is slightly lower than the value obtained by the gravimetric method, because SEC considered only the epoxy-amine conversion into the cross-linked reactive polymer microparticles. It was not determined whether the difference is due to the presence of PPG in the cross-linked reactive polymer microparticles of Reference A or to sedimentation of cross-linked reactive polymer microparticles of Reference A.

### Characterization of the Cross-Linked Reactive Polymer Microparticles

Thermal Properties

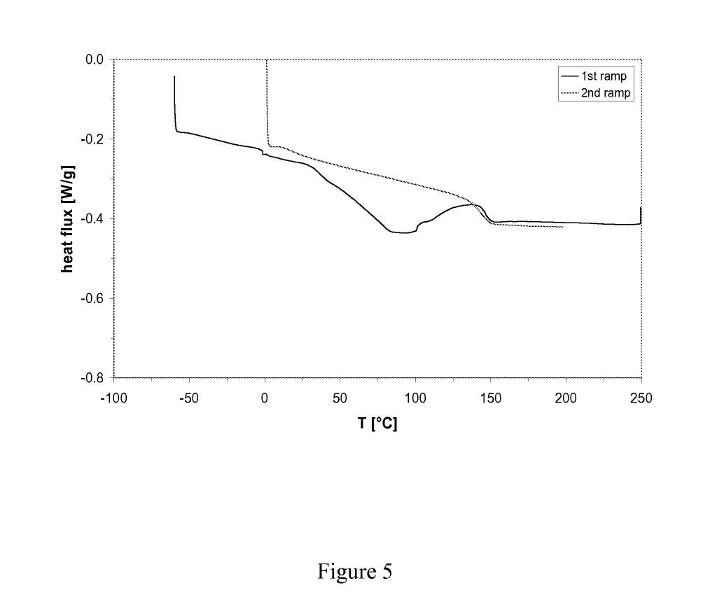

An example of the curves of the heat flux as a function of temperature from the DSC experiments on the dried cross-linked reactive polymer microparticles (Example 1 obtained after 15 hours of reaction at 130° C.) are shown in FIG. 5. The thermograph of the first heating scan is rather complex: there is an endothermic peak in the temperature region between 50° C. and 100° C. and then a glass transition is observed. The endothermic peak is related to the residual acetone (used in the washing process); using the specific heat of evaporation of the acetone, i.e. 538.9 J/g, the residual amount of acetone was estimated to be in the range 5-7 wt.-%. The second heating scan showed a clear glass transition at 147° C., very similar to the one observed during the first scan. These comments are valid for all Examples 1-12: there is no significant difference between the 1^{st} and the 2^{nd} scan.

If the cross-linked reactive polymer microparticles have a stoichiometry similar to the initial one in the feed mixture, a/e ratio=1.35, then the Tg should be equal to 137° C. The value obtained is higher so the effective stoichiometry of the cross-linked reactive polymer microparticles must be close to 1.2 if there are only made of DGEBA and DAT (FIG. 1). However the results from yield, TGA and XPS suggested that there is PPG-1000 in the cross-linked reactive polymer microparticles of Examples 1-12. The following hypothesis can be advanced: (1) PPG is adsorbed or reacted at the surface of the microparticles and its amount is very small (because of the several washing treatments) and (2) PPG may be inside the microparticles in phase separated domains; it cannot be in the cross-linked reactive polymer microparticles as a miscible polymer because it will lead to a decrease of Tg (only few polymers are miscible with epoxy networks, ex: PMMA).

MDSC Experiments:

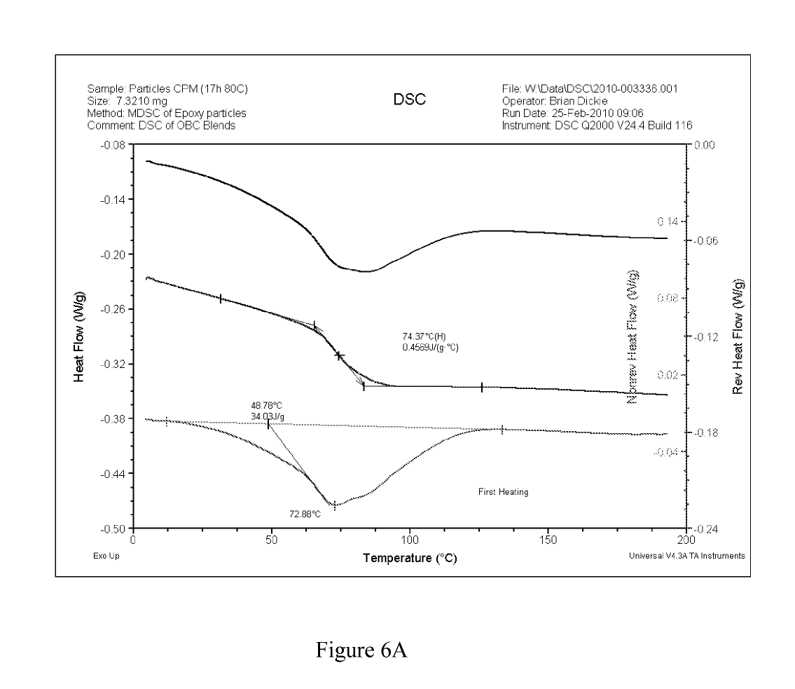

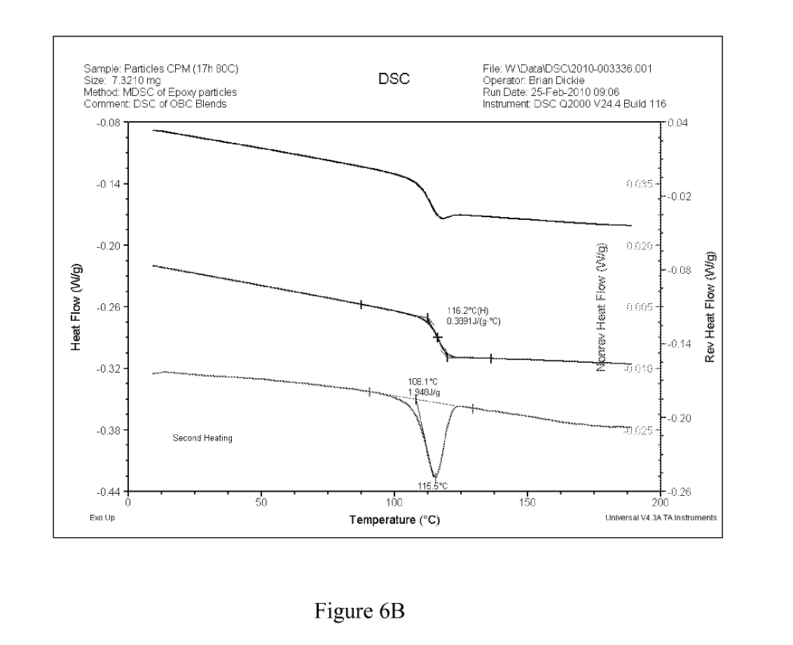

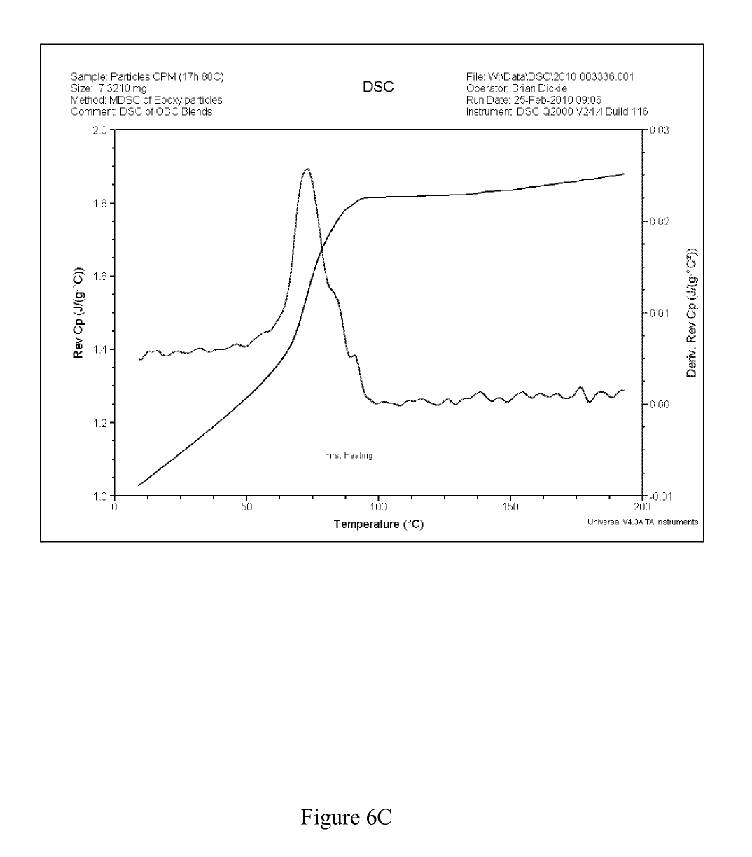

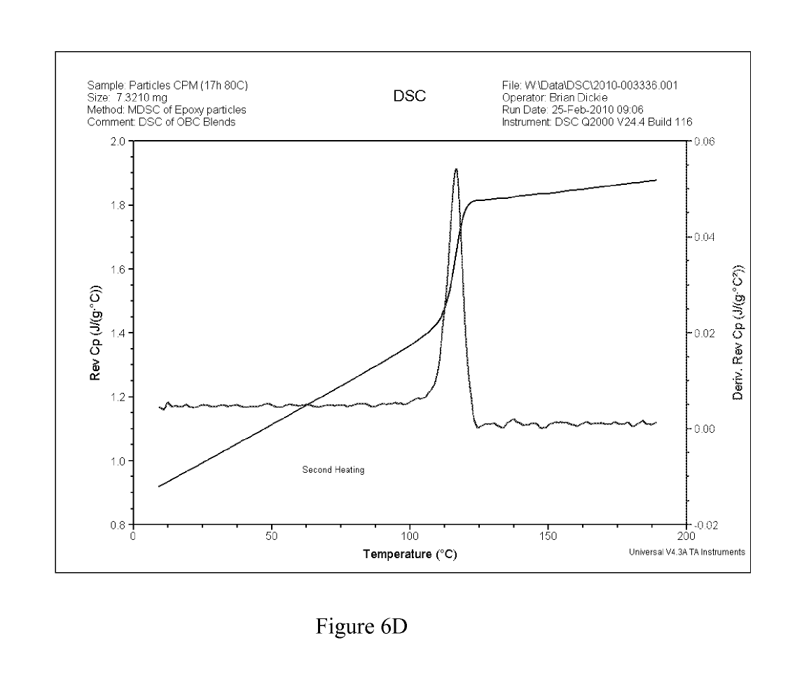

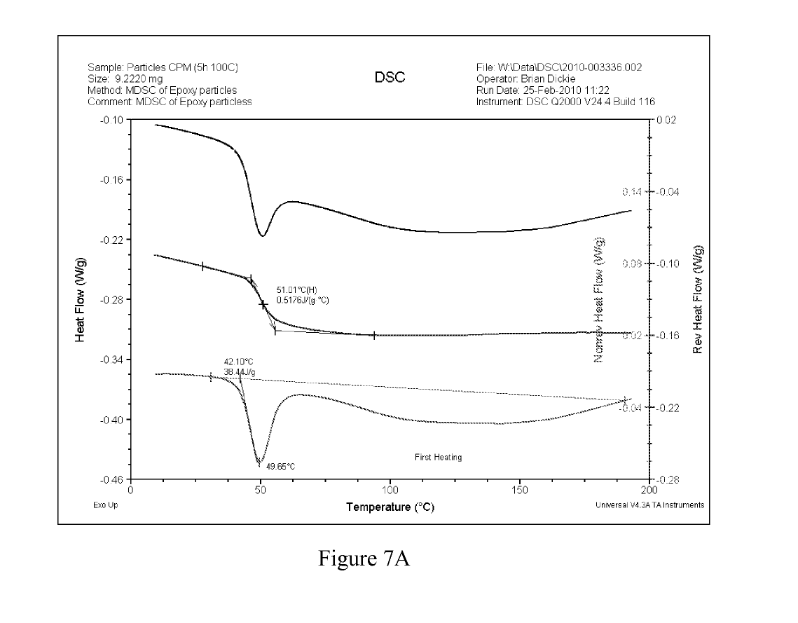

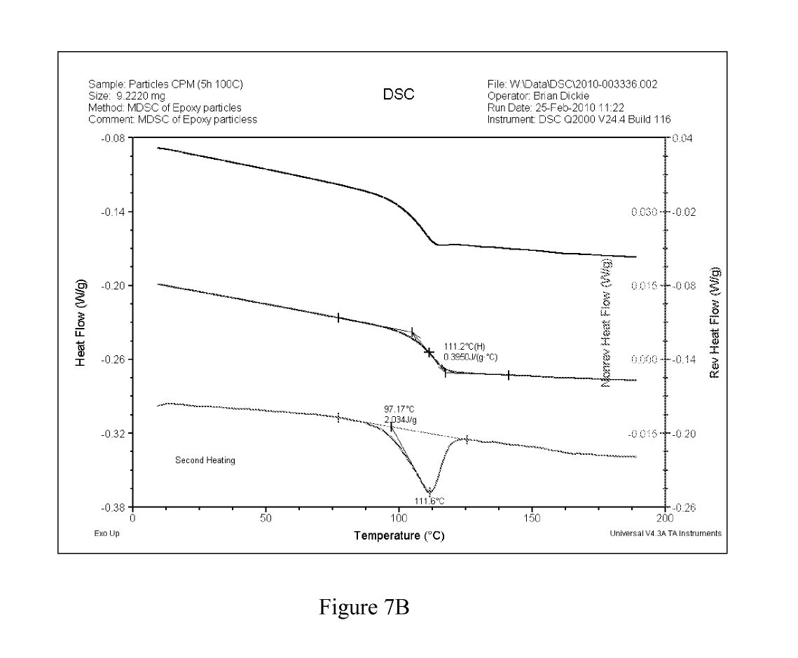

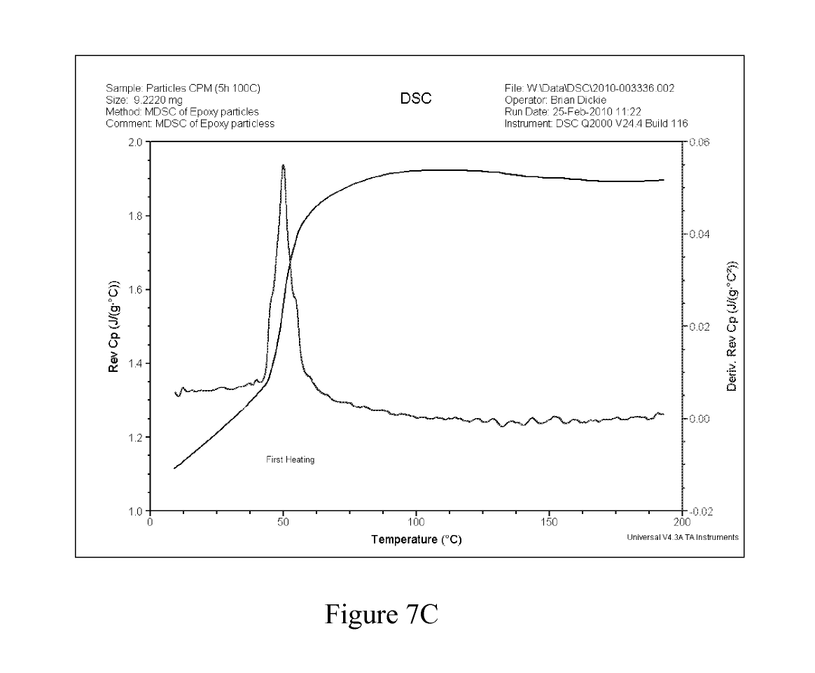

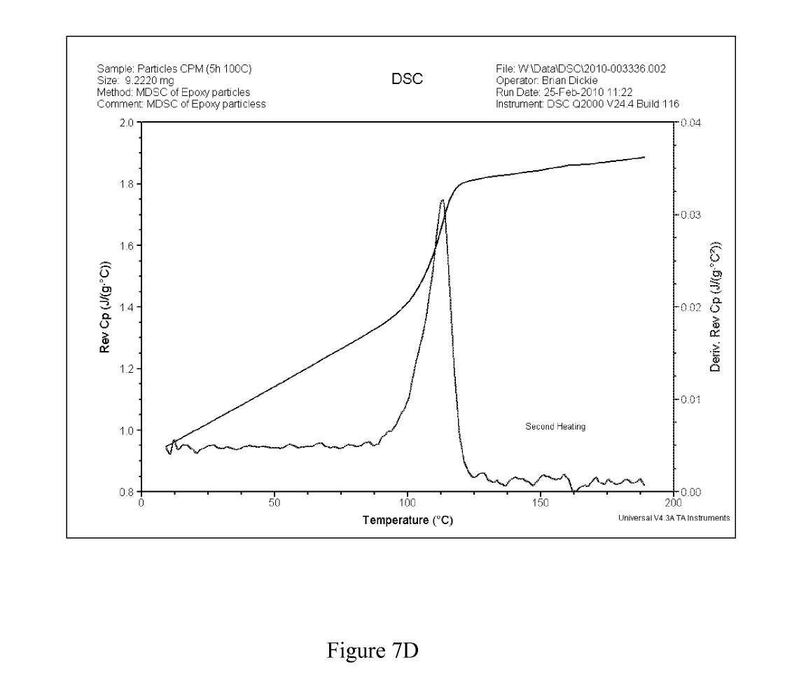

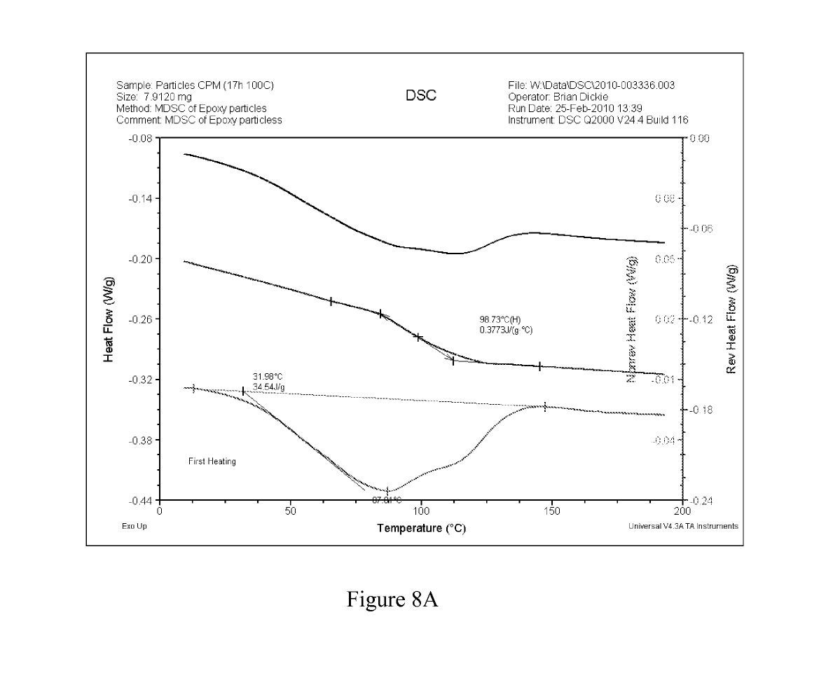

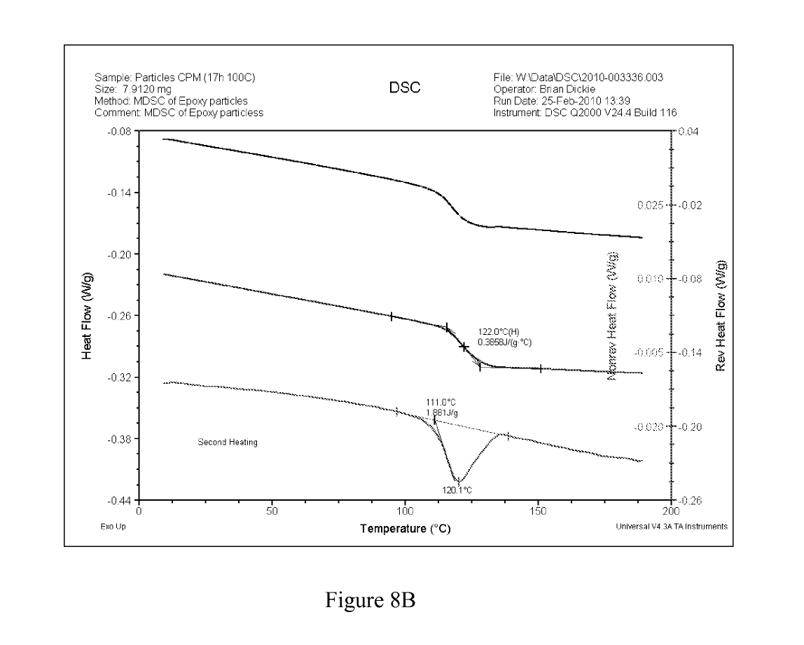

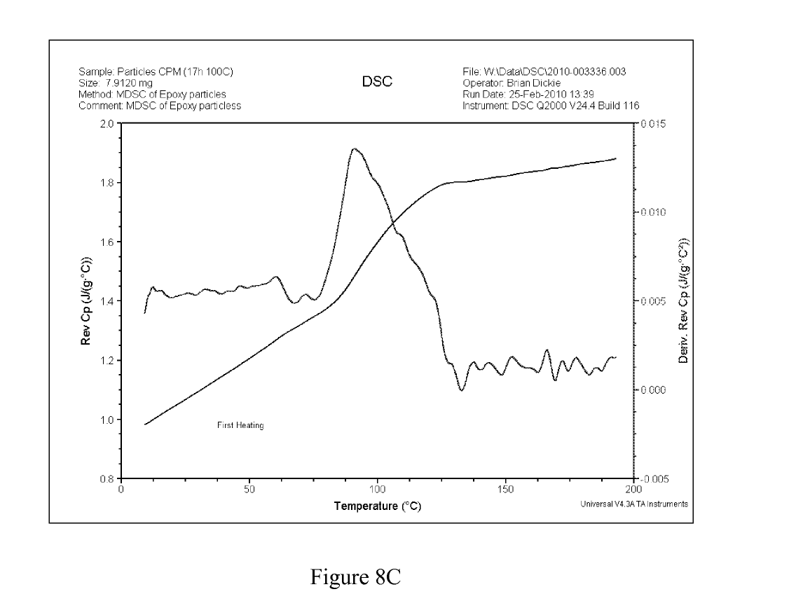

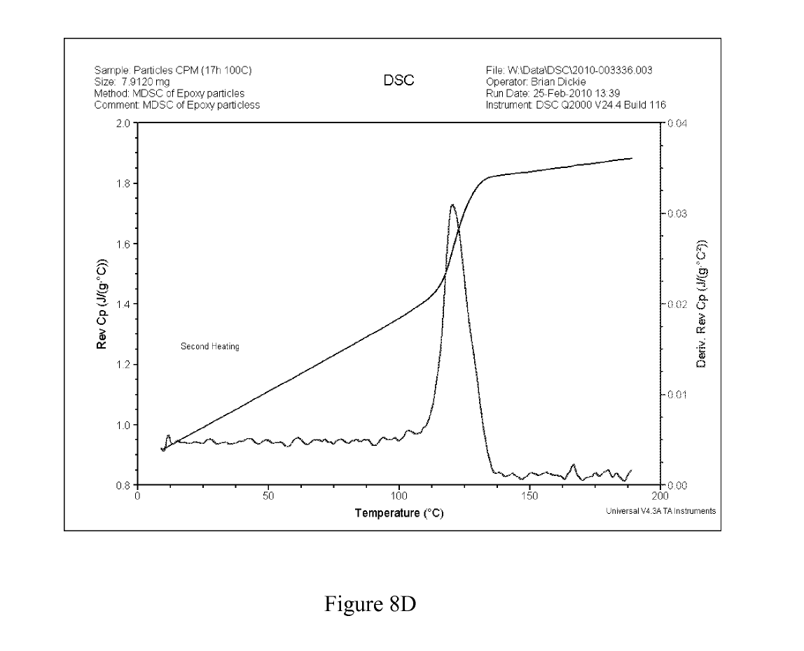

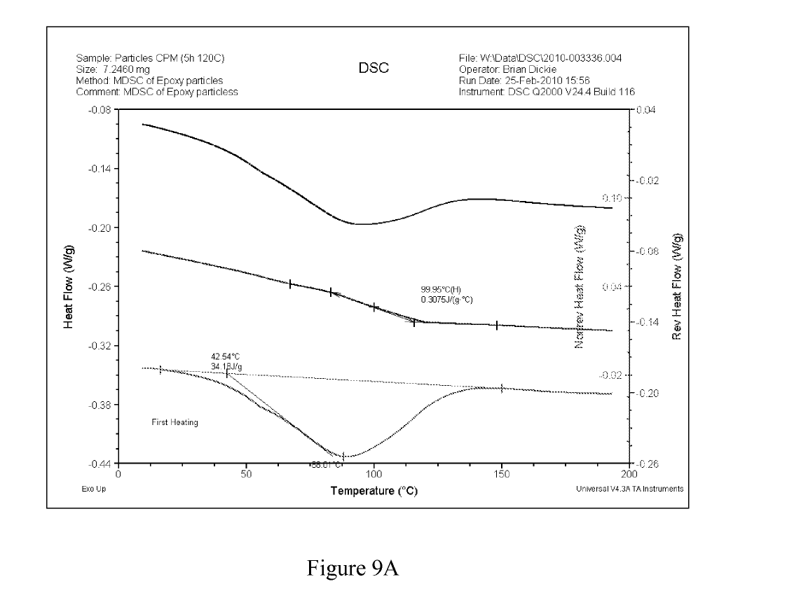

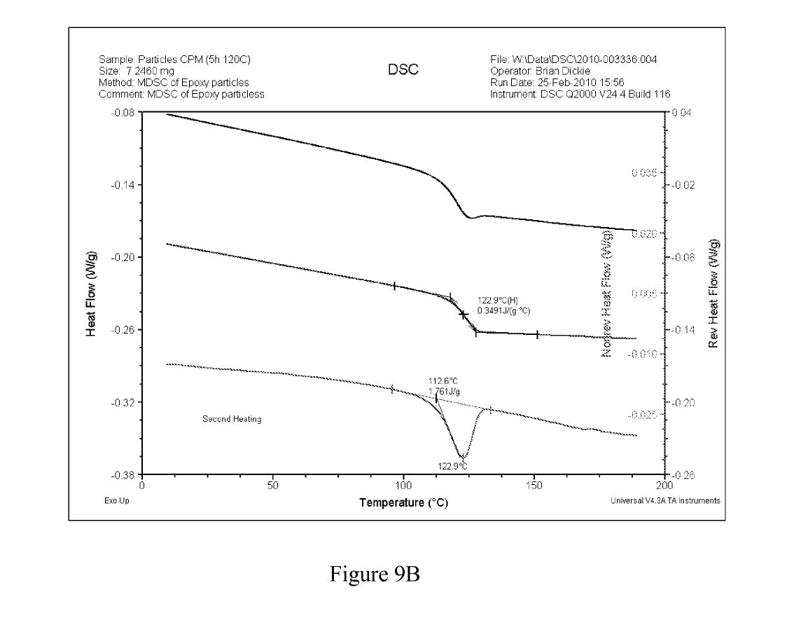

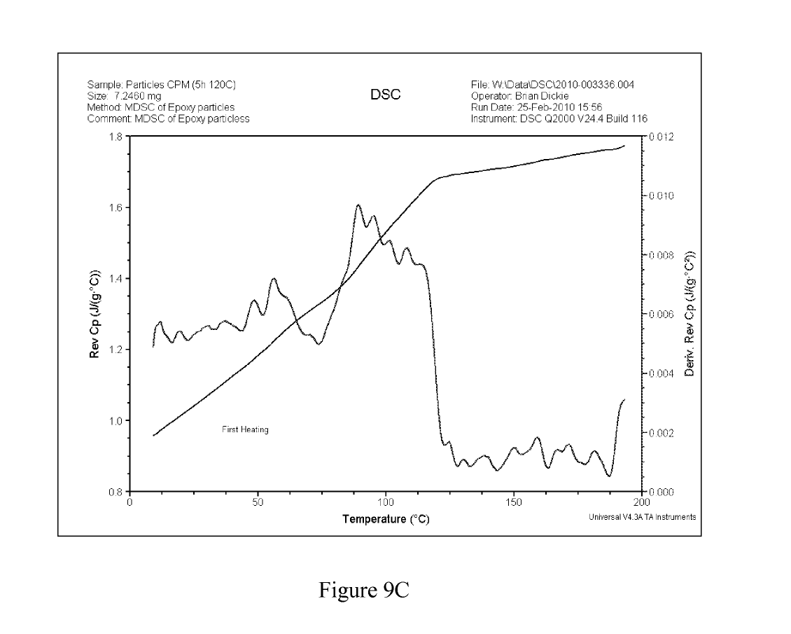

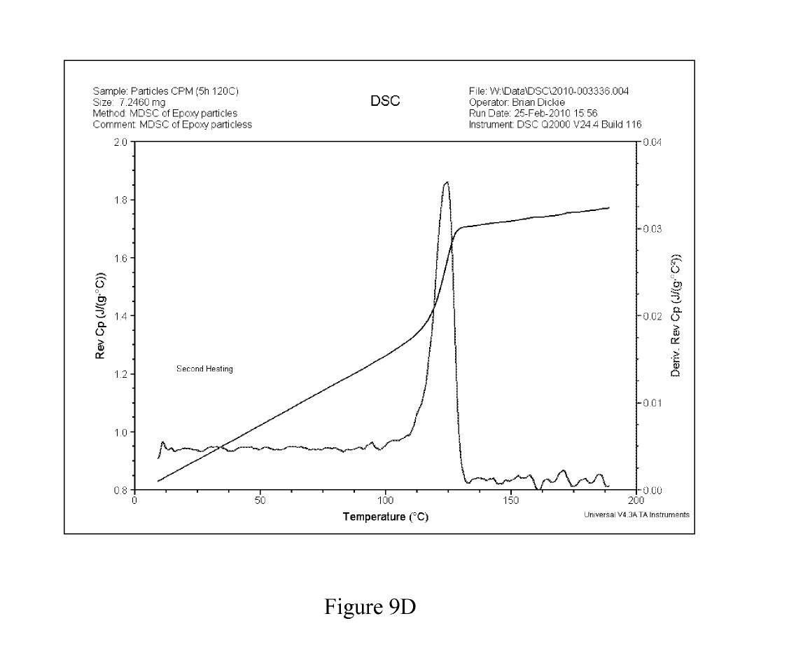

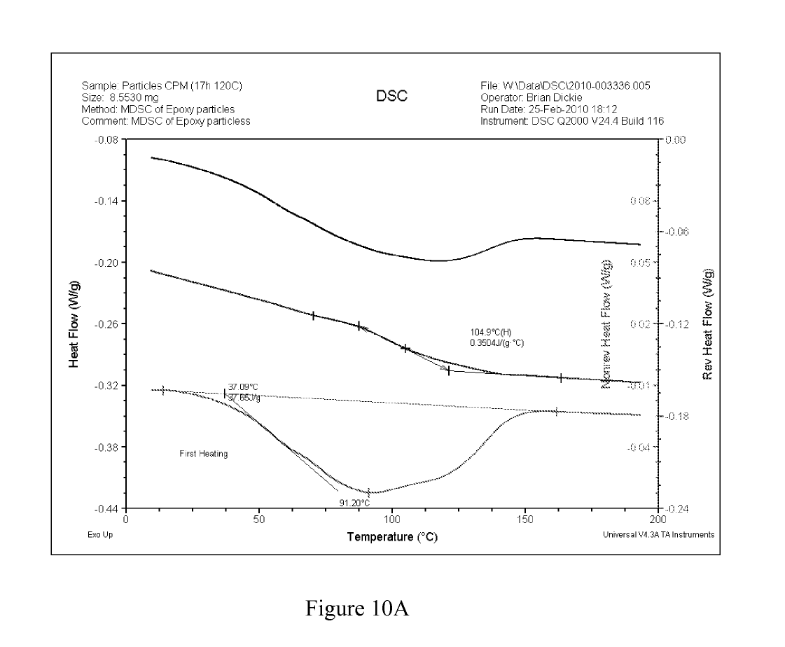

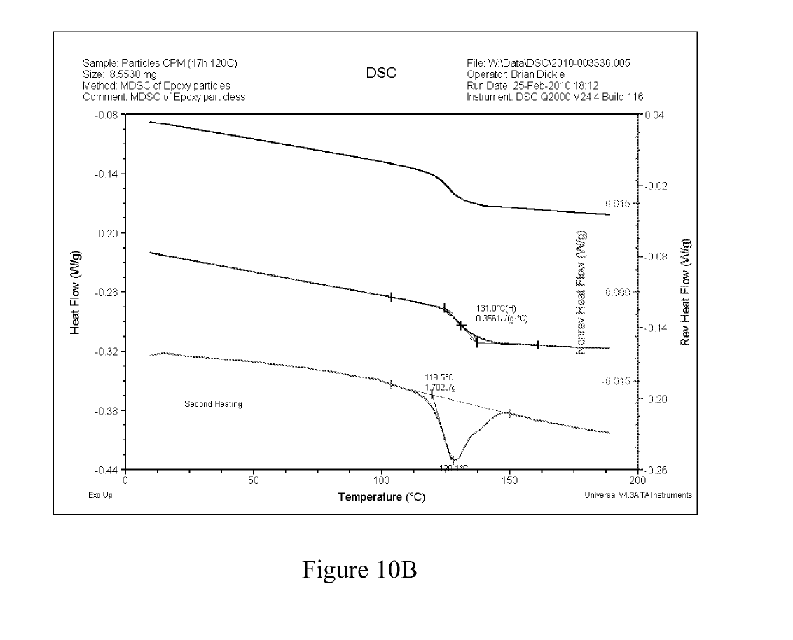

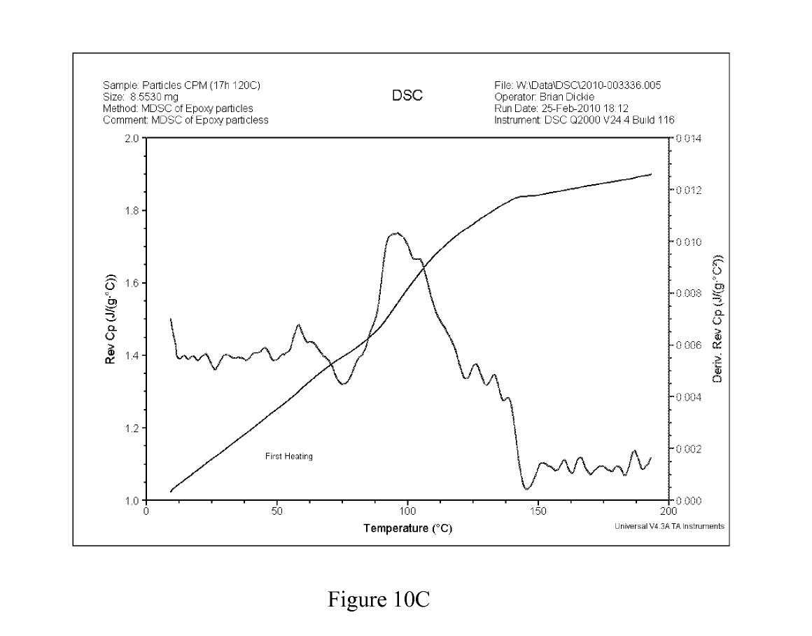

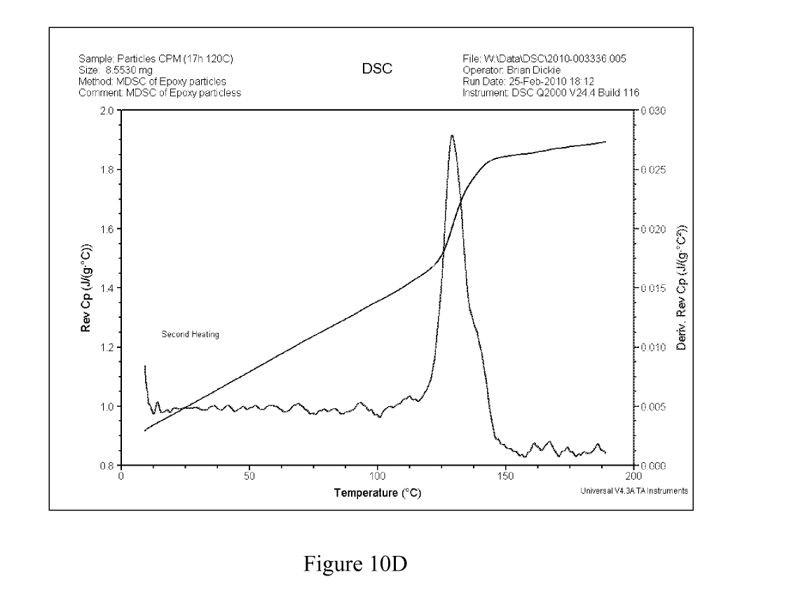

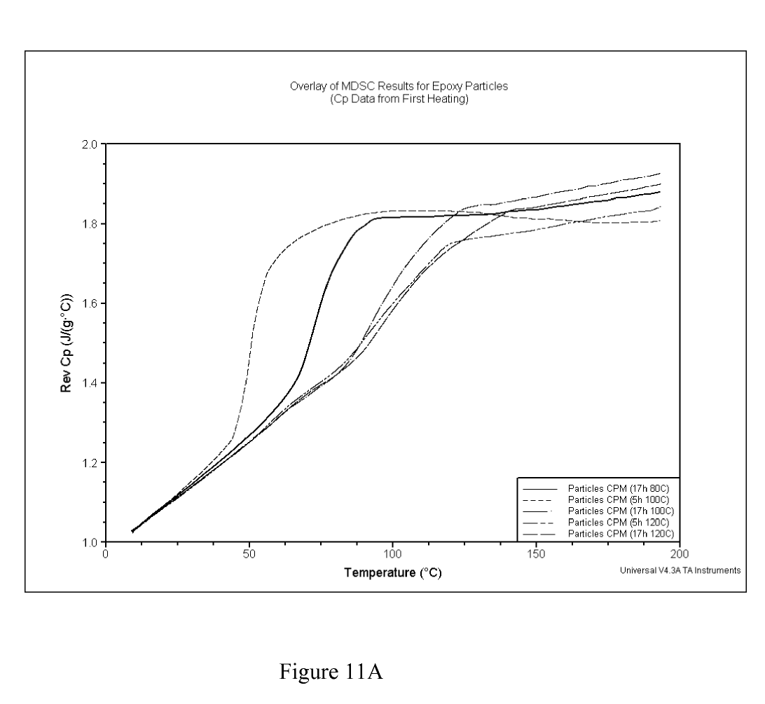

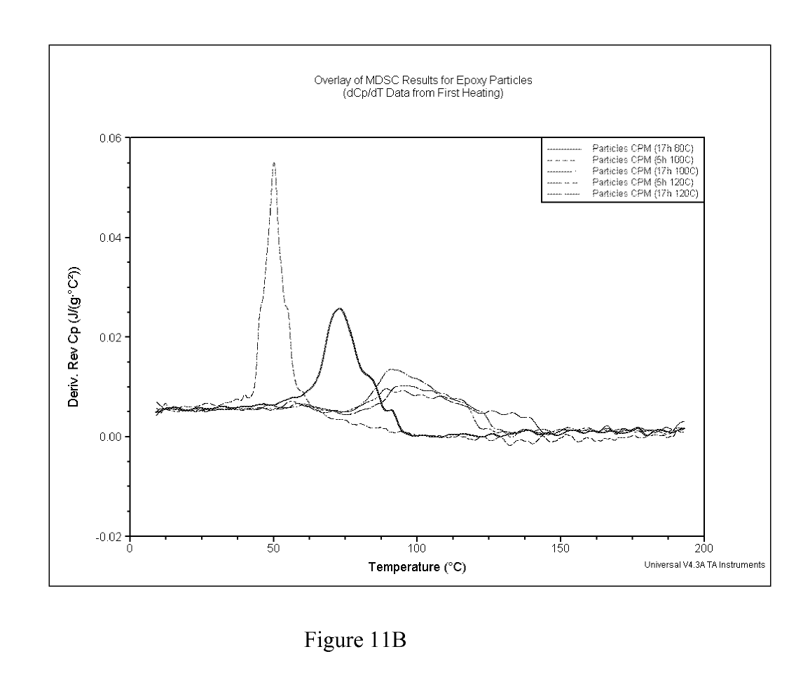

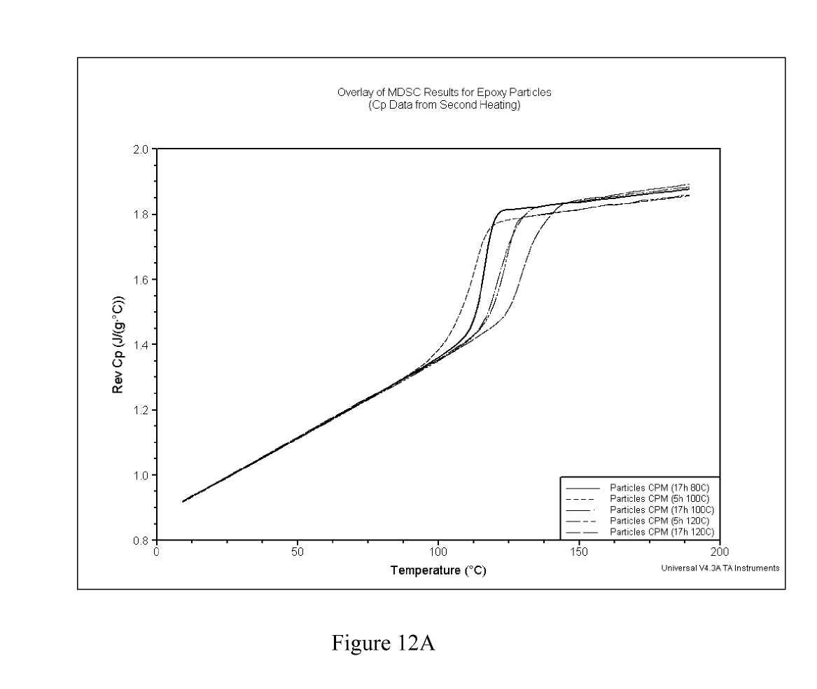

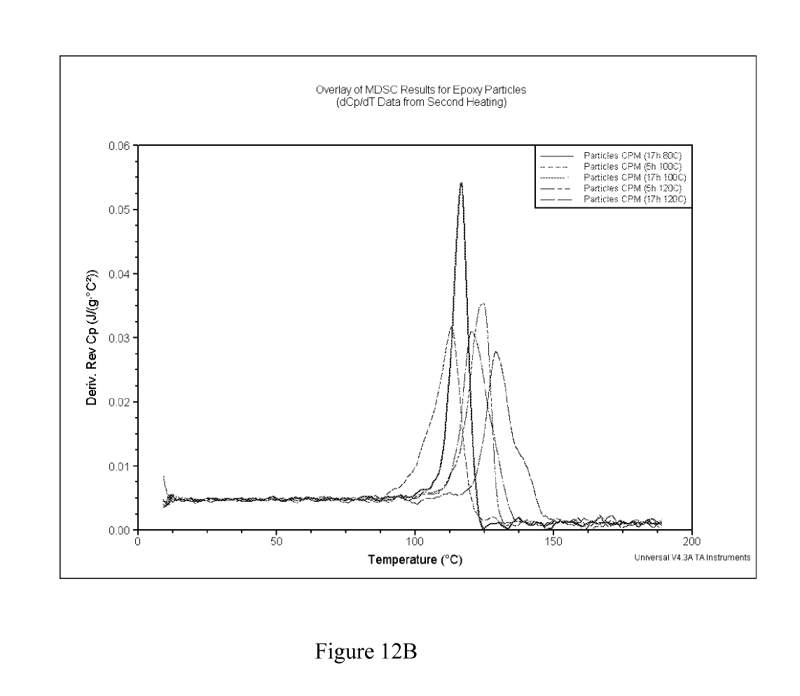

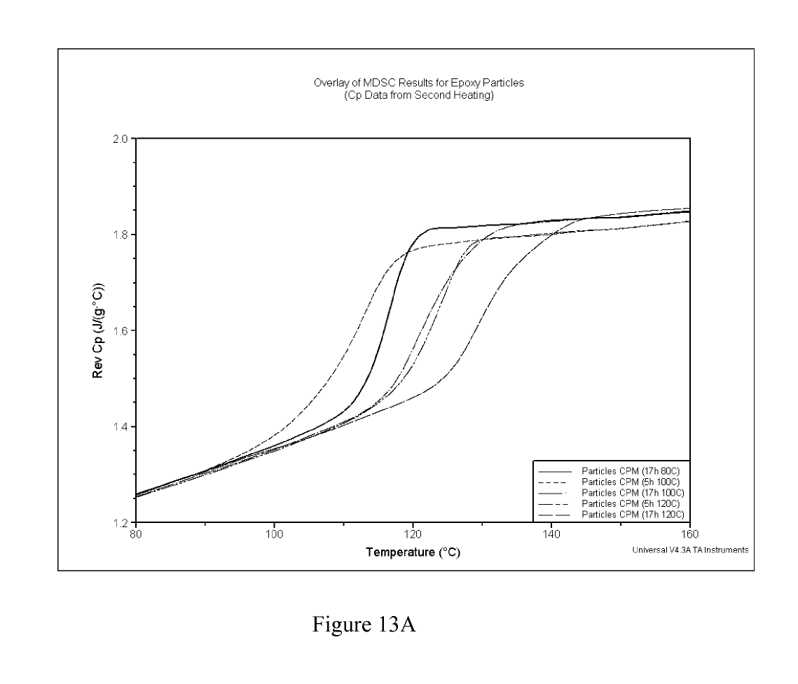

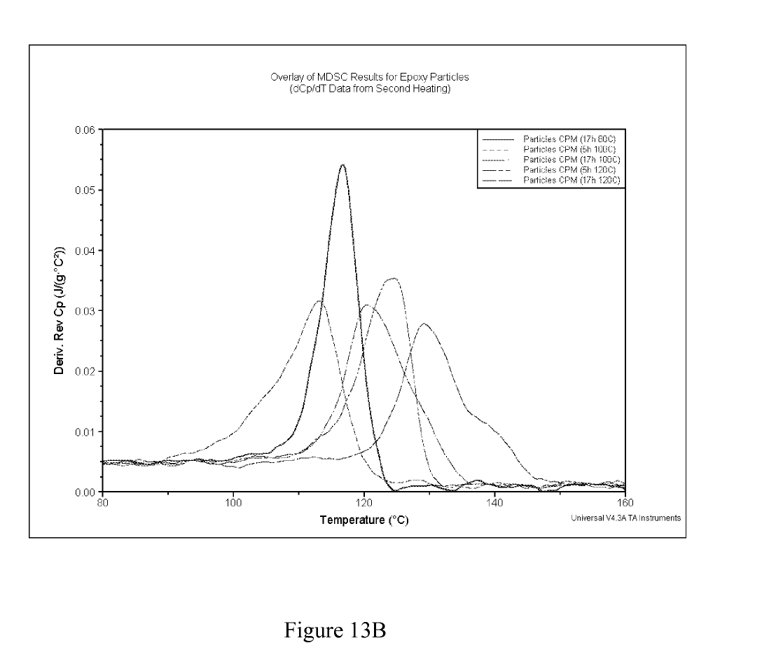

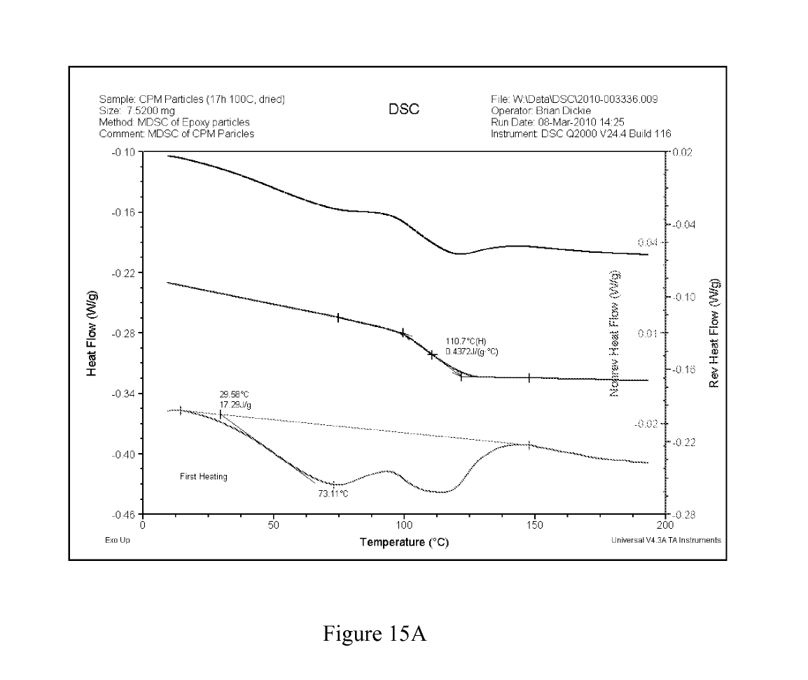

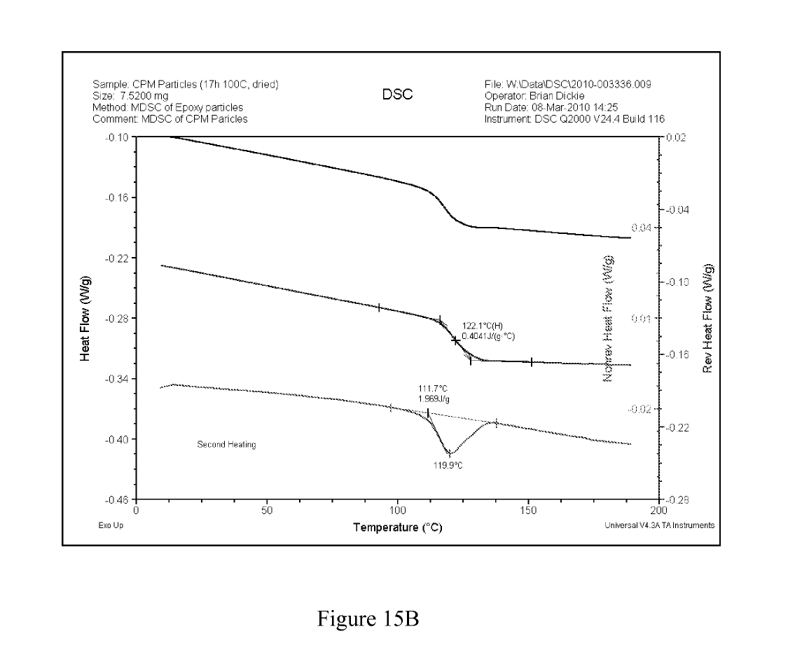

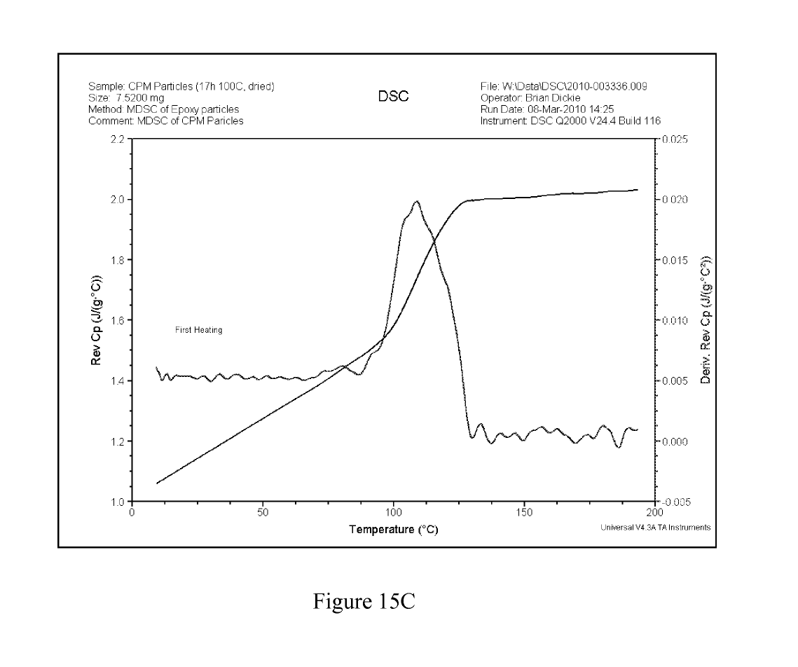

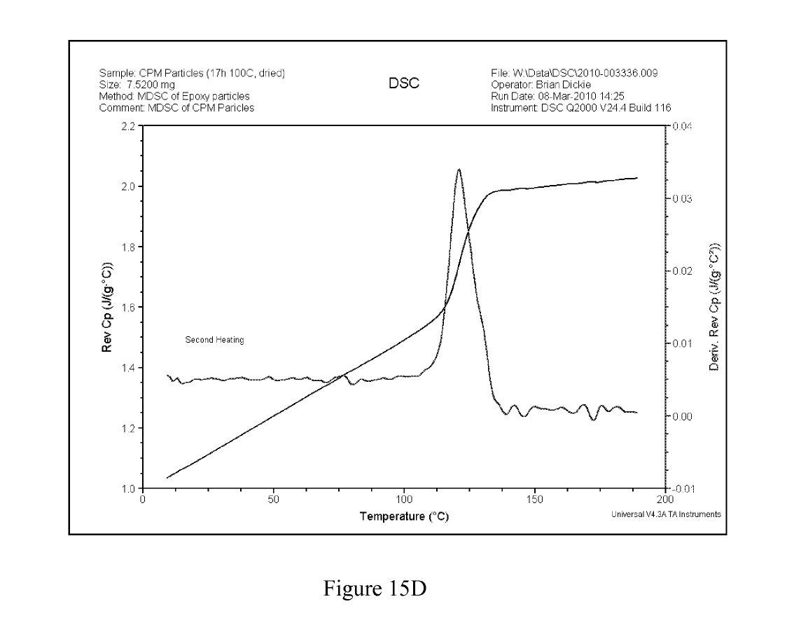

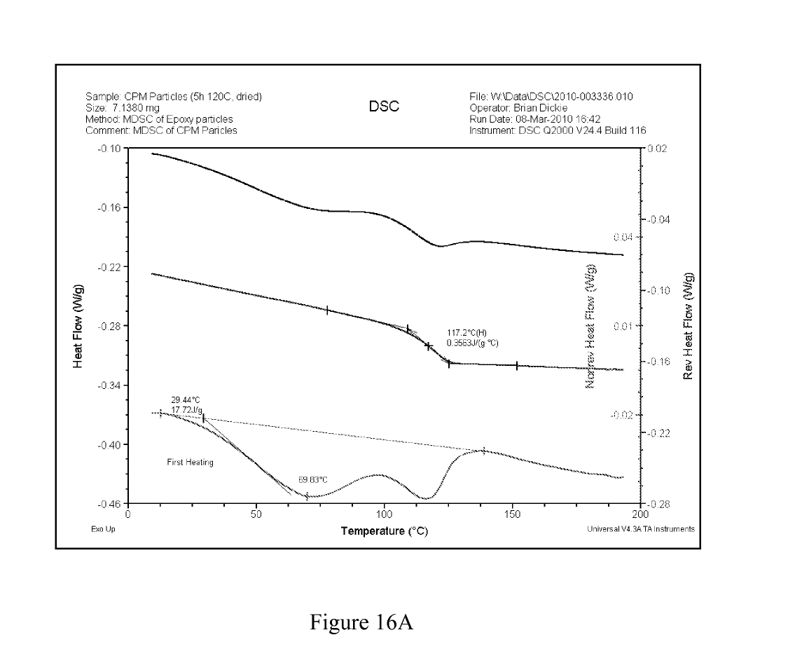

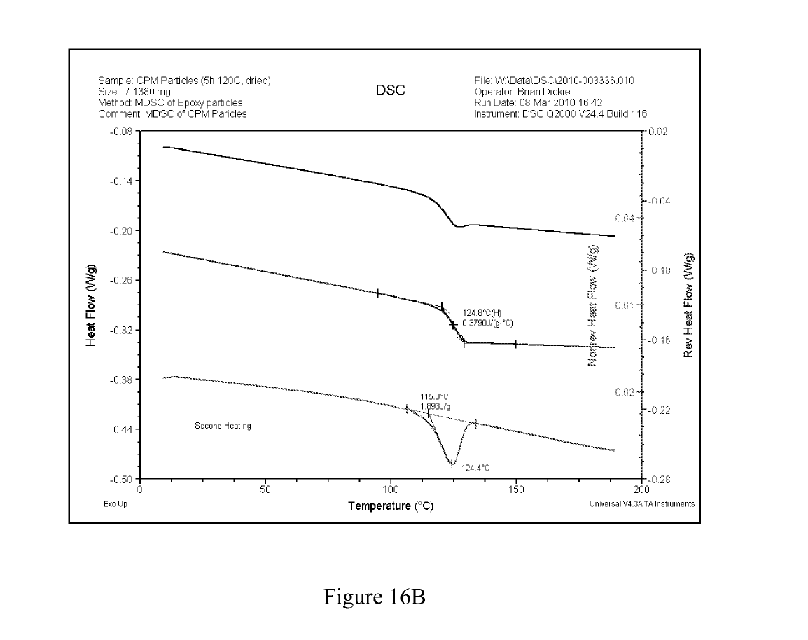

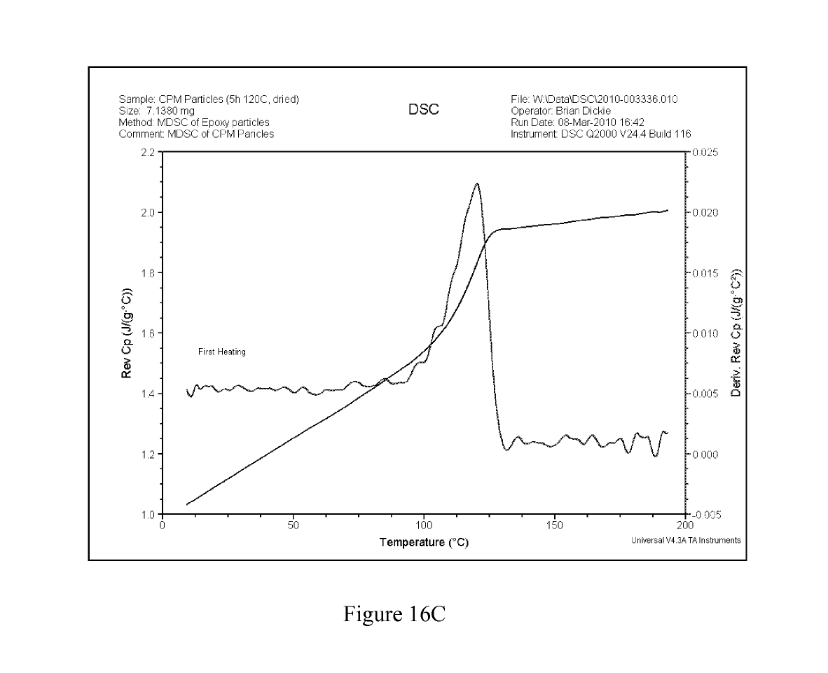

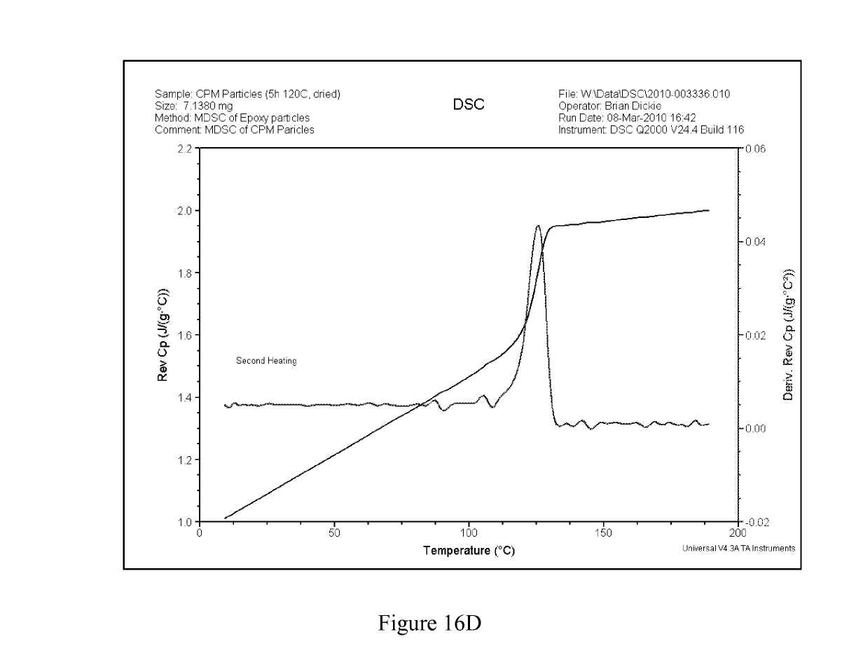

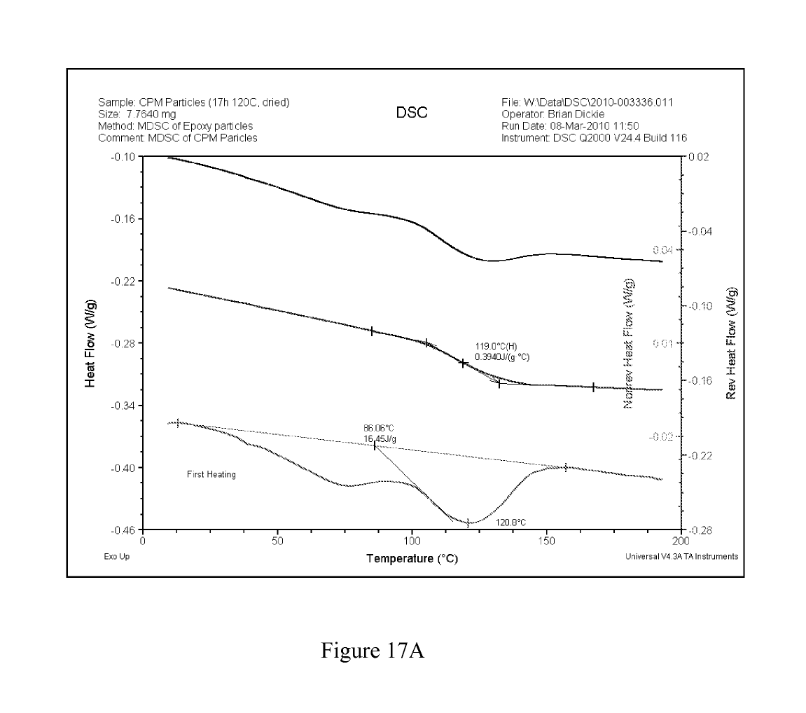

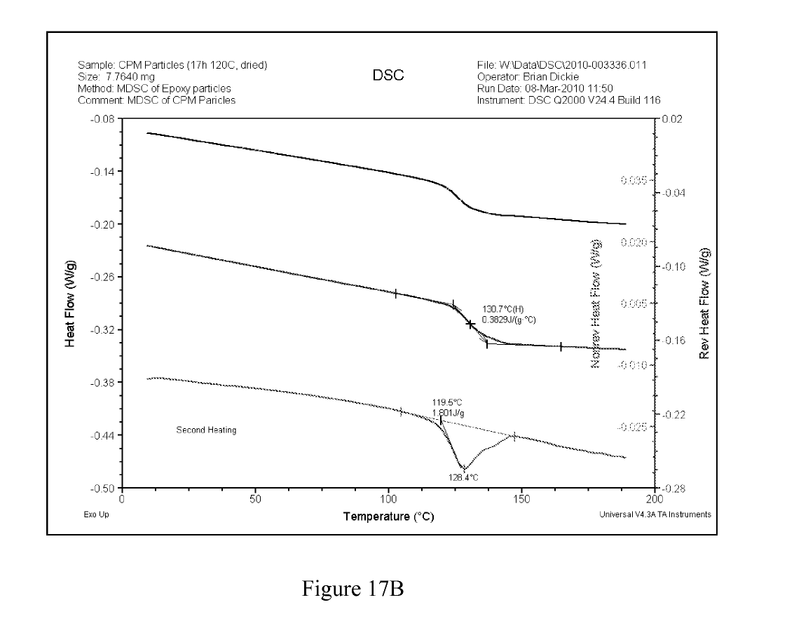

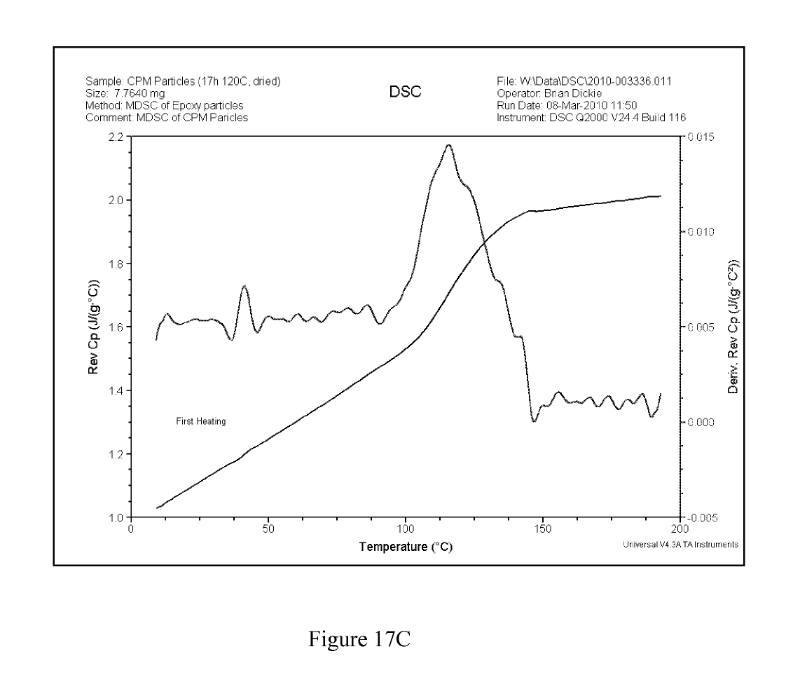

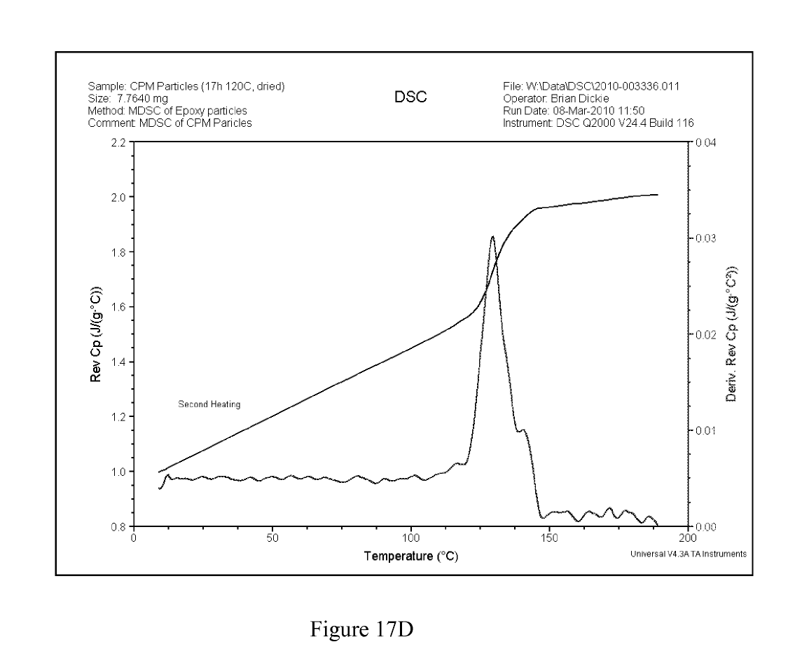

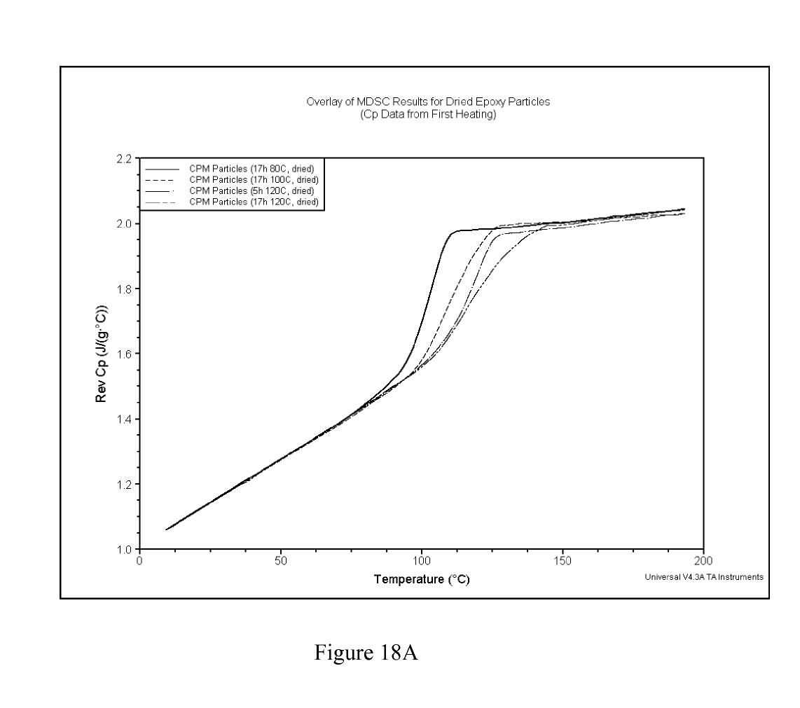

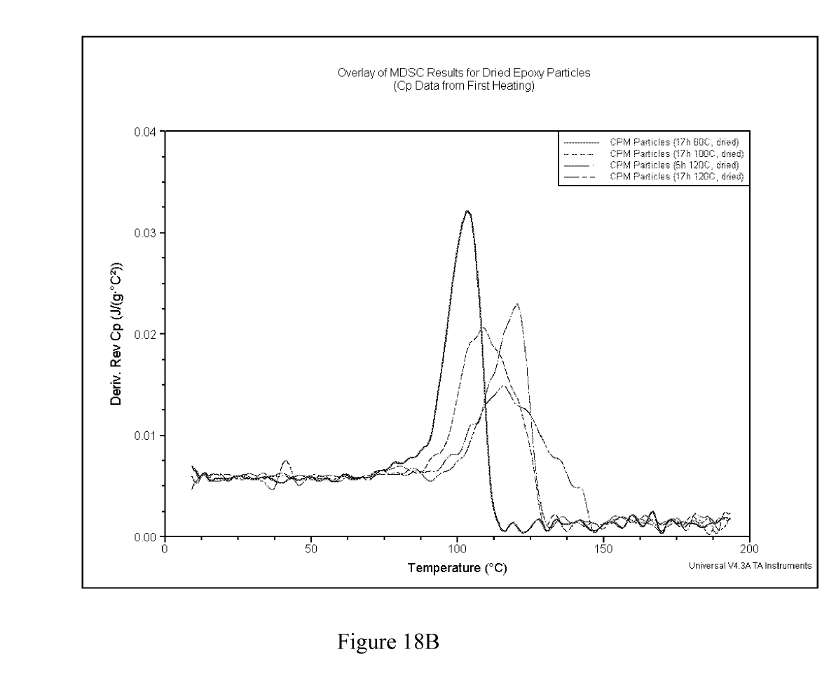

The behavior of Examples 13-18 of the cross-linked reactive polymer microparticles is shown in FIGS. 6-18. Each of the Examples 13-18 on the first heating had a large endothermic peak that is non-reversing in nature (i.e. it goes into kinetic signal of MDSC). The magnitude and width of this peak is indicative of an evaporation process. Table 6 below lists the weight loss by Examples 13-18 during the DSC experiment. Weight loss ranges from about 5.5 wt % up to a maximum of 9 wt %. It appears that a significant amount of solvent (acetone and THF from washing) is still present in the cross-linked reactive polymer microparticles. Drying via a vacuum oven was then performed. These levels of weight loss were confirmed by the TGA-MS analyzes done on the same samples.

The Tg in the first heating ranges from about 50° C. for the cross-linked reactive polymer microparticles produced at 100° C. for 5 hours (Example 15), to about 75° C. for the cross-linked reactive polymer microparticles produced at 80° C. for 17 hours (Example 14) and finally to about 100 to 105° C. for the remainder of the cross-linked reactive polymer microparticles (Examples 13 and 16-18). The shape of the Tg transitions are of interest, particularly on the high temperature side of the transition. This may be indicative of further reaction of the material or it could be coming from the simultaneous loss of solvent. No residual exothermic curing process is observed owing to the large solvent evaporation peak. In addition, if the residual exothermic process is weak and spread over a broad temperature range then it may not be visible even if there is no interference from the solvent evaporation.

In the second heating the Tg transition appears more “normal” in comparison to the first heating results (see FIGS. 6 to 18). The large endothermic peak is absent with just the usual enthalpy relation peak (about 2 J/g) being present. The transition has shifted to much higher temperatures and in most cases has become significantly sharper (i.e. narrower temperature range for transition). Now the Tg ranges from about 110° C. for the cross-linked reactive polymer microparticles produced at 100° C. for 5 hours (Example 15), to about 115° C. for the cross-linked reactive polymer microparticles produced at 80° C. for 17 hours (Example 14), to about 120° C. for the cross-linked reactive polymer microparticles produced at 100 and 120° C. at 17 and 5 hours respectively (Examples 16 and 17) to finally about 130° C. for the cross-linked reactive polymer microparticles produced at 120° C. for 17 hours (Example 18).

The width of the Tg transition is narrowest for the cross-linked reactive polymer microparticles produced at 80° C. (Examples 13 and 14). These Examples have a Tg that is more like a standard thermoplastic material instead of a crosslinked system. In addition, the Tg transition for these Examples 13 and 14 was about as narrow as for the standard thermoplastic material. Although the crosslink density is lower than the material produced at higher temperature (except for 5 hours at 100° C.) it appears that the homogeneity of the network is better (implied from width of Tg transition). As the reaction temperature and time increase the width of the Tg transition increases. This is consistent with a more heterogeneous polymer network.

TABLE 6
Summary of Weight Loss after DSC Analyses of as received
cross-linked reactive polymer microparticles

| Cross-Linked Reactive | Sample Weight | Weight Loss | |
|---|---|---|---|
| Polymer Microparticles | (mg) | (mg) | % Wgt Loss |
| Example 14 | 7.321 | 0.455 | 6.2 |
| Example 15 | 9.222 | 0.839 | 9.1 |
| Example 16 | 7.912 | 0.425 | 5.4 |
| Example 17 | 7.246 | 0.508 | 7.0 |
| Example 18 | 8.553 | 0.455 | 5.3 |

TABLE 7
Summary of Measured Tg Values of as received Cross-Linked
Reactive Polymer Microparticles

| Cross-Linked Reactive | Tg (° C.) from | Tg (° C.) from Second |
|---|---|---|
| Polymer Microparticles | First Heating | Heating |
| Example 14 | 74.4 | 116.2 |
| Example 15 | 51.0 | 111.2 |
| Example 16 | 98.7 | 122.0 |
| Example 17 | 100.0 | 122.9 |
| Example 18 | 104.9 | 131.0 |

The cross-linked reactive polymer microparticles of Examples 14-18 contain significant (5 to 9 wt %) levels of volatile materials as confirmed by both TGA and MDSC. The same level was measured by TGA and weight loss after the MDSC experiments. This weight loss comes from the evolution of residual solvent (THF and acetone) used to wash the residual polypropylene glycol (PPG). There was no clear evidence for the presence of residual PPG in any of the cross-linked reactive polymer microparticles. It is estimated that the level is less than about 0.1 weight percent (wt. %) or 1000 ppm.

The residual solvent acts as a plasticizer for the cross-linked reactive polymer microparticles. The Tg measured during the first heating is much lower and broader than that measured in the second heating. The initial Tg of the partially dried cross-linked reactive polymer microparticles is higher than the as received cross-linked reactive polymer microparticles, but still considerably lower than that measured after complete removal of the solvents. The final Tg is a function of reaction temperature and time. At a reaction temperature of 80° C. the final Tg of the cross-linked reactive polymer microparticles is about 115° C. and this shifts to about 122° C. for reaction at 100° C. and then finally to about 130° C. for reaction at about 120° C. A longer reaction time at a given temperature gives a small increase in Tg and a broader transition. At the highest temperature and longest reaction time the Tg of the cross-linked reactive polymer microparticles is slightly higher than the Comparative Epoxy Example. The cross-linked reactive polymer microparticles and the Comparative Epoxy Example have very similar thermal degradation behavior. The evolved species are essentially the same indicating that the chemical composition of the cross-linked reactive polymer microparticles and the Comparative Epoxy Example are the same. FIGS. 6a to 13b provide the MDSC and TGA-MS measurements on cross-linked reactive polymer microparticles of Examples 14-18.

Analysis of the Cross-Linked Reactive Polymer Microparticles after Drying

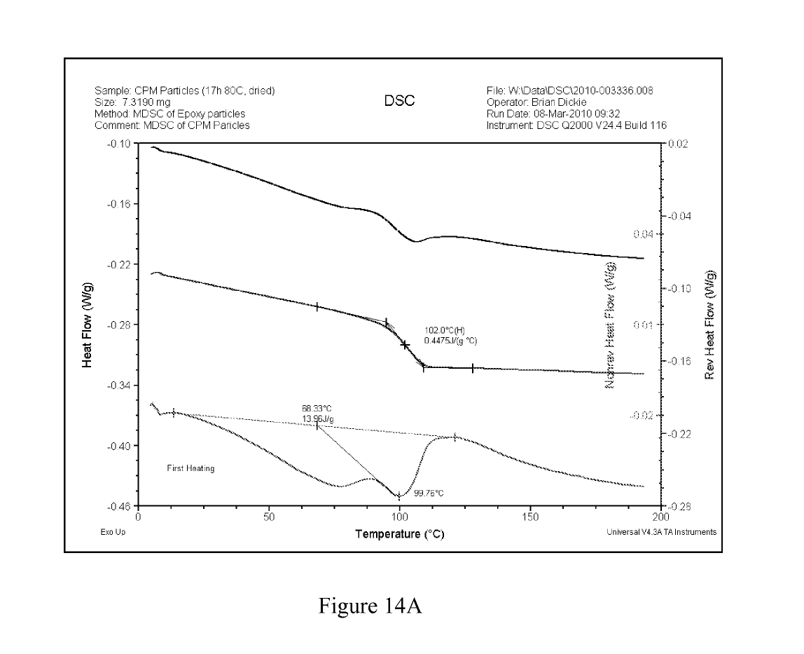

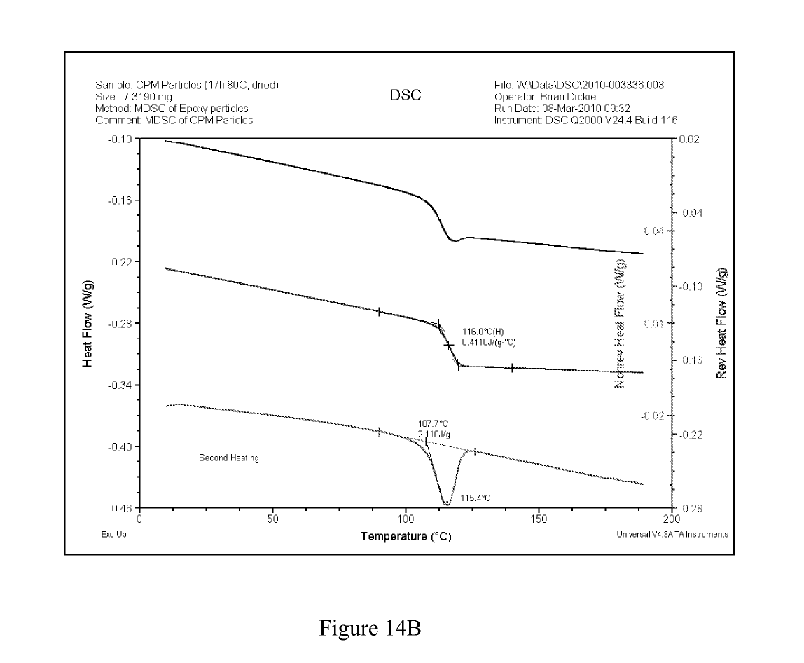

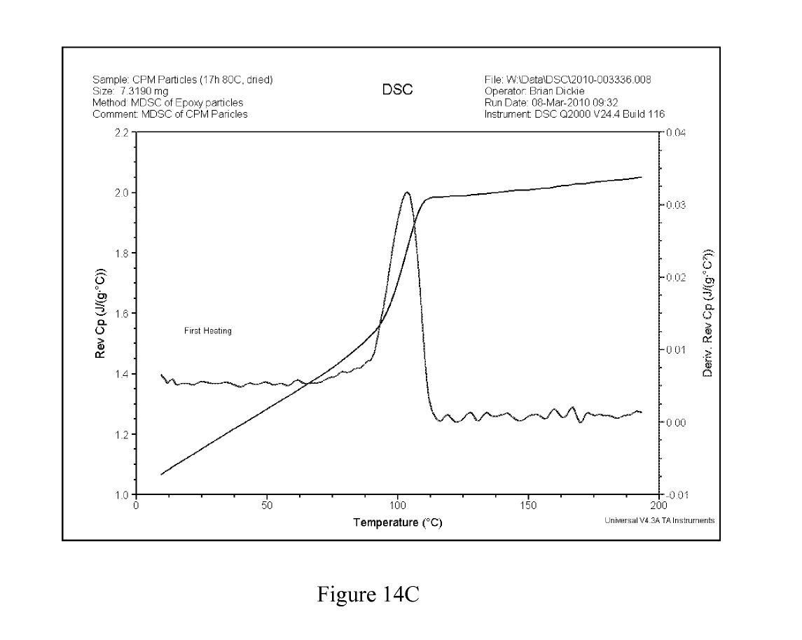

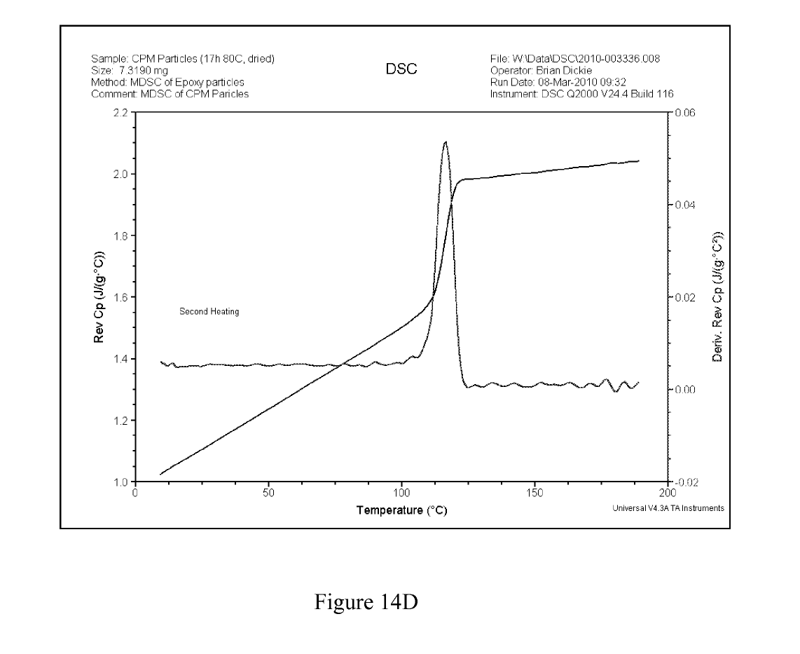

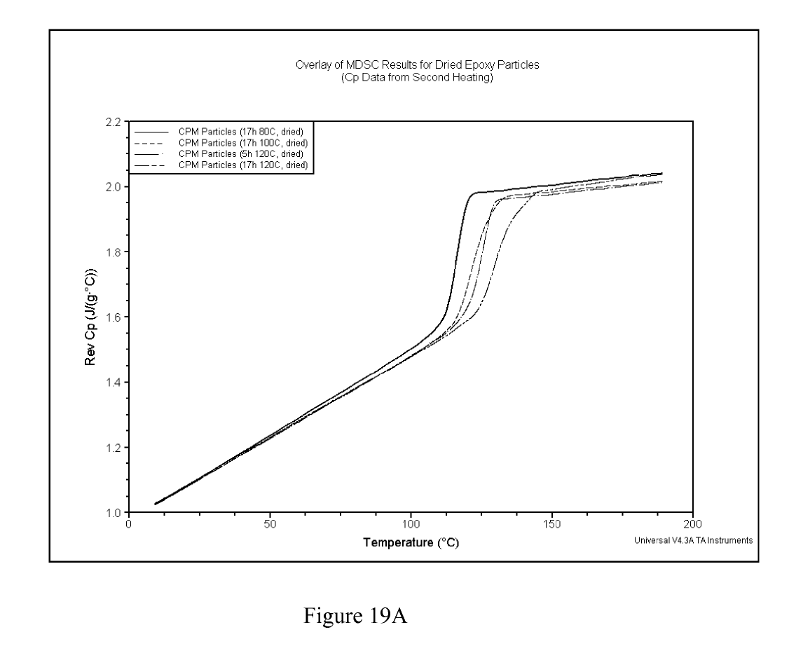

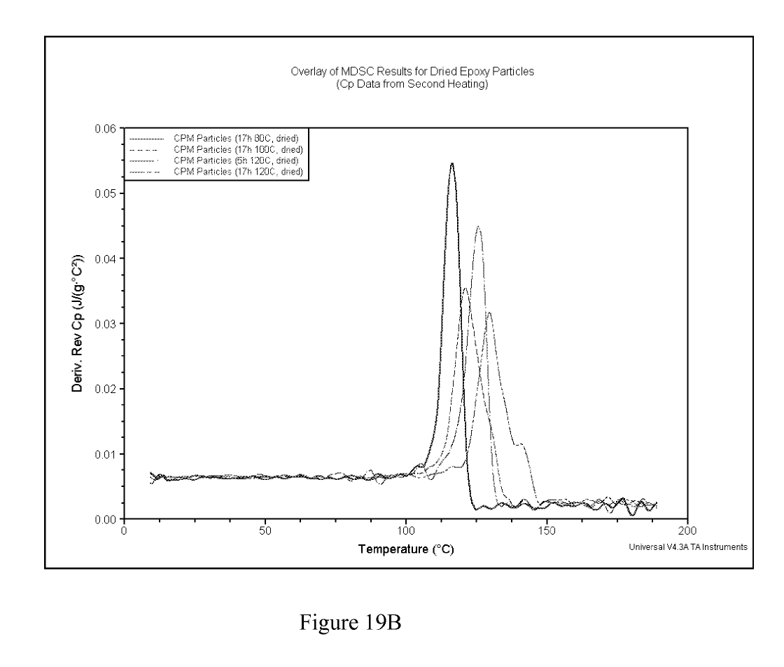

The MDSC results of the four dried cross-linked reactive polymer microparticles (Examples 14-18) are illustrated in FIGS. 14a to 19b and summarized in Tables 8 and 9. It is still clear from the results of the first heating that the Examples 14-18 still contain volatile material. That is, not all of the solvent has been removed by the vacuum drying step at 40° C. for about 64 hours. From the measured weight of the Examples 14-18 before and after analysis (see Table 8) it was observed that all of the Examples 14-18 still lose about 2 wt %. This low temperature weight loss is shifted to higher temperatures in comparison to the as received cross-linked reactive polymer microparticles and as a consequence the measured Tg is shifted to higher temperature and the transition occurs over a narrower temperature range. However, the final Tg measured in the second heating is more or less the same as measured previously.

As the reaction temperature increases the final Tg of the cross-linked reactive polymer microparticles increases. A longer reaction time at a given temperature also appears to increase the final Tg as well as broaden the Tg transition.

TABLE 8
Summary of Weight Loss after DSC Analyses of Cross-Linked
Reactive Polymer Microparticles of Examples 14 and 16-18

| | Sample Weight | Weight Loss | |
|---|---|---|---|
| Material | (mg) | (mg) | % Wt Loss |
| Example 14 | 7.319 | 0.085 | 1.2 |
| Example 16 | 7.520 | 0.167 | 2.2 |
| Example 17 | 7.138 | 0.146 | 2.0 |
| Example 18 | 7.764 | 0.169 | 2.2 |

TABLE 9
Summary of Measured Tg Values of Dried Samples of Cross-
Linked Reactive Polymer Microparticles of Examples
14 and 16-18

| | | Tg (° C.) from Second |
|---|---|---|
| Material | Tg (° C.) from First Heating | Heating |
| Example 14 | 102.0 | 116.0 |
| Example 16 | 110.7 | 122.1 |
| Example 17 | 117.2 | 124.8 |
| Example 18 | 119.0 | 130.7 |

### TGA-MS of Cross-Linked Reactive Polymer Microparticles

The main reason for performing the TGA-MS experiments was to determine if any PPG was still present in the cross-linked reactive polymer microparticles. PPG had been employed as solvent during the polymerization to form the cross-linked reactive polymer microparticles and although the final product was washed several times with THF and acetone some PPG may still be present. In order to check for the presence of PPG the different cross-linked reactive polymer microparticles were analyzed along with the pure PPG and the self-cured epoxy resin. These latter two materials were analyzed to provide reference data.

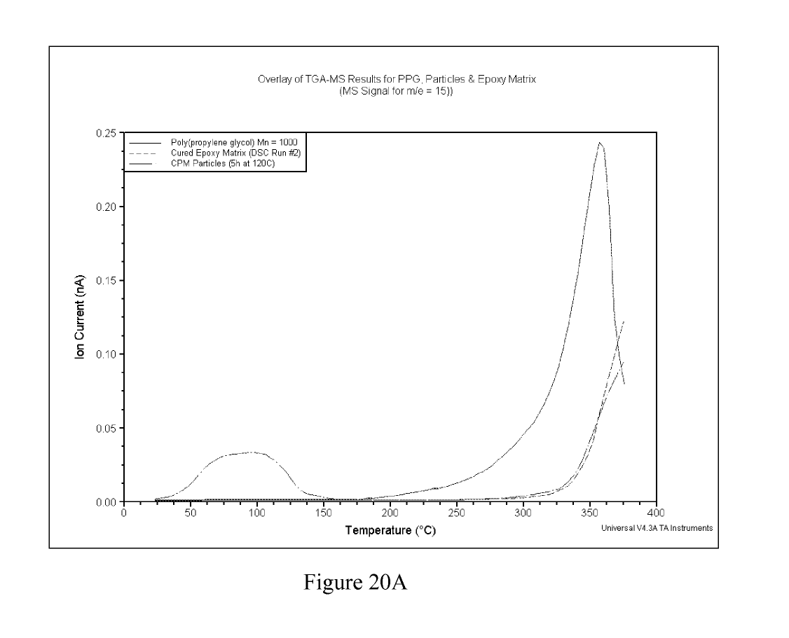

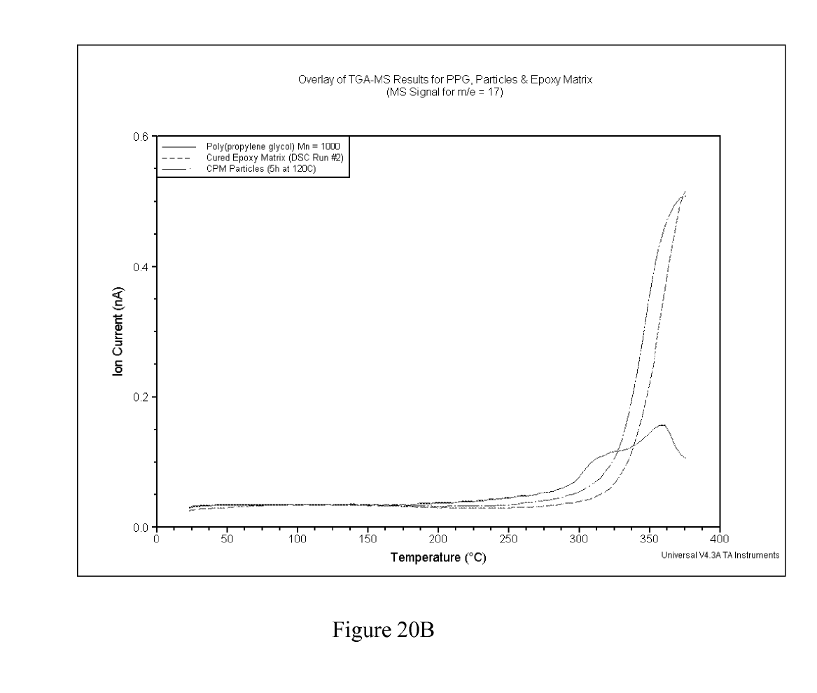

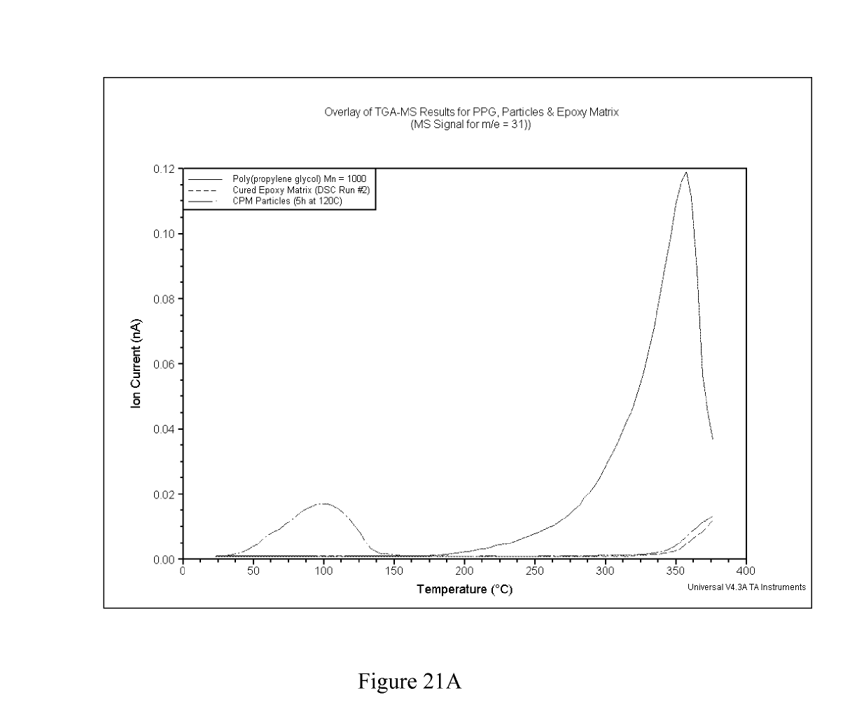

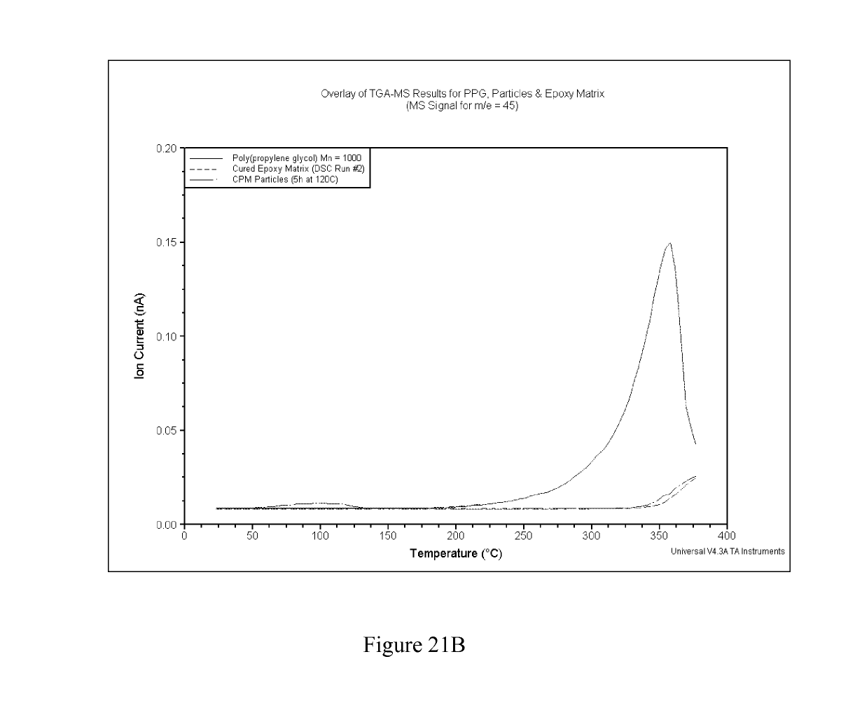

Some overlay plots of MS signals for PPG, Epoxy matrix and Example 17 of the cross-linked reactive polymer microparticles are illustrated in FIGS. 20A-20B and 21A-21B. All of the samples being compared had a similar starting weight (about 5.5 mg) so that the MS signals can be compared quantitatively without any modification. The choice of MS signals was made on the basis of the strength and/or shape of these signals for the pure PPG material.

In FIGS. 20A and 20B the MS signals for m/e=15 and 17 are compared for PPG, Epoxy matrix and Example 17 of the cross-linked reactive polymer microparticles. The m/e=15 signal is quite strong for all materials. The cross-linked reactive polymer microparticles give a peak at low temperatures that is coming from the loss of residual solvent (THF and acetone) whereas the other two materials do not give any significant signal for this m/e value until 200 to 250° C. It is clear that the strength and shape of the signal for the cross-linked reactive polymer microparticles is very similar to that of the epoxy matrix. The strength of this signal is the same or weaker for the cross-linked reactive polymer microparticles in comparison with the epoxy matrix. If any significant amount of PPG was still present in the cross-linked reactive polymer microparticles the strength if this signal should be stronger for the cross-linked reactive polymer microparticles. The MS signal for ink=17 (water) has a characteristic shape for the PPG signal and this is not observed for the epoxy matrix and the cross-linked reactive polymer microparticles. Again there is no evidence for the presence of any significant amount of PPG left in the cross-linked reactive polymer microparticles.

In FIGS. 21A and 21B the MS signals for m/e=31 and 45 are compared for the three materials. These signals are particularly strong for the PPG material and relatively weak for the epoxy matrix and cross-linked reactive polymer microparticles. In both cases the signal for the cross-linked reactive polymer microparticles is slightly stronger than for the epoxy matrix. This could imply that low levels of PPG are still present in the cross-linked reactive polymer microparticles. If this slightly stronger signal for the cross-linked reactive polymer microparticles does indeed mean that some PPG is still associated with the particles it is estimated that the amount is no more than about 0.1 wt % (i.e. 1000 ppm).

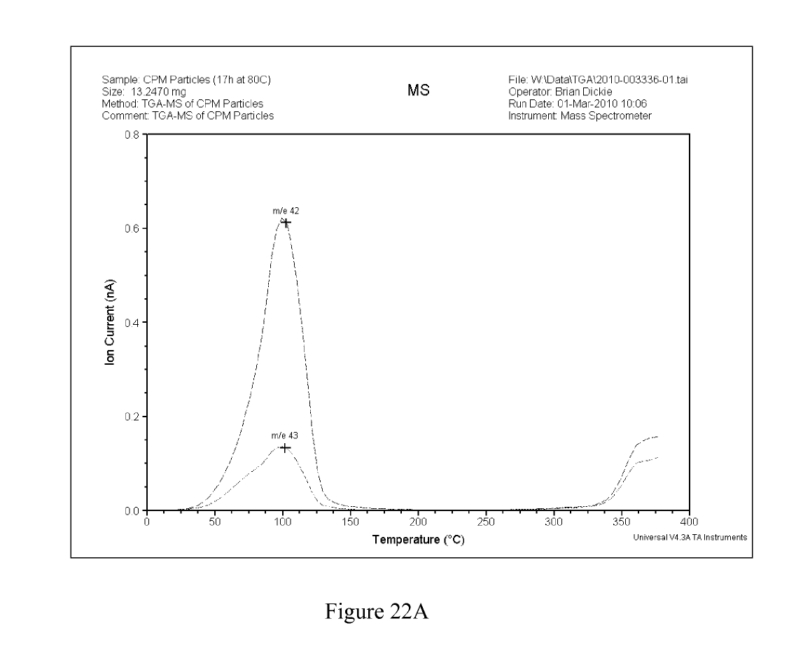

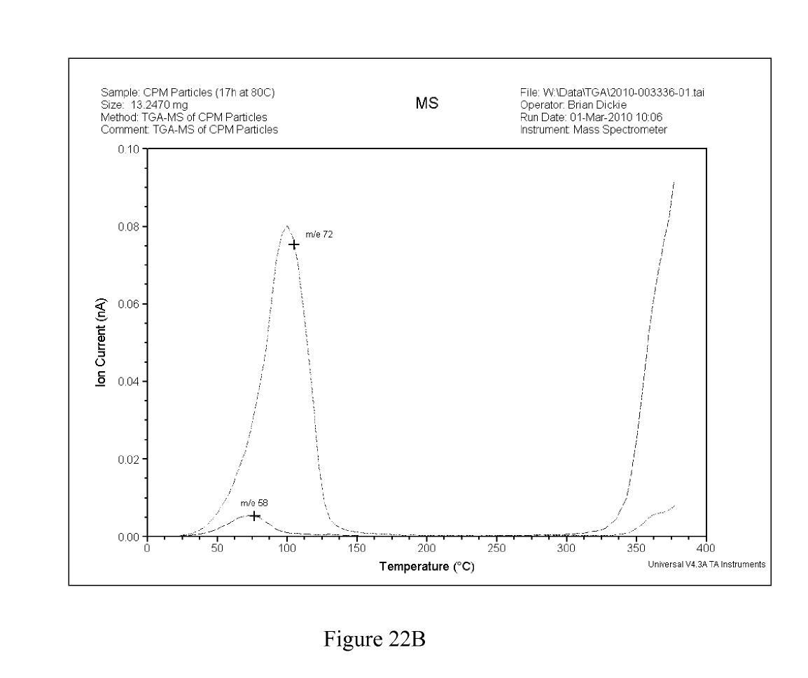

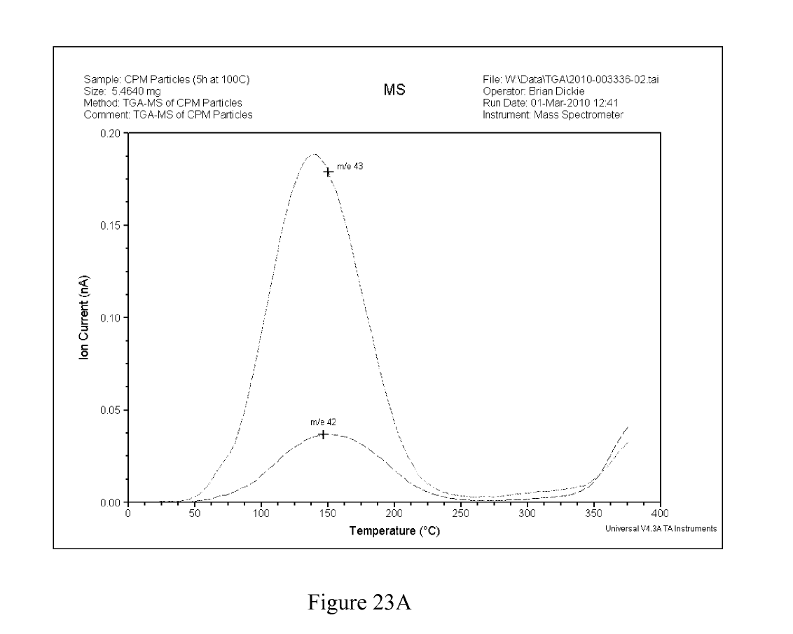

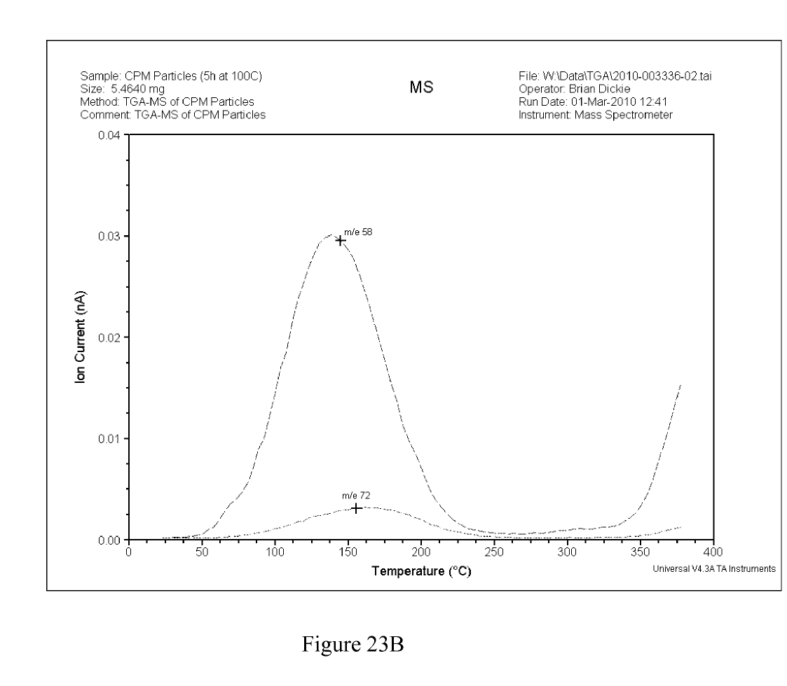

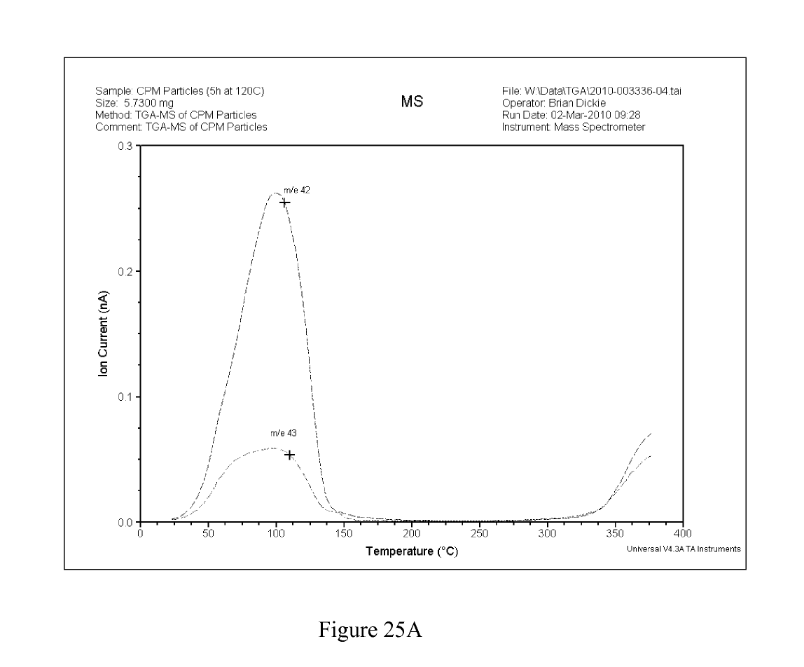

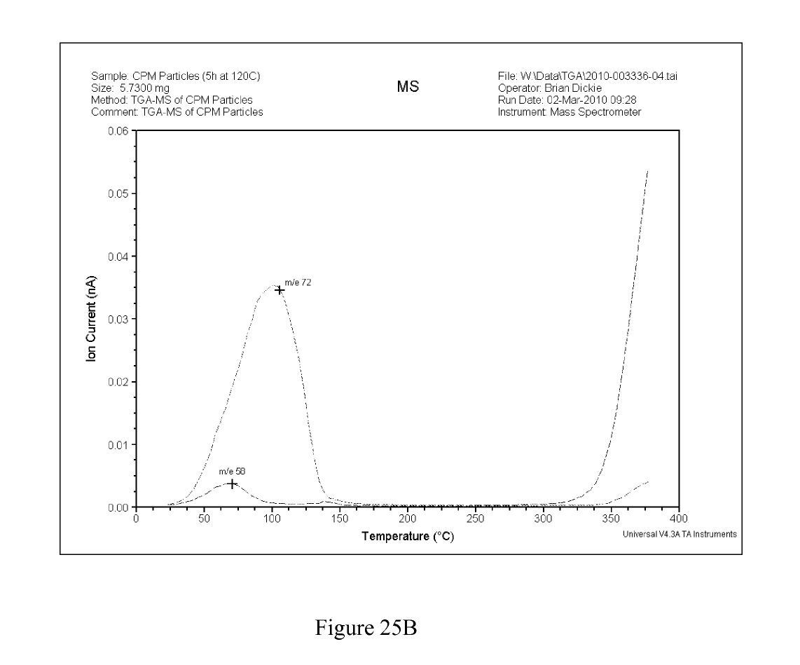

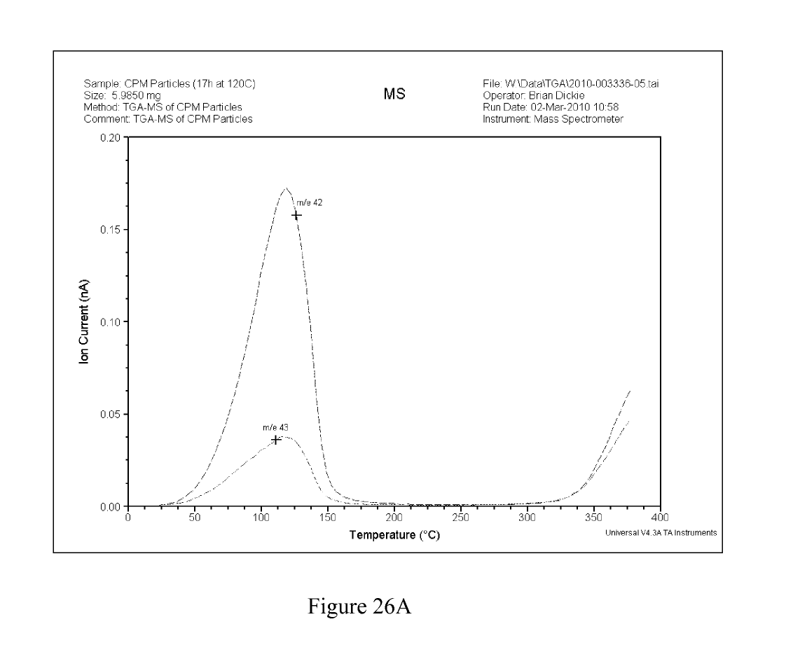

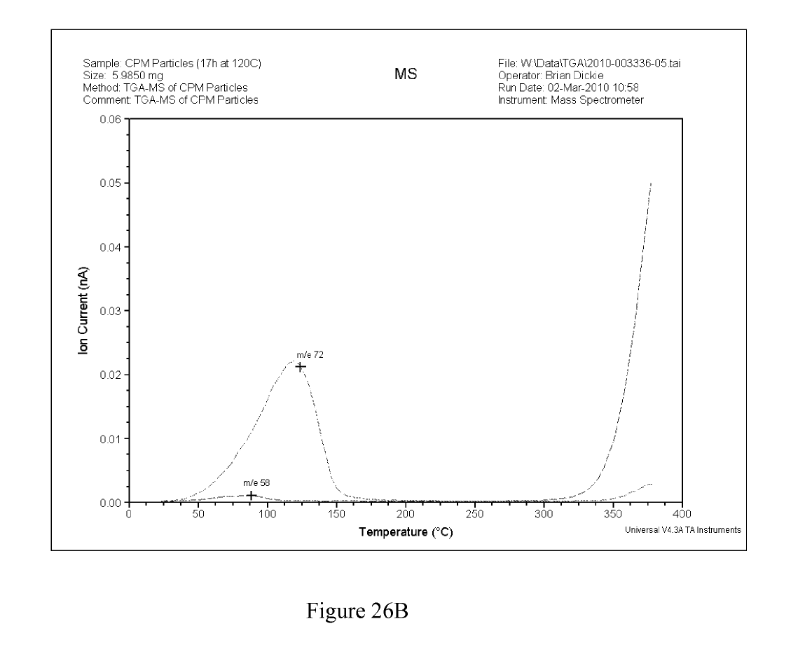

Examples 14-18 of the cross-linked reactive polymer microparticles lose a significant amount of weight (5-8 wt %) at temperatures below 150° C. These weight loss values are in good agreement with that found from the weight lost during the MDSC experiments. Since the samples had been washed with THF and acetone it is logical that one or both of these solvents is giving rise to this weight loss. The selected MS signals of m/e=42, 43, 59 and 72 for the cross-linked reactive polymer microparticles are illustrated in FIGS. 22A to 26B. Examination of MS reference spectra indicate that, at low temperatures, the MS signals for m/e=42 and 72 are mainly coming from THF and the MS signals for m/e=43 and 58 are mainly coming from acetone.

Particle Shape and Size Distribution of the Cross-Linked Reactive Polymer Microparticles

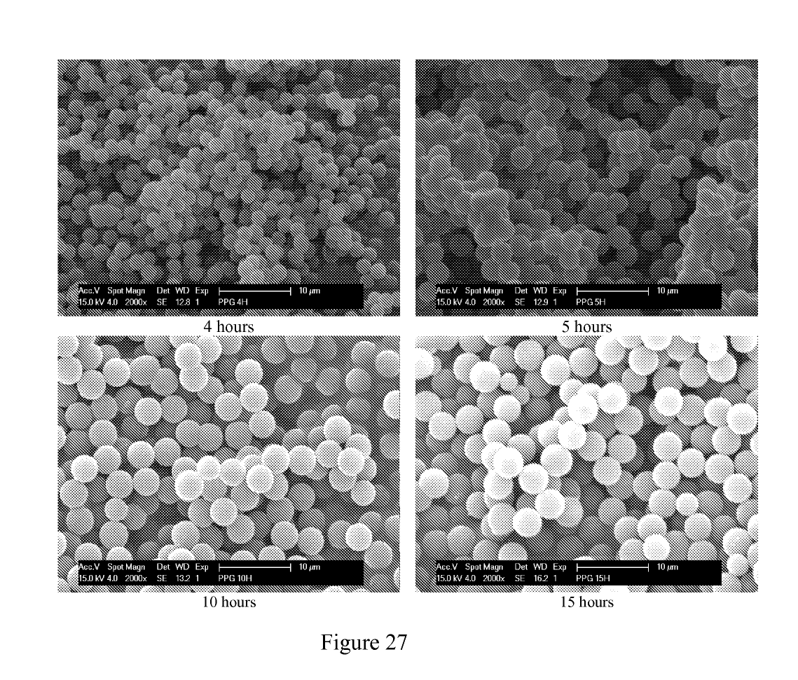

SEM micrographs of a powder of the cross-linked reactive polymer microparticle of Example 1-12 were acquired in order to assess the shape and the dimension of the cross-linked reactive polymer microparticles. FIG. 27 shows the images of cross-linked reactive polymer microparticles where the effect of the reaction time on their diameter is visible. All cross-linked reactive polymer microparticles have a spherical shape.

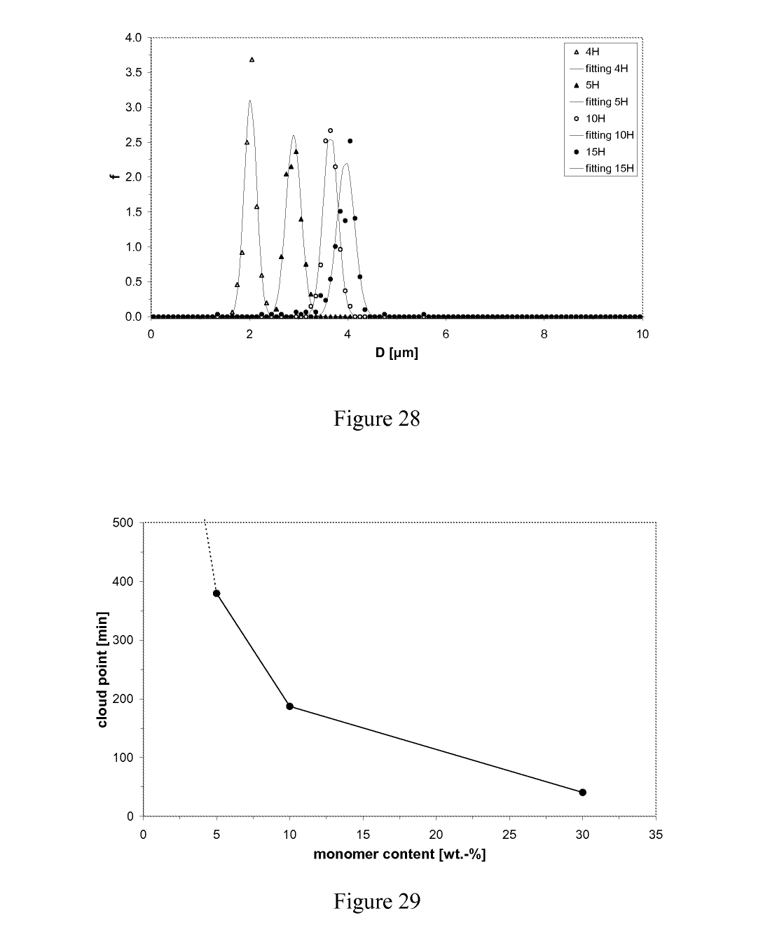

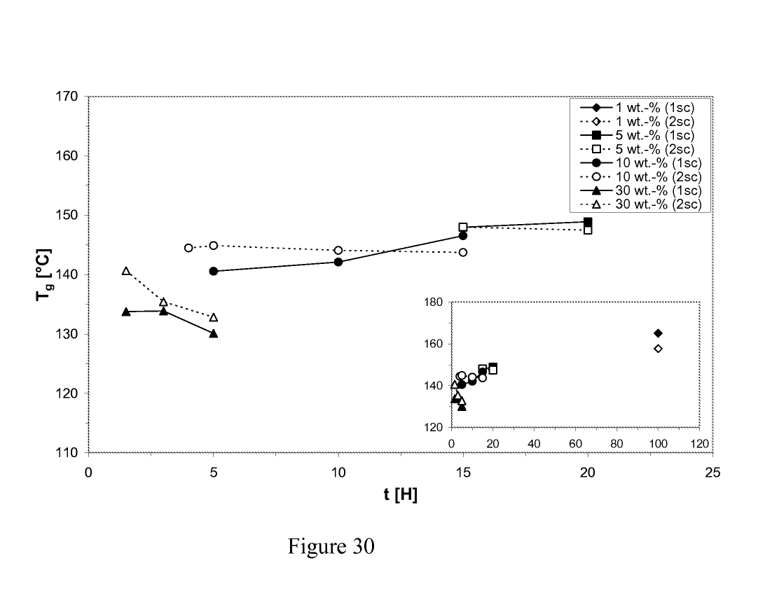

The SEM micrographs were used to determine the particle size distribution. FIG. 28 shows the particle sized distribution and FIG. 30 shows the average diameter of the cross-linked reactive polymer microparticles as a function of the reaction time. The cross-linked reactive polymer microparticle dimension follows a monomodal narrow Gaussian distribution. The average dimension of the cross-linked reactive polymer microparticle increases progressively from 2.02±0.13 μm after 4 hours to 3.9±0.3 after 15 hours of reaction time when a plateau value of the diameter is reached. The standard deviation, ranging from 0.13 to 0.3 μm, and the index of polydispersity, lower than 1.01, confirmed the very narrow distributions.

Effect of Monomer Concentration

The effect of the monomer concentration (DGEBA+DAT, a/e ratio=1.35) in the same solvent (PPG-1000) on the synthesis and characteristics of cross-linked reactive polymer microparticles of Examples 1-12 was investigated.

The cloud point shows a clear decrease as the monomer concentration is increased: from 380 minutes to 41 minutes as the concentration changes from 5 wt % to 30 wt %, as shown in FIG. 29. This expected effect was firstly because the epoxy/amine reaction proceeds faster as the concentration is increased and secondly because higher monomer concentration corresponds to a region of the phase diagram that induces phase separation at lower conversion.

Cross-Linked Reactive Polymer Microparticle Characterization

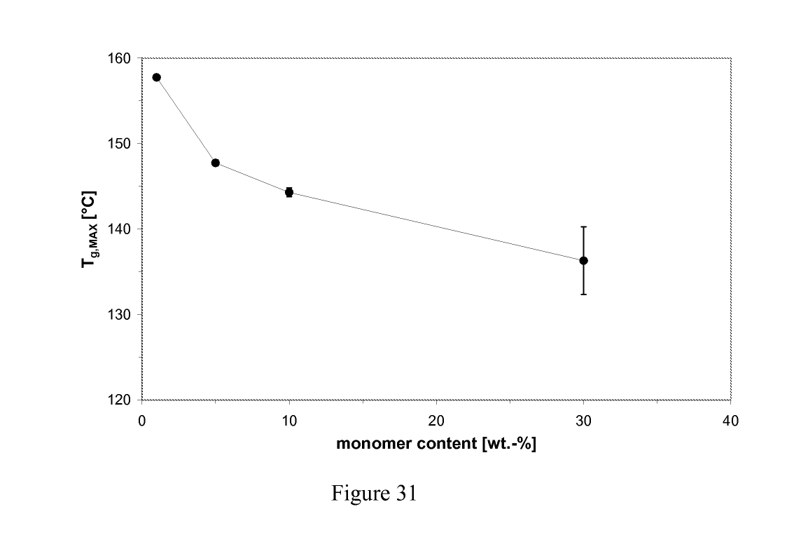

FIG. 31 demonstrates the strong influence of the monomer concentration on the Tg: it decreases as the monomer concentration is increased, from 158° C. at a monomer concentration of 1 wt % to 136° C. at a monomer concentration of 30 wt % (values obtained after the longest reaction time, and during the 2^{nd} DSC scan). This is a significant difference. The trend is the same for Tg measured during the first DSC scan (which is the value at the end of the synthesis) or the second scan (which represents the maximum value that the particles can reach after full cure). A higher Tg means higher crosslink density, so an effective stoichiometry of the cross-linked reactive polymer microparticles is close to 1. This high Tg excludes the presence of PPG as a miscible polymer in the particles, because PPG (if miscible) will have a plasticizing effect. A lower Tg means lower crosslink density, which can have several reasons: incomplete curing, stoichiometry far from 1, and/or plasticizing effect of PPG, among other reasons.

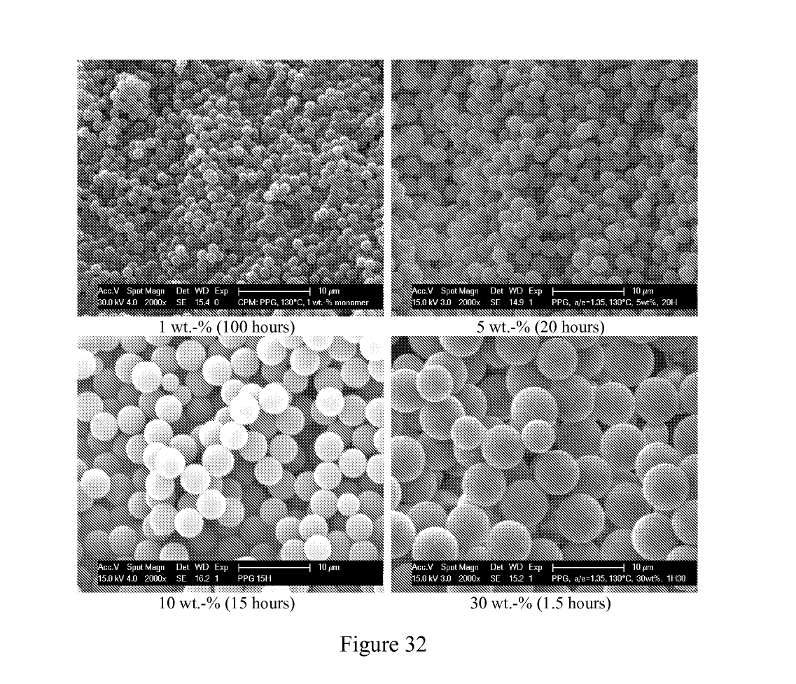

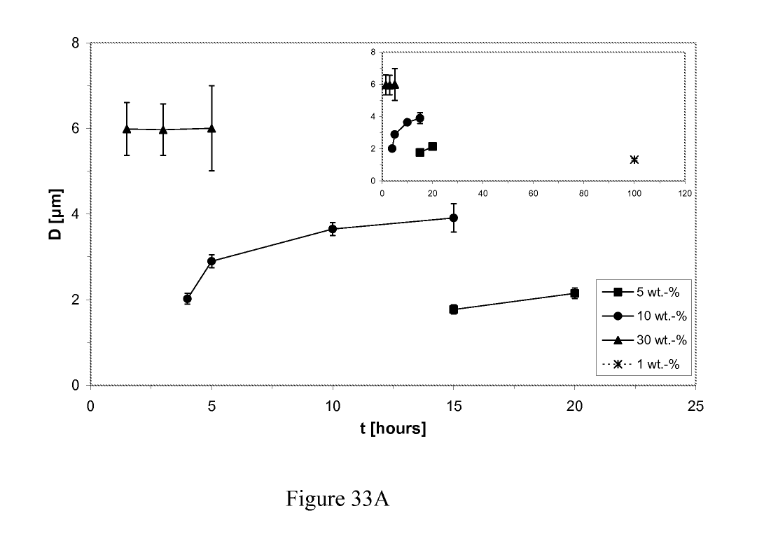

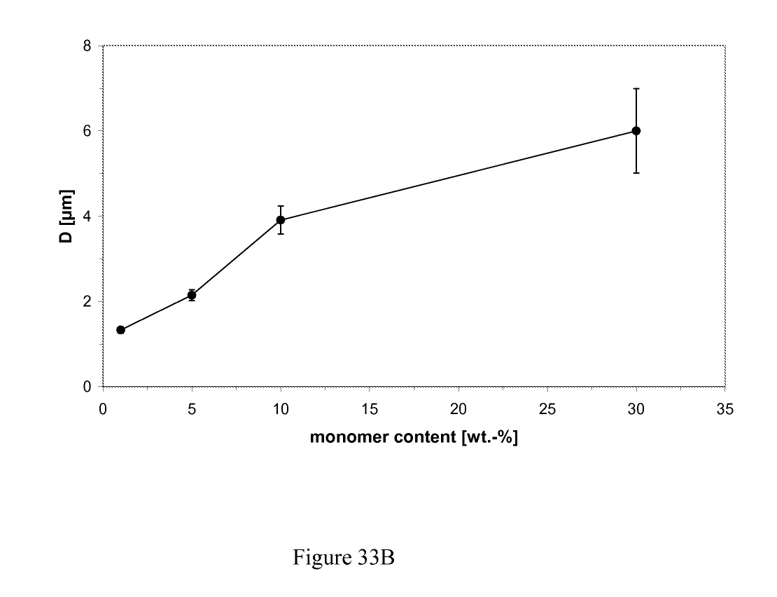

The SEM micrographs confirmed the formation of spherical micrometer-size particles. FIG. 32 shows some examples of acquired SEM micrographs of cross-linked reactive polymer microparticles, which were produced from solutions with different monomer content. Some agglomerates are observed on SEM images of cross-linked reactive polymer microparticles prepared from a 1 wt % monomer concentration. Using the SEM micrographs, the average cross-linked reactive polymer microparticle diameter (with the standard deviation) was calculated and is depicted in FIGS. 33A and 33B.

Similarly to the cross-linked reactive polymer microparticle yield and cloud point, different monomer content caused different particle growth kinetics and different value of the average cross-linked reactive polymer microparticle diameter at the plateau. This value increases almost linearly with the monomer content: the diameter at long reaction time increases from about 1 μm at 1 wt. % to about 6 μm at 30 wt. %. The smallest particles (1 μm) are the one having the highest Tg (158° C.), but the lowest yield. An increase of the polydispersity is observed as the concentration is increased even if it remained in the range of very narrow distribution (1.002-1.03). The standard deviation increased from 0.7 μm in the case of 1 wt. % after 100 hours to 1 μm in the case of 30 wt. % after 5 hours of reaction.

### Influence of the Molar Ratio

The effective amine to epoxy ratio (a/e ratio) of the cross-linked reactive polymer microparticles is different from the one in the feed, which was a/e ratio=1.35. The following illustrates the effect of a variation of the molar ratio in the feed on the formation and characteristics of the cross-linked reactive polymer microparticles. Four a/e ratios were studied: 0.7 (excess of epoxy), 1 (same number of amine and epoxy), 1.35 and 2 (excess of amine).

Synthesis

There is a decrease of the time to phase separation as the amine/epoxy ratio is increased: from 267 minutes for a/e ratio=0.7 to 159 minutes for a/e ratio=2. This behavior could be related to the structure of the oligomers, which is strongly dependent on the molar ratio: at a/e ratio>1, the oligomers formed have a more linear structure, with remaining —NH groups, than the ones obtained when a/e ratio<1, which have a branched structure with dangling epoxy groups. As these oligomers do not have the same chemical structure, they have different solubility parameters and as a consequence they do not separate at the same time because of a different phase diagram. This behavior could also be related to the cross-linking kinetics, which is influenced by the relative monomer composition.

### Cross-Linked Reactive Polymer Microparticle Characterization

The time of reaction (as soon as it is higher than 5 hours) and of the values for Tg obtained during the first DSC scan or the second DSC scan do not appear to depend upon a given a/e molar ratio. On the contrary, there is an influence of the molar ratio, but not as expected. Specifically, a maximum Tg for a/e ratio=1. A decrease of Tg is observed as a/e ratio in the initial mixture is increased. These values are reported in Table 10.

TABLE 10
Tg as function of initial molar ratio.

a/e ratio (initial)

| | 0.7 | 1 | 1.35 | 2 |
|---|---|---|---|---|
| Tg (CROSS- | 159 | 153 | 146 | 132 |
| LINKED | | | | |
| REACTIVE | | | | |
| POLYMER | | | | |
| MICROPARTICLE - | | | | |
| Examples 1, 2, | | | | |
| 10, and 3, | | | | |
| respectively) ° C. | | | | |
| (2^{nd} scan) | | | | |
| Tg (Comparative | 82 | 157 | 137 | 101 |
| Epoxy Example A- | | | | |
| bulk network) ° C. | | | | |

For a/e ratio=1 and 1.35 the difference between a/e ratio in the initial mixture and in the cross-linked reactive polymer microparticles is small. The difference, however, becomes larger for a/e ratio=0.7 and 2. In both cases, the Tg of the cross-linked reactive polymer microparticles is higher than in the bulk samples (Comparative Epoxy Example A). It appears that, even if the cross-linked reactive polymer microparticle synthesis was done using a broad range of a/e ratio (from 0.7 to 2) ratio, the a/e ratio of cross-linked reactive polymer microparticles is in much more narrow range (from 1 to 1.44). The high values of Tg obtained exclude the possibility to have PPG as a miscible polymer in the cross-linked reactive polymer microparticles.

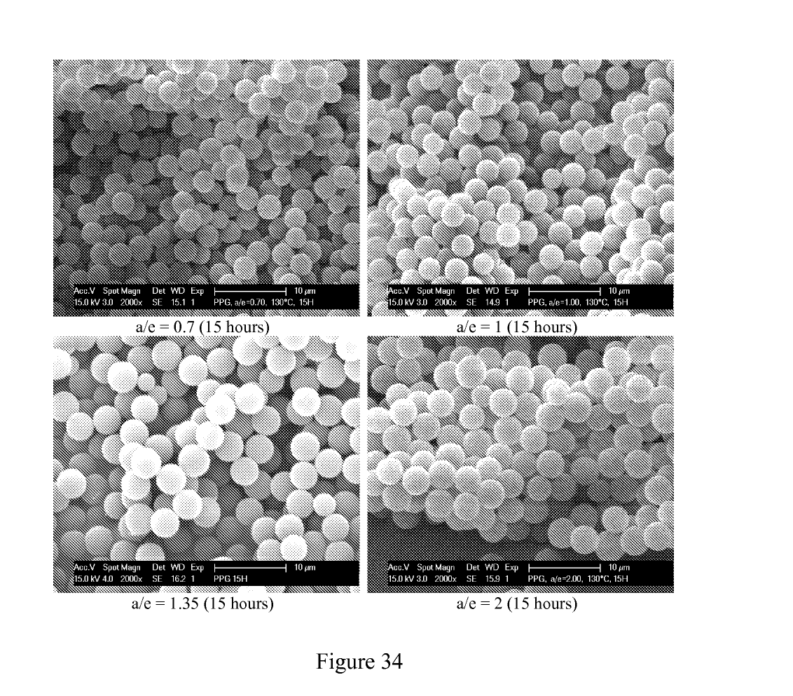

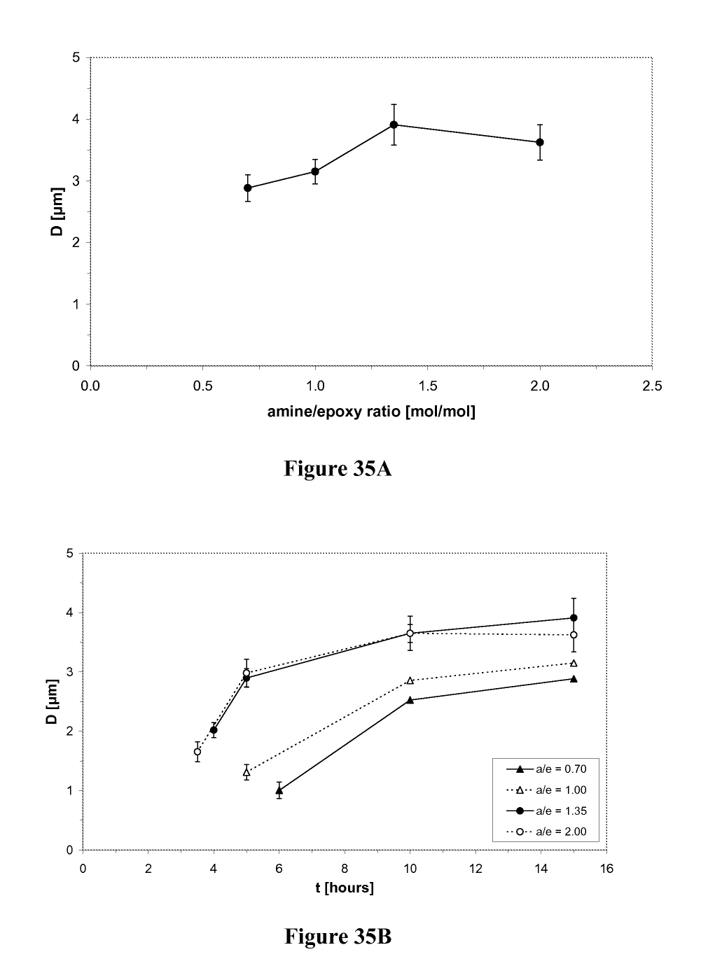

The SEM micrographs shown in FIG. 34 confirm the formation of spherical microparticles, without forming an agglomeration. Micrographs were utilized to calculate the average diameter as function of the reaction time (FIGS. 35a and 35b) for different a/e ratios. The diameter increases with the reaction time and then reaches a constant value after 10 hours of reaction. The molar ratio has a small influence on the size reached by the cross-linked reactive polymer microparticles: the largest particles, 3.6/3.9 μm are obtained with a/e ratio=2 and 1.35, the smallest particles, 2.9/3.2 μm, are obtained with a/e ratio=0.7 and 1.

### Effect of the Reaction Temperature

A parameter that influences the reaction kinetics of the cross-linked reactive polymer microparticles is the reaction temperature. For the cross-linked reactive polymer microparticle preparation via dispersion polymerization, it was varied from 80° C. to 160° C. with the molar ratio in the feed solution a/e ratio=1.35 and the monomer concentration of 10 wt %.

### Synthesis

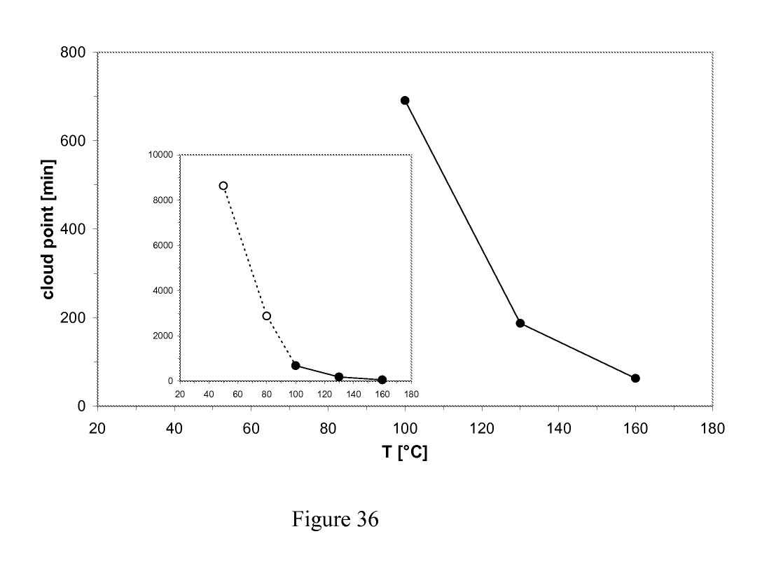

The epoxy-amine reaction is activated by the temperature; as expected with an increase in the temperature, a decrease of the time to phase separate is observed. The conversion at which phase separation takes place occurs more rapidly: cloud point shifts from 1 hour at 100° C. to 11.5 hours at 63° C. At lower temperatures, the cloud point was roughly estimated by optical observation of the solution: it is close to 48 hours at 80° C. and 144 hours at 50° C. (FIG. 36). A solution was left at room temperature during six months: in between 30 and 60 days the solution became opaque, after 90 days, precipitated cross-linked reactive polymer microparticles were observed. A full conversion is reached only when the reaction temperature is high (160 and 130° C.). For the same kinetic reason it is expected to reach a lower yield if the temperature is decreased, for a given time of reaction.

The residual solution was analyzed by SEC for the residual amount of DGEBA and DAT after the reaction was stopped. Indeed when the reaction was performed at 80, 100 or 130° C., residual monomers could be detected, for example, around 10-12 wt % for DGEBA and 2-3 wt % for DAT was left unreacted of the initial feed of the monomers in the case of reaction at 100° C. At higher temperature, less oligomers were found to be present by SEC in the residual solution.

### Cross-Linked Reactive Polymer Microparticle Characterization

At a given temperature, there is no strong effect of the reaction time on Tg (Except at 160° C.: the 1st point taken after 1.5 hours of reaction has a Tg close to 140° C. but a plateau value is reached after 5 hours). The values recorded during the 1^{st} and 2^{nd} scan are reported in Table 11; the values obtained just after the synthesis (1^{st} scan) or after the post-curing cycle in the DSC oven (2^{nd} scan) show a difference which depends on the reaction temperature. It is well known that a vitrification phenomena (where a Tg value is about equal to a cure temperature for a given system) stops the reaction; this reaction will start again as soon as the temperature increases. Nevertheless, high Tg were obtained even at low temperature (e.g., Tg=125° C. for a reaction at T=80° C.). It should be noted that the value of the final Tg depends on the reaction temperature. So the cross-linked reactive polymer microparticles structure is not the same despite the fact that the initial monomer feed is the same. For the comparison, bulk networks, synthesized from the same system (Comparative Epoxy Example A and/or Comparative Epoxy Example B), partially reacted at a low temperature and then post-cure at higher temperature, will show the same final Tg. For solution polymerisation this is not the case.

Two reasons may explain the variation of Tg. First, the effective stoichiometry of the cross-linked reactive polymer microparticles. Reference A (a/e ratio=1.35, T=130° C.) has a real stoichiometry close to 1.2. Based on the hypothesis that cross-linked reactive polymer microparticles are made of only epoxy and amine, the same calculation of effective stoichiometry was done. It is found that the effective stoichiometry increases as the reaction temperature is decreased: from 1 to 1.5 for T=160 and 50° C. respectively. Secondly, PPG is a miscible polymer in the cross-linked reactive polymer microparticles that can produce a decrease in the Tg.

TABLE 11
Values of Tg as a function of the reaction temperature
(a/e ratio = 1.35 in the feed).

| | T ° C. (time hours) | | | | |
|---|---|---|---|---|---|
| | 50 (395 | 80 (100 | 100 (50 | 130 (15 | 160 (15 |
| | hours) | hours) | hours) | hours) | hours) |
| Tg (CROSS- | 61 | 128 | 136 | 146 | 160 |
| LINKED | | | | | |
| REACTIVE | | | | | |
| POLYMER | | | | | |
| MICROPARTICLE | | | | | |
| 1^{st} scan, ° C. | | | | | |
| Tg (CROSS- | 127 | 132 | 140 | 144 | 156 |
| LINKED | | | | | |
| REACTIVE | | | | | |
| POLYMER | | | | | |
| MICROPARTICLE | | | | | |
| 2^{nd} scan, ° C. | | | | | |
| Effective | 1.5 | 1.44 | 1.35 | 1.2 | 1 |
| stoichiometry | | | | | |

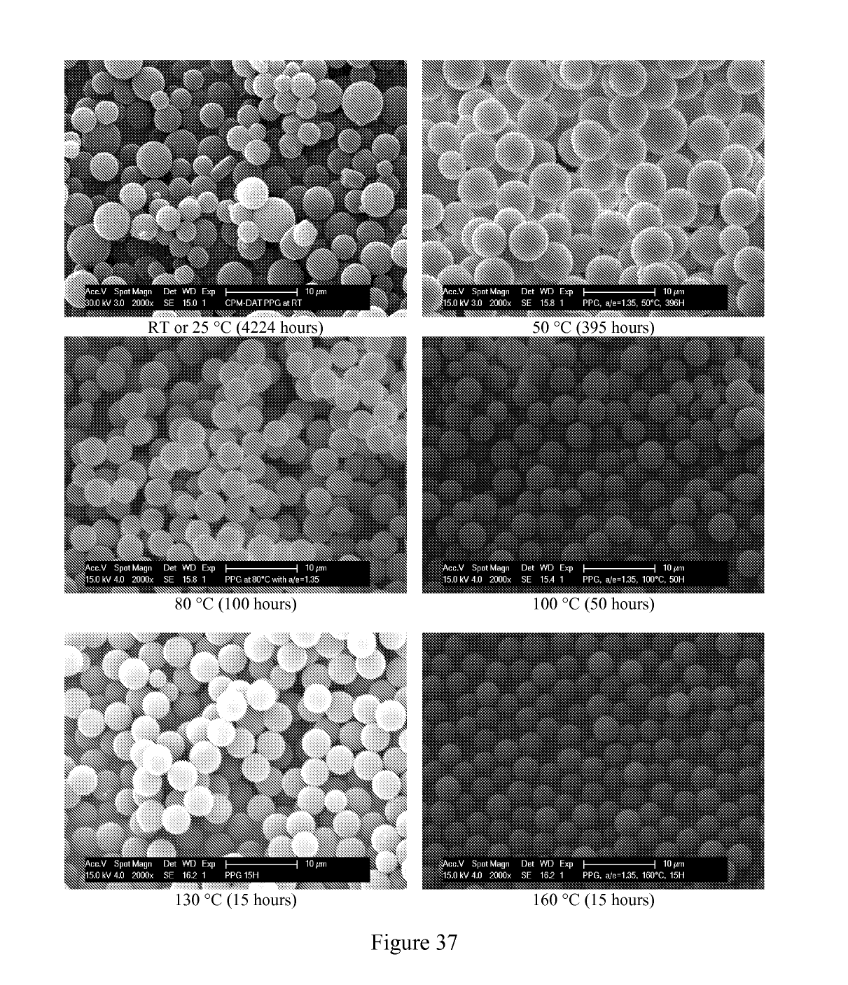

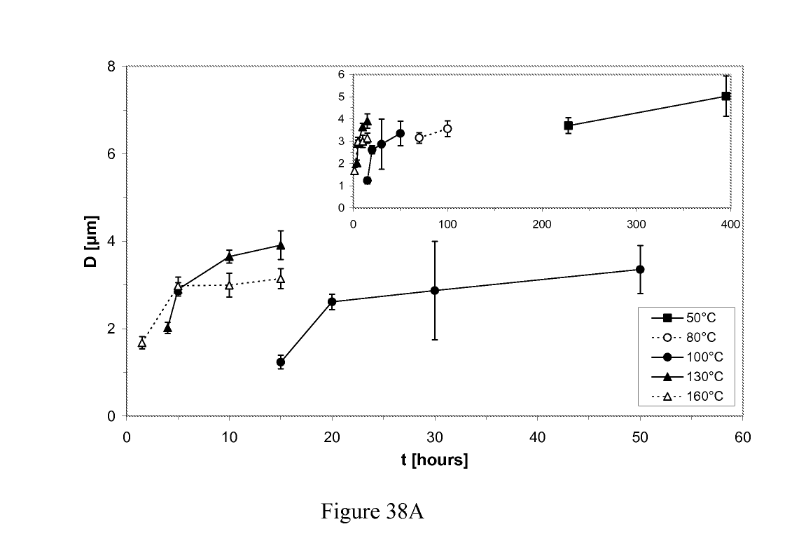

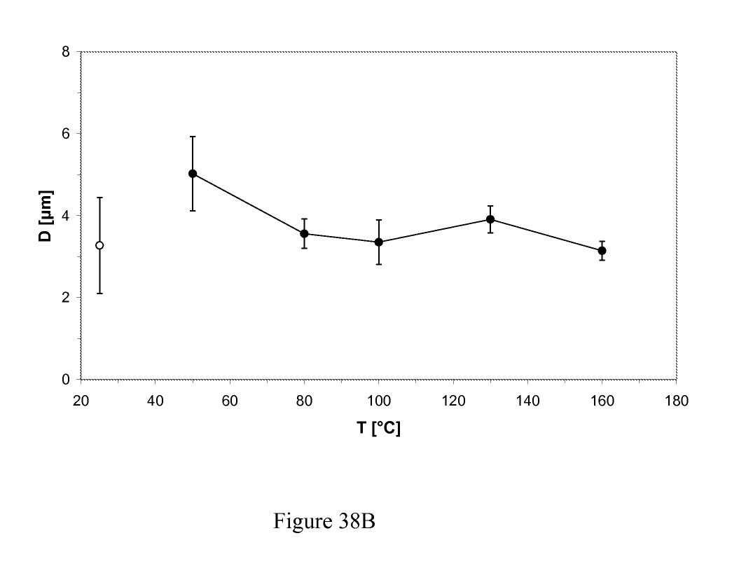

The micrographs depicted in FIG. 37 confirm that spherical microparticles are formed regardless of the temperature, and without apparent agglomeration. The average diameter of these microparticles as a function of reaction time and reaction temperature is depicted in FIGS. 38a and 38b. There is no large change in the average cross-linked reactive polymer microparticle diameter: for the reaction temperature from 80 to 160° C., the diameter is in the range 3.1 to 3.9 μm, only at 50° C. the diameter is slightly higher, around 5 μm.

PPG-Dodecane Mixtures

As solubility parameters of epoxy resins change for different molecular weight and composition, it was necessary to see how the addition of nonsolvents to the dispersion media impacts the dispersion polymerization. Dodecane was chosen for this purpose as it is a nonsolvent for both epoxy and amine and has a relatively high boiling point. The addition of a nonsolvent changes all three components of solubility parameters of the mixture. Two dodecane/PPG mixtures were prepared as dispersion media, containing 10 and 50 wt % of dodecane. The paragraphs below describe the impact of addition of dodecane on the cloud point, yield of the reaction as well as Tg and morphology of the Cross-Linked Reactive Polymer Microparticles.

Synthesis

There is a decrease of the time to phase separation when dodecane is added to

PPG: from 380 minutes in the case of pure PPG-1000 down to 58 minutes in the case of 50 wt.-% of dodecane in the solution. This result was expected because of the change in the solubility parameters that was facilitated by dodecane addition. The kinetics of the amine-epoxy reaction should remain the same, since the temperature, a/e ratio and oligomer concentration remain unchanged.

The solution with 50 wt.-% dodecane leads to higher cross-linked reactive polymer microparticle yield as compared to 10 wt-% dodecane mixture.

TGA has been utilized to analyze cross-linked reactive polymer microparticles synthesized using: PPG/dodecane=90/10, reaction time of 15 hours (Example 10) and PPG/dodecane=50/50 reaction time of 10 hours (Example 12) both at T=130° C. The cross-linked reactive polymer microparticles synthesized in PPG or the PPG/dodecane mixture of 50/50 have the same behavior with a T₅%=338° C. (lower than the bulk network, Reference A), the cross-linked reactive polymer microparticles synthesized using only 10 wt % of dodecane in the solution has a slightly different behavior with a first mass loss of 1.5% at 140° C. and T₅% at 319° C., about 20° C. lower as compared to cross-linked reactive polymer microparticles. This difference probably comes from solvent left after cross-linked reactive polymer microparticles cleaning procedure.

### Cross-Linked Reactive Polymer Microparticle Characterization

The Tg of the cross-linked reactive polymer microparticles sampled after different reaction time is also investigated. For a given system, the Tg increases as the reaction progresses until its values reach a plateau. For DAT based cross-linked reactive polymer microparticles, synthesized at temperature between 100 and 160° C., the “Tg plateau” is reached after 5 hours of reaction. This appears to indicate that the chemical composition and structure of the cross-linked reactive polymer microparticles are not changing after 5 hours of reaction.

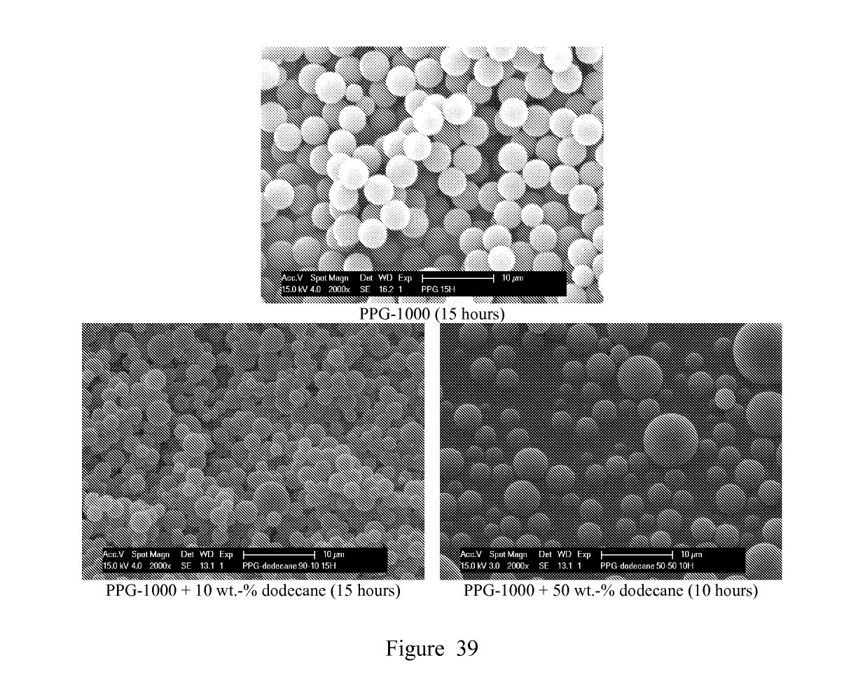

From FIG. 39, it can be seen that spherical particles are formed when the nonsolvent is added to the PPG. The particle size distribution and the average cross-linked reactive polymer microparticle diameter were calculated as a function of the reaction time and are shown in FIGS. 40a and 40b. Some differences appear. First, at short times of reaction, the dimension of the cross-linked reactive polymer microparticle was lower than 1 μm: 0.9±0.4 μm with 10 wt. % of dodecane after 3.5 hours and 0.7±0.3 μm with 50 wt. % of dodecane after 1.7 hours. This could be related to the shorter time to the cloud point in the presence of dodecane. Second, the average dimensions of the cross-linked reactive polymer microparticles in the case of 50 wt. % of dodecane are the same as the ones of the cross-linked reactive polymer microparticles synthesized in only PPG-1000, whatever the reaction time. However as it is seen by comparing the micrographs of FIG. 39, the main effect of the dodecane is the broadening of the size distribution. When the reaction was stopped, the diameters were 3.5±1.5 μm and 3.9±0.3 μm respectively. The addition of the dodecane allowed the formation of cross-linked reactive polymer microparticles with diameter as low as 500 nm. Third, the average diameter of the cross-linked reactive polymer microparticles in the case of 10 wt. % of dodecane is smaller than in the case of only PPG-1000 and PPG/50 wt % dodecane: the cross-linked reactive polymer microparticles average diameter reaches 1.8±0.7 μm.

### Conclusions

Synthesis of the cross-linked reactive polymer microparticles in a mixture of PPG and dodecane can be used to obtain a broader size distribution (especially using 50 wt % dodecane) which can potentially lead to a higher degree of heterogeneity in a cross-linked reactive polymer microparticle-filled epoxy network; in addition, using 10 wt % dodecane leads to a decrease by 2 of the average diameter. Others parameters, such as the yield, the glass transition temperature and the presence of PPG in the particles were not influenced by the addition of the nonsolvent.

### Influence of the Structure of the Diamine

Isophorone diamine (IPDA) is a curing agent used with epoxy resins. Due to its chemical structure (cycloaliphatic) it reacts at lower temperature. By using IPDA to synthesize cross-linked reactive polymer microparticles the reaction temperature could be reduced, which allowed use of solvents with low boiling point in synthesizing the cross-linked reactive polymer microparticles. The influence of stoichiometry, temperature and solvents on the cross-linked reactive polymer microparticles morphology and composition is now discussed.

Characterization of the Reference System

The same protocol was applied for the synthesis of IPDA-based microparticles (Examples 19-25) as for DAT based particles (Examples 1-12), except that the reaction temperature for the Reference B was 80° C. instead of 130° C. (a/e ratio=1.35, c=10 wt %, solvent: PPG-1000). It was observed that (1) phase separation occurs after 4 hours at 80° C. (it was ˜48 hours in the same conditions for DAT); (2) the yield of the reaction was found equal to 76 wt % after 24 hours of reaction (similar synthesis done in PPG-3500 gives a yield of 94%); this value was confirmed on different batches of cross-linked reactive polymer microparticles; (3) the TGA analysis of cross-linked reactive polymer microparticles revealed very similar mass loss versus temperature profile as one obtained on DAT-based cross-linked reactive polymer microparticles: the beginning of degradation is at the same temperature (T_{5%} is equal to 336° C.), however the curve is slightly shifted to lower temperature; (4) the glass transition temperature of cross-linked reactive polymer microparticles, which were sampled after a given reaction time, was difficult to determine with the given method without ambiguity.

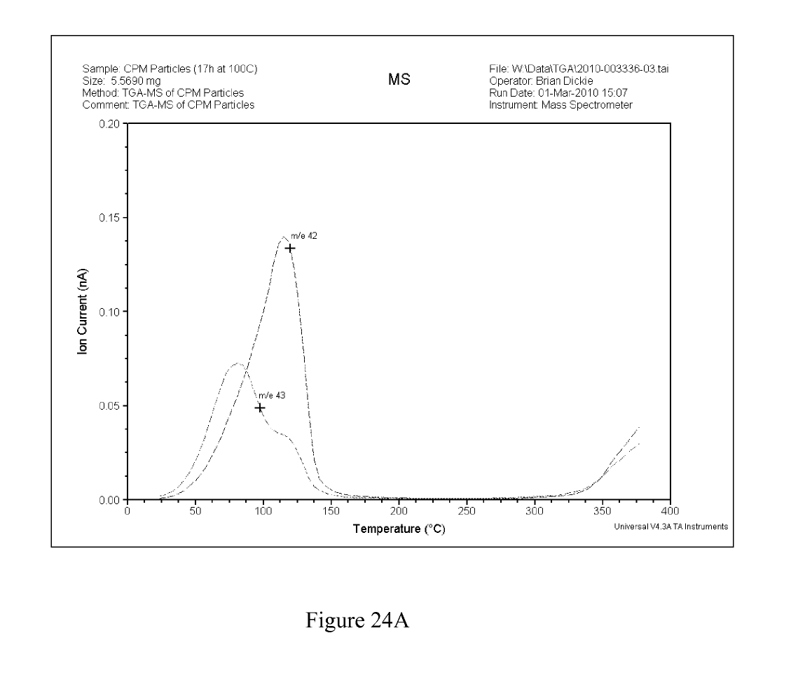

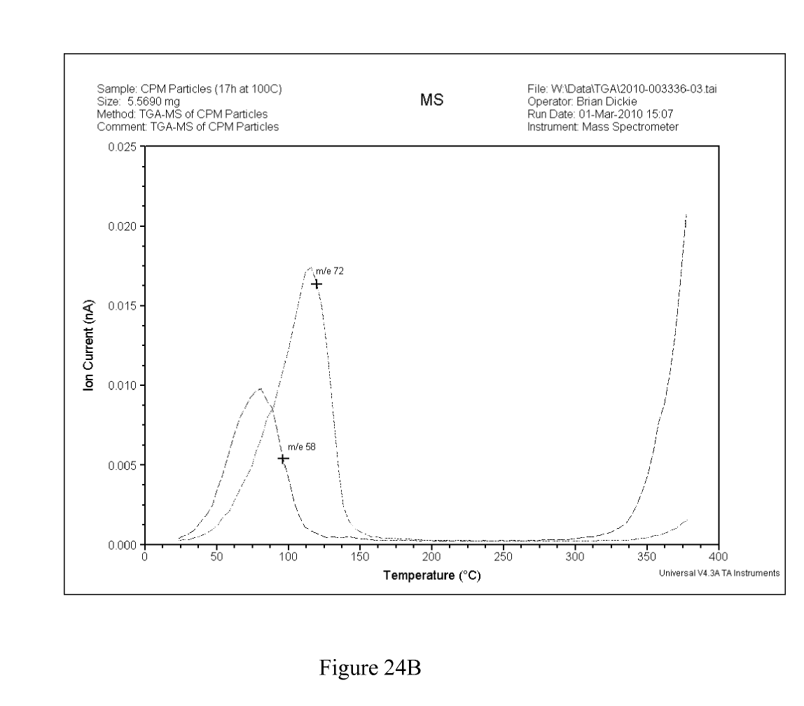

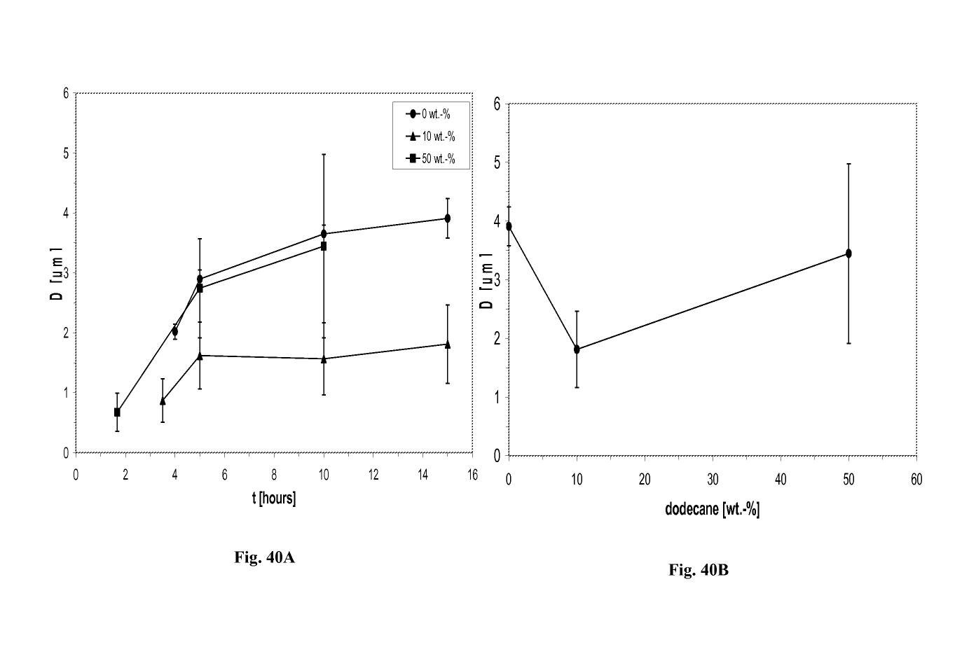

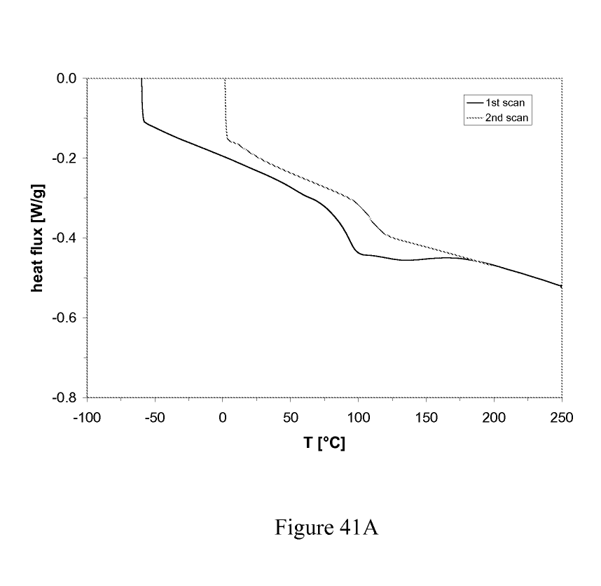

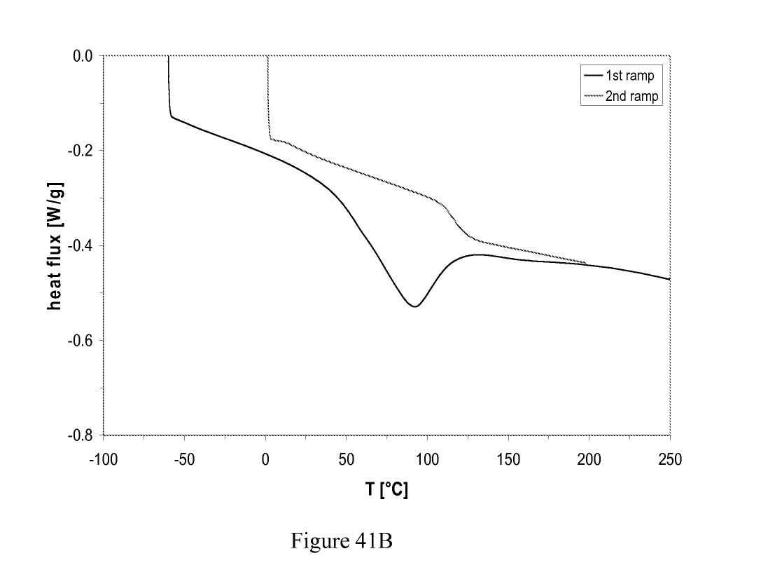

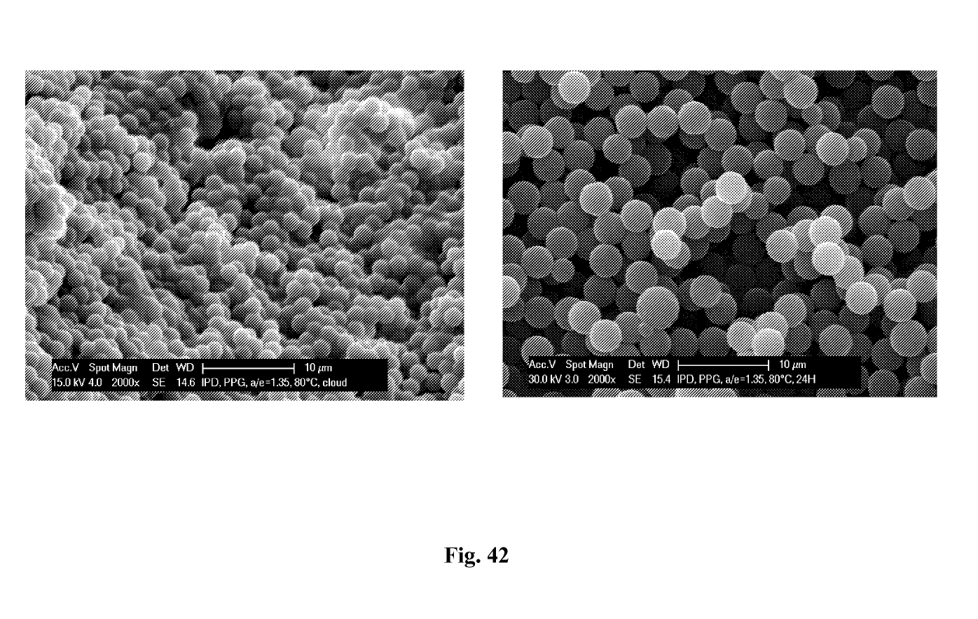

FIGS. 41A and 41B show the thermograms obtained during two successive scans: after 17 hours of reaction (FIG. 41A) and 24 hours of reaction (FIG. 42B). As already mentioned, (thermal properties of cross-linked reactive polymer microparticles) the signal during the 1^{st} scan is very often perturbed by residual solvent evaporation; it is the case in FIG. 41A. Hence the Tg, equal to 53° C., extracted from this graph may be underestimated due to the presence of the endothermic peak of solvent evaporation. For a longer time of reaction the signal is not perturbed by the solvent and a clear Tg equal to 93° C. is observable.

As presented in Table 12, the maximum attainable Tg of this epoxy-amine combination system is as high as 149° C., hence some of epoxy and amine groups remain unreacted in these cross-linked reactive polymer microparticles. This is a different behaviour as compared to DAT-based cross-linked reactive polymer microparticles where maximum Tg value can be reached when the reaction was stopped (15 hours at T=130° C.). However the reaction temperature as well as the reaction time was, in the case of DAT-based Cross-Linked Reactive Polymer Microparticles, more favourable to lead to higher Tg. For a bulk network with amine/epoxy ratio of 1.35, the Tg temperature is equal to 125° C., however even after the second scan, as shown in FIGS. 41a and 41b, these values for IPDA-based cross-linked reactive polymer microparticles is not reached.

This confirms that the effective stoichiometry of cross-linked reactive polymer microparticles is substantially different from the one in the initial monomer solution. Considering the Tg obtained during the 2^{nd} scan, after the post-cure in the DSC, and that no residual solvent (PPG) is present in the cross-linked reactive polymer microparticles, an effective stoichiometry can be estimated from the variation of Tg as a function of a/e ratio. Two values are possible: 0.8/0.85 (excess of epoxy) or 1.5/1.6 (excess of amine). The second value is believed to be more realistic as there was an excess of IPDA at the start of the reaction.

TABLE 12
Values of Tg as a function of reaction time at 80° C.

time (hours) at
T = 80° C.

| | 17 | 24 |
|---|---|---|
| Tg (CROSS-LINKED | 53 | 93 |
| REACTIVE | | |
| POLYMER | | |
| MICROPARTICLE of | | |
| Example 19) 1^{st} scan, | | |
| ° C. | | |
| Tg (CROSS-LINKED | 116 | 108 |
| REACTIVE | | |
| POLYMER | | |
| MICROPARTICLE of | | |
| Example 19) 2^{nd} scan, | | |
| ° C. | | |

| | |
|---|---|
| Effective stoichiometry | 0.8/0.85 or |
| | 1.5/1.6 |

SEM micrographs show that IPDA based cross-linked reactive polymer microparticles are spherical particles, often agglomerated (especially when samples after short reaction time (4.5 hours) and where the Tg of cross-linked reactive polymer microparticles is low). It is considered that the cross-linked reactive polymer microparticles might have residual amino or epoxy groups, especially at short reaction time, which can react during the drying step and leading to agglomeration. The reaction time has an influence on the particle diameter: it increases from 2 μm to 3.5 μm, but distribution remains narrow. The diameter at the end of the reaction is in the same rage as the one found on the reference DAT-based cross-linked reactive polymer microparticles.

Influence of the Molar Ratio

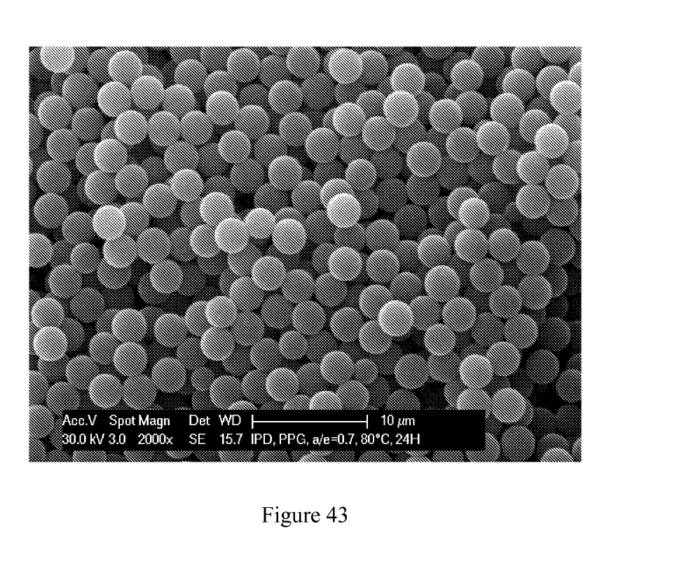

The influence of molar ratios was studied by examining the morphology and Tg for the cross-linked reactive polymer microparticles of Examples 26, 19 and 24 (amine to epoxy molar ratios: 0.7, 1 and 1.35, respectively). The Tgs are reported in Table 13. After a 17 hour reaction time, the first scan reviled the Tg of cross-linked reactive polymer microparticles (1^{st} scan signal was also perturbed by solvent evaporation) as low as 49 to 57° C. However, after post-curing the Tgs increased, especially when the initial We ratio was low. As in the case of DAT-based cross-linked reactive polymer microparticles, the maximum Tg was obtained for a/e ratio=0.7; the SEM micrographs show spherical, non agglomerated microparticles. An example of high Tg cross-linked reactive polymer microparticles (a/e ratio=0.7) image is given in FIG. 43. The diameter increases only slightly with the initial value of a/e ratio: from 2.7 μm, to 3 and 3.2 for 0.7, 1 and 1.35 respectively.

TABLE 13
Tg as a function of the initial stoichiometry.

| | a/e ratio | | |
|---|---|---|---|
| | 0.7 | 1 | 1.35 |
| Tg (CROSS-LINKED | 57 | 49 | 52 |
| REACTIVE | | | |
| POLYMER | | | |
| MICROPARTICLE - | | | |
| Examples 26, 19 and | | | |
| 24) 1^{st} scan, ° C. | | | |
| Tg (CROSS-LINKED | 141 | 131 | 116 |
| REACTIVE | | | |
| POLYMER | | | |
| MICROPARTICLE - | | | |
| Examples 26, 19 and | | | |
| 24) 2^{nd} scan, ° C. | | | |
| Tg (Comparative | 75 | 149 | 125 |
| Epoxy Example A) | | | |
| ° C. | | | |
| Effective | ~0.95 | 0.92 or 1.3 | ~0.85 or 1.5 |
| stoichiometry | | | |

### Influence of the Synthesis Temperature (80,100 and 130° C.) and Addition of a Non-Solvent (10 wt % Dodecane to the Dispersion Media)

Through this set of experiments the feed a/e molar ratio were kept at a/e ratio=1.35 and monomer concentration at 10 wt %. Synthetic procedures where different solvents (1-octanol, cyclohexanone and cyclohexane) were utilized as a dispersion media: in some cases cross-linked reactive polymer microparticles were obtained, however with the low yield and agglomeration of cross-linked reactive polymer microparticles.

The effect of addition of a non-solvent and of temperature on cross-linked reactive polymer microparticle morphology and composition is as follow: (1) Table 14 shows a dependence of the yield on temperature. At short reaction times (4.5 hours) some correlation exists. However, at long reaction time (17 hours), the yield is above 90% regardless of temperature (2) the Tg of cross-linked reactive polymer microparticles does not vary with the reaction temperature after 17 hours of reaction time and is close to 50° C. although higher Tg were expected with a higher reaction temperature. 50° C. is definitively too low for long reaction times at 130° C. taking into account the high reactivity of IPDA.

TABLE 14
Yield and Tg of CROSS-LINKED REACTIVE POLYMER
MICROPARTICLE synthesized at different temperature,
in PPG + 10% dodecane.

| | T (° C.) | | |
|---|---|---|---|
| | 80 | 100 | 130 |
| Tg (CROSS-LINKED | 51 | 52 | 53 |
| REACTIVE POLYMER | | | |
| MICROPARTICLE - Examples | | | |
| 20, 21, 22) 1^{st} scan, ° C. | | | |
| (after 17 hours) | | | |
| Tg (CROSS-LINKED | 102 | 108 | 125 |
| REACTIVE POLYMER | | | |
| MICROPARTICLE- Examples | | | |
| 20, 21, 22) 2^{nd} scan, ° C. | | | |
| Tg (Comparative Epoxy | 125 | 125 | 125 |
| Example A) ° C. | | | |

| | | |
|---|---|---|
| Effective stoichiometry | ~0.85 or 1.5 | 1.35 |

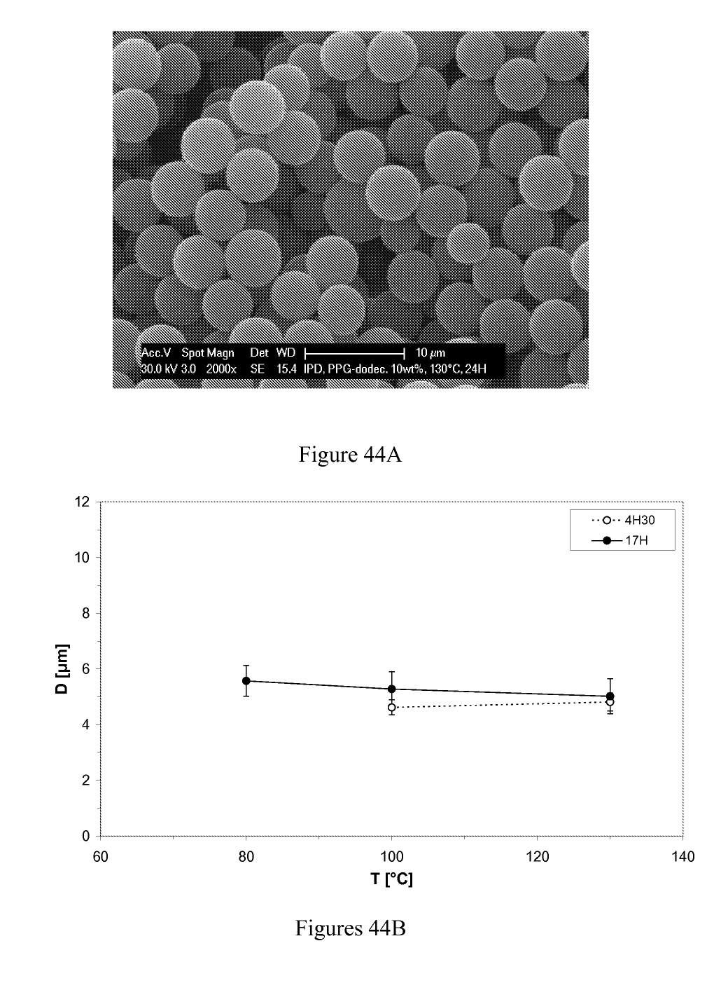

The SEM images reveal spherical microparticles as shown in FIG. 44a. The average diameter as a function of reaction time and temperature is presented in the same FIG. 44b. It is evident that these two parameters have no significant influence on the size of the cross-linked reactive polymer microparticles.

### Conclusions

The synthesis of cross-linked reactive polymer microparticles based on DGEBA and IPDA can be performed, at a lower temperature than with DAT using either in PPG or in a mixture of PPG+10 wt dodecane as a dispersion media. Spherical microparticles were obtained in both solvents and have narrow size distribution. As for DAT-based cross-linked reactive polymer microparticles, the effective stoichiometry of the cross-linked reactive polymer microparticles is different from the one in the feed based on the DSC analysis. The diameters are in the range of 3 μm for the synthesis in PPG, and around 5 μm for the synthesis in the mixture of PPG and dodecane. After post-curing, the Tg of the cross-linked reactive polymer microparticles is between 102° C. and 141° C. depending on the conditions of the synthesis.

### Preparation of the Thermoset Cross-Linked Network

The impact of the cross-linked reactive polymer microparticles addition on final film/network properties of thermoset cross-linked network are provided herein. A number of cross-linked reactive polymer microparticles filled thermoset cross-linked network were synthesized with formulations based on DER and IPDA. The cross-linked reactive polymer microparticles utilized were either IPDA or DAT-based. The influence of several formulation parameters was investigated: Formulation (curable epoxy system) a/e ratio: 0.7, 1 and 1.35; Type of cross-linked reactive polymer microparticles: cross-linked reactive polymer microparticles synthesized via various synthetic parameters (a/e ratio, temperature, time) hence having different Tg and diameter; and cross-linked reactive polymer microparticles loading <1, 3, 5, 10, 20, 40 weight percent (wt %) based on the thermoset cross-linked network.

The addition of cross-linked reactive polymer microparticles reflected on the cure behavior of the thermoset cross-linked network by slowing the cure kinetic. At the same time as the cross-linked reactive polymer microparticles were partially or fully cured they acted as heat sinks decreasing the cure exotherm of the thermoset cross-linked network. The initial viscosity did increase upon the addition of these particles, but not substantially, therefore at the very beginning of the cure, the viscosity of the thermoset cross-linked network loaded with the cross-linked reactive polymer microparticles was lower than that of the neat formulation.

Regarding the mechanical properties of the cross-linked reactive polymer microparticles loaded thermoset cross-linked networks, depending on the combination of the cross-linked reactive polymer microparticles and curable epoxy system, several scenarios could be distinguished: First, thermoset cross-linked networks having a single a transition as analyzed by DMA. They were obtained when the Tg's of the curable epoxy system and the cross-linked reactive polymer microparticles were close and the composition the same. The electron microscopy suggests good particle embedding, shown by clear fracture surface (the fracture was propagating through the cross-linked reactive polymer microparticles) hence indicating one homogeneous network for the thermoset cross-linked network.

Those having two transitions: such thermoset cross-linked networks were obtained when the Tg's of the curable epoxy system and the cross-linked reactive polymer microparticles were different. The compatibility between the formulation (here presented by having a/e ratio of curable epoxy system close to 0.7 while the cross-linked reactive polymer microparticles are amine functionalized) is as follows. The electron microscopy shows that the cross-linked reactive polymer microparticles have no strong adhesion to the curable epoxy system and that the fracture propagates in the curable epoxy system and at the particle-curable epoxy system interface. The glass transition is very broad. It is remarkable to obtain such heterogeneous networks with similar chemical composition for the dispersed phase and the curable epoxy system.

Networks having more than one a transition, while retaining fully embedded cross-linked reactive polymer microparticles, have clear fracture surfaces as depicted by SEM imaging. The Tg transition was expanded by the second peak in the high temperature range (as compared to the neat curable epoxy system). In the case of the high cross-linked reactive polymer microparticles loading level (above 20 wt %), Tg transition expands to lower temperature range as well, probably due to low curing levels. It is remarkable to obtain such heterogeneous network from the same resin/hardener while having no interface between the cross-linked reactive polymer microparticles and the curable epoxy system of the thermoset cross-linked network.

It is interesting to note that even low amounts of the cross-linked reactive polymer microparticles have an effect on the dynamic mechanical behavior of the thermoset cross-linked network. For example, the magnitude of the transition due to the cross-linked reactive polymer microparticles is not proportional to weight percent (wt %) of the cross-linked reactive polymer microparticles added.

The main objective was to prove that by producing the thermoset cross-linked networks different material properties can be achieved compared to neat curable epoxy systems. In particular the Tg transition has expanded for the given cure regime by the addition of the cross-linked reactive polymer microparticles, provided that these particles are fully embedded in the thermoset cross-linked network.

The composition of the curable epoxy system was similar to those of the cross-linked reactive polymer microparticles in forming the thermoset cross-linked network. The molar ratio a/e ratio for the curable epoxy system was 0.7, 1 or 1.35. Most of the curable epoxy systems were prepared using cross-linked reactive polymer microparticles synthesized from IPDA in different conditions, and only few samples were prepared using cross-linked reactive polymer microparticles based on DAT (diaminotoluene). Note that that the main difference between these two types of cross-linked reactive polymer microparticles is their epoxy conversion level and hence the Tg.

IPDA based Cross-Linked Reactive Polymer Microparticles

Prior to dispersion, the cross-linked reactive polymer microparticles were stored in suspension in acetone at −25° C. after having been washed and centrifuged, as discussed above. Different protocols for the preparation of thermoset cross-linked network were tested, with the following protocol being considered the most suitable:

Dissolve the epoxy resin (D.E.R. 331™ in tetrahydrofuran (THF) at a concentration of 50 wt %. Add the cross-linked reactive polymer microparticles to the epoxy resin solution and sonicate with an ultrasound probe for 15 min. Remove the THF under vacuum (15 hours at room temperature, 23° C.). Add and mix by hand the amine curing agent, IPDA, to the cross-linked reactive polymer microparticles and epoxy resin mixture. Degas the mixture under vacuum at room temperature (23° C.) for about 30 minutes. The thermoset cross-linked network is then cast on a PTFE adhesive film. The dry film thickness of the thermoset cross-linked network was close to 100 μm. The film of the thermoset cross-linked network was crosslinked in an oven 2 hours at 80° C. followed by a postcure step (2 hours at 160° C.).

The list of films prepared is reported in Table 15, together with the description of the cross-linked reactive polymer microparticles (Tg and diameter of the microparticles).

### Thermoset Cross-Linked Network—Film Preparation

Prior to formulation, particles were dispersed (in a given wt loading level) in THF using the ultrasound probe (15 minute). The epoxy resin (DER 331) was dissolved in the THF (50 wt. %/50 wt. %). After mixing the dispersion with the solution the THF was removed under vacuum (room temperature, 4 hours). The amine curing agent (IPDA) was added to the dispersion of particles in the epoxy resin, where the epoxy resin and the amine curing agent had an a/e ratio as provided in Tables 15 and 16. The cure kinetics/rheokientics were measured immediately, while free standing films were made by curing the film on a PTFE adhesive film. Dry film thickness was about 100 μm. Films were cured in the vacuum oven at 80° C. followed by a postcure step (2 hours at 160° C.).

### Films of Thermoset Cross-Linked Network

Examples 27-36 of the films are provided below in Tables 15 and 16.

TABLE 15
Formulation of the Thermoset Cross-Linked Network having IPDA-based cross-
linked reactive polymer microparticles

| | | | | Weight | |
|---|---|---|---|---|---|
| | | | | Percentage | |
| | | | | (wt. %) of | |
| | | | | Cross-Linked | |
| | | | | Reactive | |
| | | | Amine to | Polymer | |
| | | | Epoxy Molar | Microparticles | |
| Example | | Amine to | ratio (a/e | in Curable | Tg (Cross- |
| of | | Epoxy Molar | ratio) of | Epoxy System | Linked |
| Thermoset | Cross-Linked | ratio (a/e | Cross-Linked | for the | Reactive |
| Cross- | Reactive | ratio) of | Reactive | Thermoset | Polymer |
| Linked | Polymer | Curable | Polymer | Cross-linked | Microparticles) |
| Network | Microparticles | Epoxy System | Microparticles | Network | ° C./Φ μm |
| 32 | Example 19 | 0.7 | 1 | 1 wt % of | 49/3.1 |
| | | | | Example 19 | |
| | | | | and 99 wt % of | |
| | | | | the curable | |
| | | | | epoxy system | |
| | | | | of Reference B | |
| 33 | | | | 3 wt % of | |
| | | | | Example 19 | |
| | | | | and 97 wt % of | |
| | | | | the curable | |
| | | | | epoxy system | |
| | | | | of Reference B | |
| 34 | | | | 5 wt % of | |
| | | | | Example 19 | |
| | | | | and 95 wt % of | |
| | | | | the curable | |
| | | | | epoxy system | |
| | | | | of Reference B | |
| 35 | | | | 10 wt % of | |
| | | | | Example 19 | |
| | | | | and 90 wt % of | |
| | | | | the curable | |
| | | | | epoxy system | |
| | | | | of Reference B | |
| 36 | | | | 20 wt % of | |
| | | | | Example 19 | |
| | | | | and 80 wt % of | |
| | | | | the curable | |
| | | | | epoxy system | |
| | | | | of Reference B | |
| 37 | | | | 40 wt % of | |
| | | | | Example 19 | |
| | | | | and 60 wt % of | |
| | | | | the curable | |
| | | | | epoxy system | |
| | | | | of Reference B | |
| 38 | Example 24 | | 1.35 | 10 wt % of | 53/3.3 |
| | | | | Example 24 | |
| | | | | and 90 wt % of | |
| | | | | Reference B | |
| 39 | Example 19 | 1 | 1 | 10 wt % of | 49/3.1 |
| | | | | Example 19 | |
| | | | | and 90 wt % of | |
| | | | | Reference B | |
| 40 | Example 24 | | 1.35 | 10 wt % of | 53/3.3 |
| | | | | Reference 24 | |
| | | | | and 90 wt % of | |
| | | | | Reference B | |
| 41 | Example 19 | 1.35 | 1 | 1 wt % of | 49/3.1 |
| | | | | Example 19 | |
| | | | | and 99 wt % of | |
| | | | | Reference B | |
| 42 | | | | 3 wt % of | |
| | | | | Example 19 | |
| | | | | and 97 wt % of | |
| | | | | Reference B | |
| 43 | | | | 5 wt % of | |
| | | | | Example 19 | |
| | | | | and 95 wt % of | |
| | | | | Reference B | |
| 44 | | | | 10 wt % of | |
| | | | | Example 19 | |
| | | | | and 90 wt % of | |
| | | | | Reference B | |
| 45 | | | | 20 wt % of | |
| | | | | Example 19 | |
| | | | | and 80 wt % of | |
| | | | | Reference B | |
| 46 | | | | 34 wt % of | |
| | | | | Example 19 | |
| | | | | and 66 wt % of | |
| | | | | Reference B | |
| 47 | | | | 40 wt % of | |
| | | | | Example 19 | |
| | | | | and 60 wt % of | |
| | | | | Reference B | |
| 48 | Example 26 | 1 | 1.35 | 10 wt % of | 51/5.6 |
| | | | | Example 26 | |
| | | | | and 90 wt % of | |
| | | | | Reference B | |
| 49 | | | | 10 wt % of | Nd/4.6 |
| | | | | Example 26 | |
| | | | | and 90 wt % of | |
| | | | | Reference B | |
| 50 | | | | 10 wt % of | 52/5.3 |
| | | | | Example 26 | |
| | | | | and 90 wt % of | |
| | | | | Reference B | |
| 51 | | | | 10 wt % of | Nd/4.8 |
| | | | | Example 26 | |
| | | | | and 90 wt % of | |
| | | | | Reference B | |
| 52 | | | | 10 wt % of | 53/5.0 |
| | | | | Example 26 | |
| | | | | and 90 wt % of | |
| | | | | Reference B | |

TABLE 16
Formulation of the Thermoset Cross-Linked Network having DAT-based cross-
linked reactive polymer microparticles

| | | | | Weight | |
|---|---|---|---|---|---|
| | | | | Percentage | |
| | | | | (wt. %) of | |
| | | | | Cross-Linked | |
| | | | | Reactive | |
| | | | Amine to | Polymer | |
| | | | Epoxy Molar | Microparticles | |
| Example | | Amine to | ratio (a/e | in Curable | Tg (Cross- |
| of | | Epoxy Molar | ratio) of | Epoxy System | Linked |
| Thermoset | Cross-Linked | ratio (a/e | Cross-Linked | for the | Reactive |
| Cross- | Reactive | ratio) of | Reactive | Thermoset | Polymer |
| Linked | Polymer | Curable | Polymer | Cross-linked | Microparticles) |
| Network | Microparticles | Epoxy System | Microparticles | Network | ° C./Φ μm |
| 53 | Example 18 | 1 | 1.35 | 10 wt % of | 153/2.9 |
| | | | | Example 18 | |
| | | | | and 90 wt % of | |
| | | | | Reference A | |
| 54 | Example 2 | | 1 | 10 wt % of | 153/3.9 |
| | | | | Example 2 and | |
| | | | | 90 wt % of | |
| | | | | Reference A | |

### Results and Discussion

### Chemorheology

The gelation phenomenon in thermoset cross-linked networks can be observed by different experimental methods. Chemorheological measurements where used in the dynamic mode: the variation of viscosity with time and the variation of tan δ as a function of reaction time recorded at different frequencies and at isothermal conditions. The objective was to determine if the presence of cross-linked reactive polymer microparticles has an influence on gelation of the thermoset cross-linked network. The variation of viscosity (η) during an isothermal curing at 80° C., is plotted in FIG. 45 for three neat formulations of the curable epoxy system differing by the a/e ratio. At a given reaction time an increase of the viscosity was observed which corresponds to gelation (represented by divergence of Mw and η). The gelation time is dependent on a/e ratio: it increases with a decrease of a/e ratio (excess of epoxy). In order to make more precise observations regarding the gel-time, multi-frequencies experiments were performed. Gel-time was marked by the crossover of the tan δ curves for a set of different frequencies.

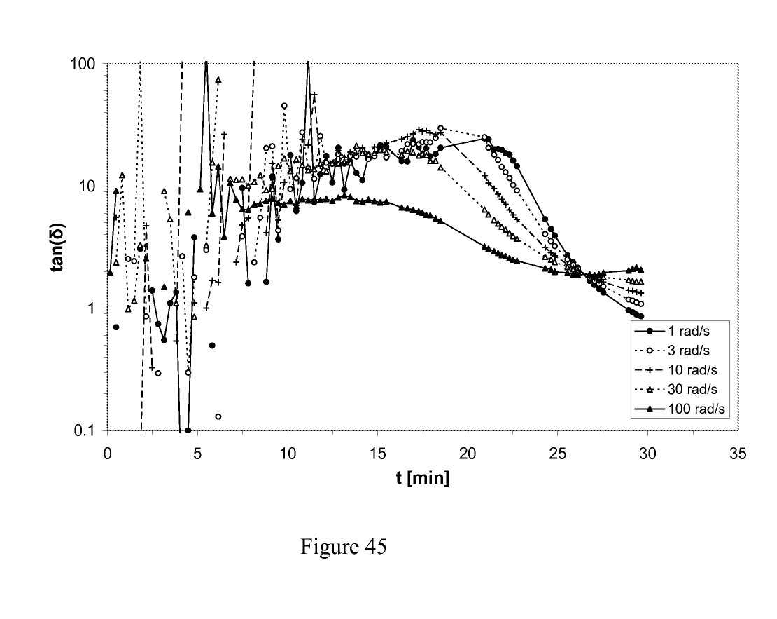

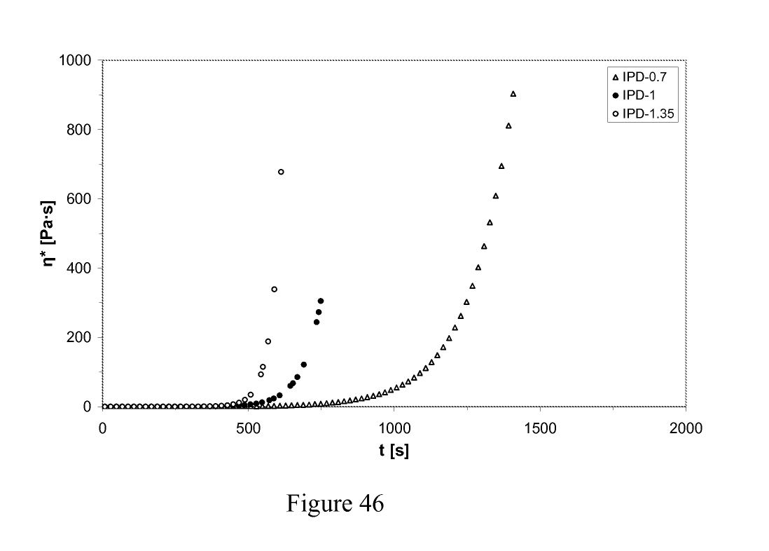

An example of the curve obtained is shown in FIG. 46 for a neat formulation of the curable epoxy system where amine to epoxy ratio a/e ratio=0.7. Gelation is clearly observed after 26 min of the reaction at 80° C. Similar experiments for formulations with a/e ratio=1 and a/e ratio=1.35 give 18 min for 12 min gel-time, respectively.

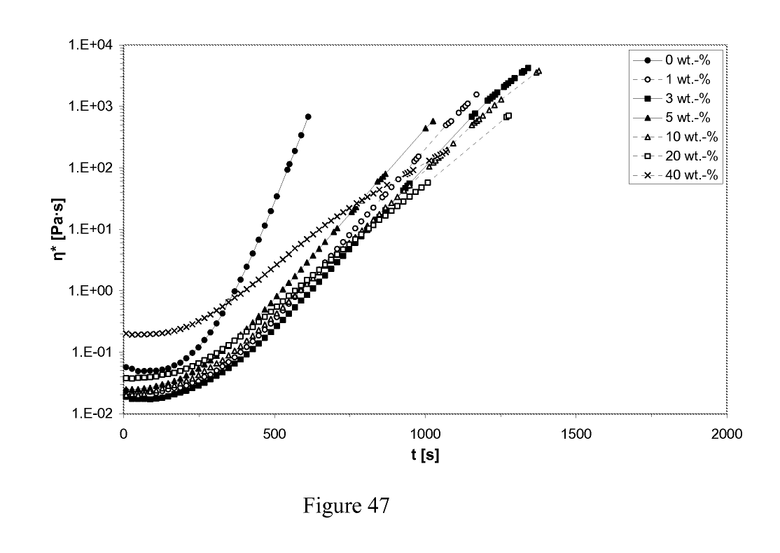

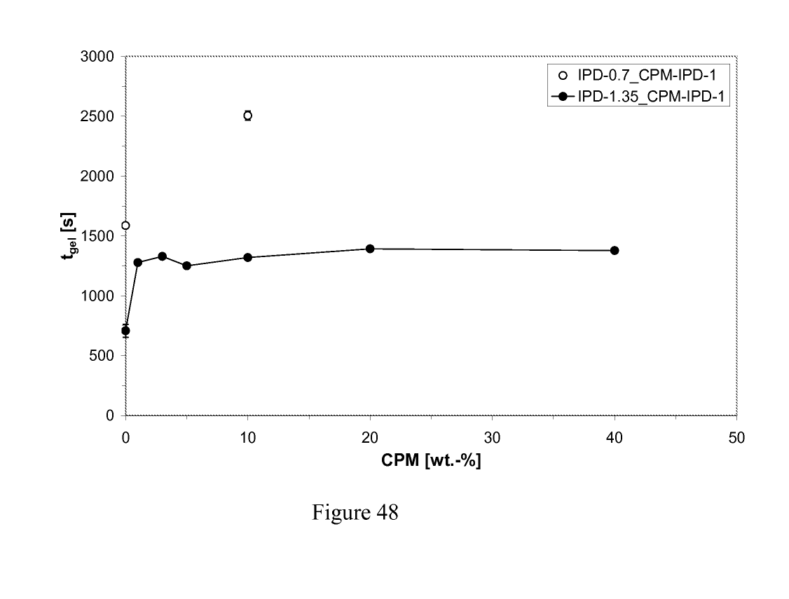

Different loadings of the cross-linked reactive polymer microparticles, ranging from 1 wt % to 40 wt %, were added in the curable epoxy system (DGEBA-IPDA formulation with an a/e ratio=1.35). The evolution of complex viscosity is plotted FIG. 47 and the gel times obtained from multi-frequency experiments are plotted in FIG. 48. From these curves two conclusions can be drawn: firstly the gelation time is delayed when cross-linked reactive polymer microparticles are added to the curable epoxy system, and secondly the initial viscosity of the thermoset cross-linked network is lower as compared to (except for the highest amount of cross-linked reactive polymer microparticles, 40 wt %) the neat system. A priori, these results were not expected. Nevertheless the increase of the time to gelation in the presence of the cross-linked reactive polymer microparticles is confirmed by the experiment realized using a different stoichiometry for the curable epoxy system (a/e ratio=0.7) and 10 wt % of the cross-linked reactive polymer microparticles, it is even more pronounced.

A decrease in the initial viscosity can be explained by the presence of the residual solvent (THF), although all thermoset cross-linked network were excessively vacuum distilled prior to cure. An increase in the gel time can be due to a decrease of the stoichiometry of the curable epoxy system or to a lower reactivity of the curable epoxy system by dilution effect. Comparing findings of the thermoset cross-linked networks, it can be concluded that the addition of cross-linked reactive polymer microparticles from 1 wt % to 10 wt % has no effect on the initial viscosity, and that for higher amounts, 20 wt % and 40 wt %, an increase in the initial viscosity is observed. The gel times obtained from multi-frequency experiments appear to be independent of the cross-linked reactive polymer microparticles loading level.

### Kinetics of Reaction by Infra-Red Spectroscopy

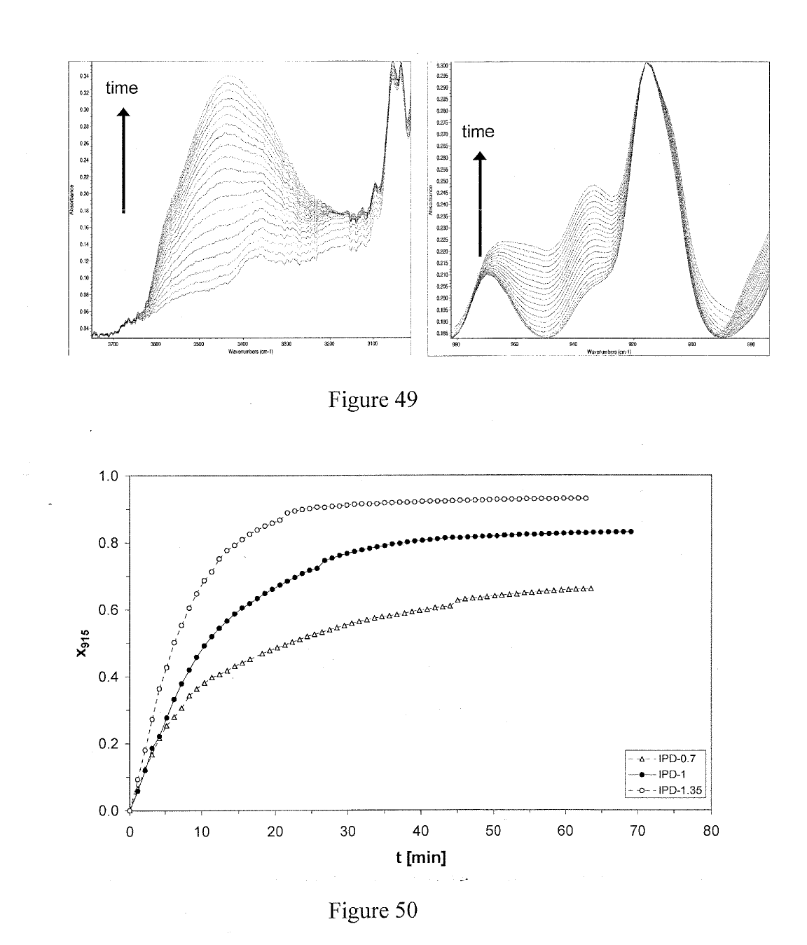

Infra-red spectroscopy was used to determine the kinetics of the curing reaction of the thermoset cross-linked networks. Curing was carried out in the isothermal mode for all samples (at T=80° C.). Neat curable epoxy systems having three different We ratios, and thermoset cross-linked networks (curable epoxy systems with the cross-linked reactive polymer microparticles of Example 35 and Examples 41-47) were investigated. FIG. 49 shows the evolution of the IR spectra as a function of the reaction time. Peaks of interest are at 915 cm⁻¹ (related to the epoxy group) and at 3450 cm⁻¹ (related to hydroxyl group): the first one decreases as a function of the reaction time while the second one increases. The conversion of epoxy groups was calculated as a disappearance of the epoxy-attributed peak, which was normalized by peak at 830 cm⁻¹ (originating from ═CH— p-phenylene groups) and is reported in FIG. 50. From the aforementioned figures, the conversion of epoxy groups is faster when the amino curing agent is in excess (a/e ratio=1.35) and the maximum conversion reached is higher (90%). In excess of epoxy (a/e ratio=0.7) the maximum observable conversion within the experimental time range is close to 65%. These results are in agreement with previous observation on viscosity measurements.

Using the values of gel times reported above, the conversion at gel-point can be estimated and compared to the theoretical one. The values are reported in the Table 17. Experimental values are very close to the theoretical ones. The small differences can be due to the fact that two different instruments were used, having each a different set-up for the sample and equilibration of temperature (refer to Rheometer and IR spectrometer). In the theoretical calculation an equi-reactivity of all amino and epoxy groups was assumed. This is an accurate assumption for conversion of epoxy groups, but for the IPDA there is a difference of reactivity of the two amino groups thus leading to a small increase of the theoretical conversion at gel point (from 0.58 to 0.62 for a molar A4+B2 mixture). The agreement between experimental and theoretical values of the conversion at gel point is the proof that the rheological and kinetics measurements on neat epoxy systems are reliable.

TABLE 17
Conversion at Gelation for Neat Matrices.

| | a/e ratio | | |
|---|---|---|---|
| | 0.7 | 1 | 1.35 |
| t_{gel} (min) from rheology | 26 | 18 | 12 |
| Conversion at gel point | 53 | 63 | 73 |
| from IR curves (%) | | | |
| Theoretical conversion (%) | 48 | 58 | 69 |
| for (A4 + B2) system¹ | | | |

¹A4: amine curing agent, functionality = 4, B2: epoxy prepolymer, functionality = 2

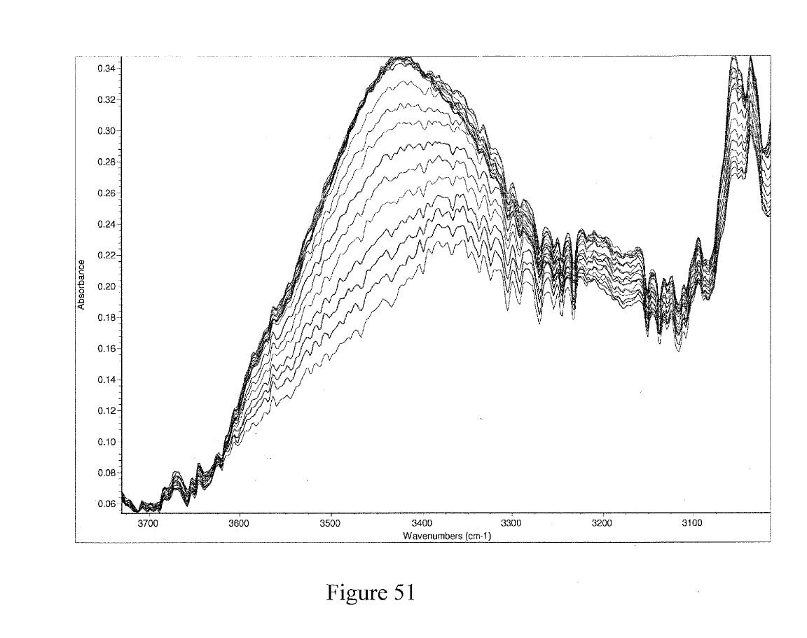

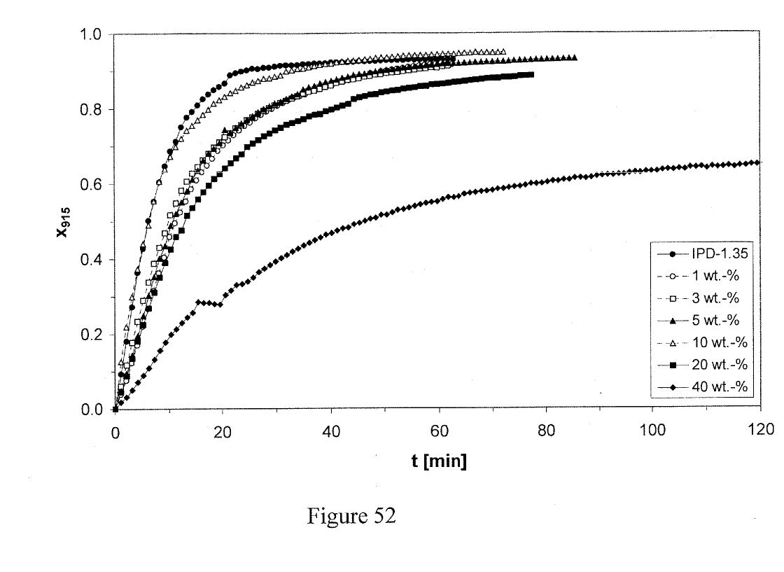

The influence of the addition of the cross-linked reactive polymer microparticles on the cure kinetics of the thermoset cross-linked network is shown in FIGS. 51 and 52. When the loading level is sufficiently high, there is a modification of the initial shape of the hydroxyl peak because the cross-linked reactive polymer microparticles bear hydroxyl groups. The difference between the curves in FIG. 51 (top and bottom) is that the basic data extracted from the IR spectra (top) have been corrected by the initial epoxy conversion of the cross-linked reactive polymer microparticles (bottom). To calculate this initial conversion the value of the glass transition temperature of the cross-linked reactive polymer microparticles was used (Tg=49° C.) and implemented in the DiBenedetto equation, which relates Tg to conversion. However the assumption that the cross-linked reactive polymer microparticles have the same stoichiometry as in the feed (a/e ratio=1 in this particular case) was done.

The initial conversion is directly linked to the amount of the cross-linked reactive polymer microparticles added in the thermoset cross-linked network, so the shape of the curves become significantly different when high amount of microparticles are added (20 and 40 wt %). It appears that the rate of the reaction is decreased in the presence of high amounts of cross-linked reactive polymer microparticles (40 wt %) and that the maximum conversion is low. For lower amounts of the cross-linked reactive polymer microparticles an intermediate behaviour between the neat system and the highly filled system is observed, but without a clear trend of the cross-linked reactive polymer microparticles wt % impact on cure kinetics.

### DSC

The DSC was used to assess whether the cross-linked reactive polymer microparticles have an influence on the reactivity of the thermoset cross-linked network.

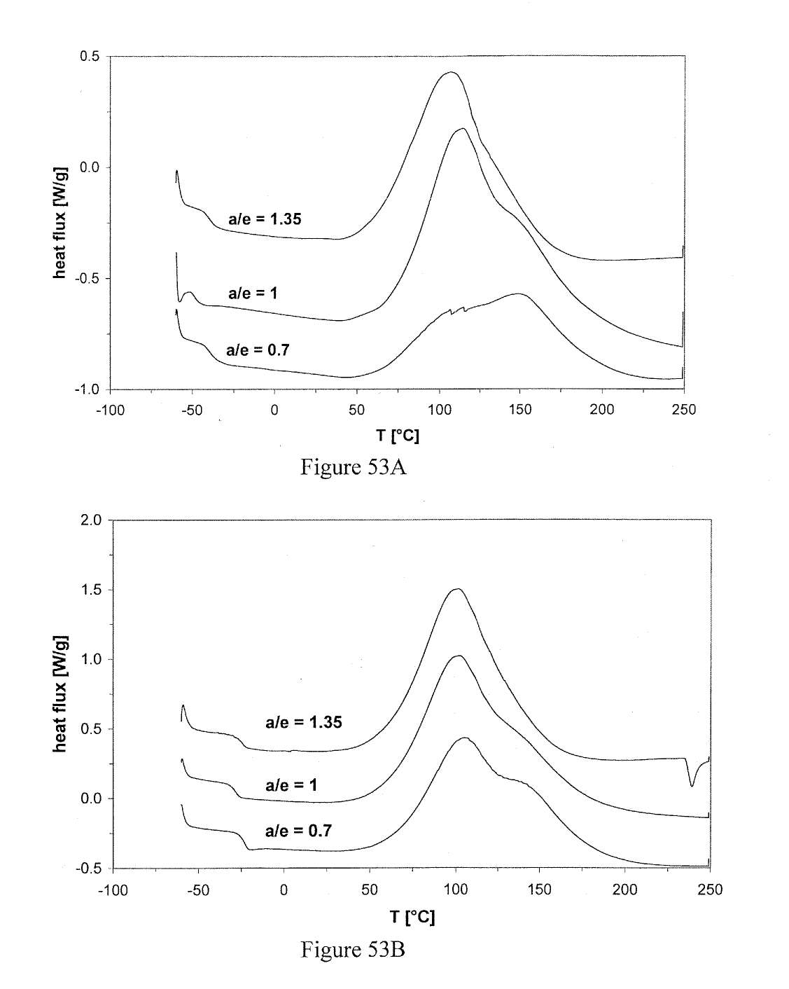

The reactivity was estimated from the value of the enthalpy of reaction, ΔH and temperature at the maximum of the peak. Value of the Tg measured during a second scan are also reported. FIG. 53 shows the comparison of the DSC signals obtained on neat curable epoxy system (diagram to the left) and a thermoset cross-linked network (curable epoxy system with the cross-linked reactive polymer microparticles—diagram to the right) systems (10 wt %), for different a/e ratio in the film. With an excess of amine groups a single broad peak is observed, for a molar amine to epoxy ratio a shoulder on the high temperature side (peaks at 100° C. and 150° C.) appears which is also retained by further increase of the epoxy content. This behaviour probably originates from the difference of reactivity between primary and secondary amine in the IPDA or from epoxy homopolymerization. In the presence of the cross-linked reactive polymer microparticles, the signal for a/e ratio=0.7 changes: first the DSC signal shows some noise near 100° C. and the magnitude of the two peaks is reversed. The peak at 150° C. is higher than the peak at 100° C.

The values of reaction heat (ΔH) are reported in Table 18. The values obtained for the thermoset cross-linked network are disproportionally lower than those for the neat curable epoxy system formulations.

TABLE 18
Exotherm of reaction as measured by DSC.

| | a/e ratio | | |
|---|---|---|---|
| | 0.7 | 1 | 1.35 |
| ΔH (J/gr) | 354 | 430 | 392 |
| Neat curable epoxy | | | |
| system system | | | |
| ΔH (J/gr) | 201 | 383-232 | 280 |
| thermoset cross- | | (2 tests) | |
| linked network | | | |
| (10 wt %, a/e ratio = 1) | | | |

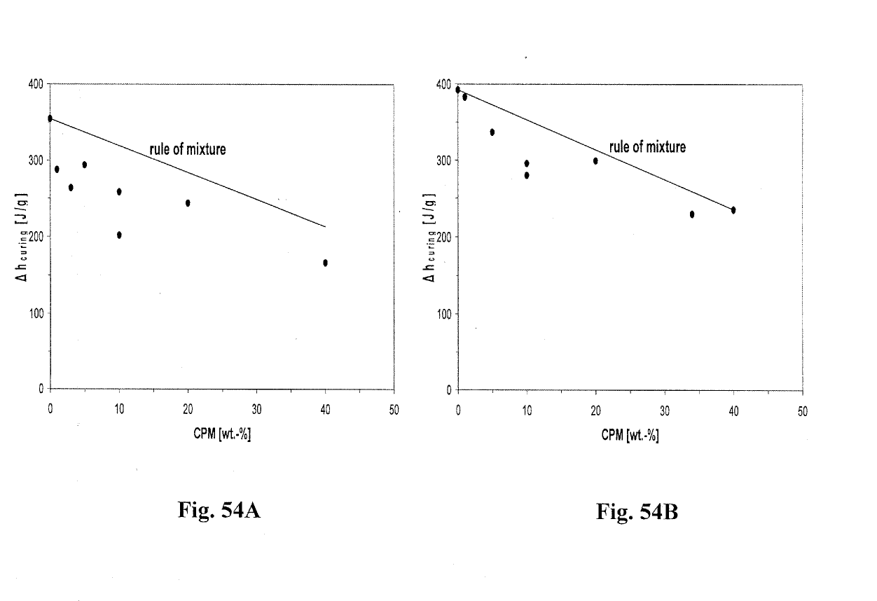

Similar experiments have been realized on other thermoset cross-linked network formulations. The plot of ΔH versus the amount of the cross-linked reactive polymer microparticles is reported FIG. 54. The trend is always the same: a decrease of ΔH with an increase of the cross-linked reactive polymer microparticles content, however this decease is not proportional to the cross-linked reactive polymer microparticles loading. Several reasons can be invoked to explain these results. First, the determination of the enthalpy is not very precise (small shifts in the base-line determination can change the enthalpy value). Secondly, the signal is very often noisy, in presence of cross-linked reactive polymer microparticles which can be attributed to the presence of the residual solvent. Finally, the reaction does not reach completion during the DSC scan; indeed it was showed previously that the reaction proceeds more slowly in presence of the cross-linked reactive polymer microparticles.

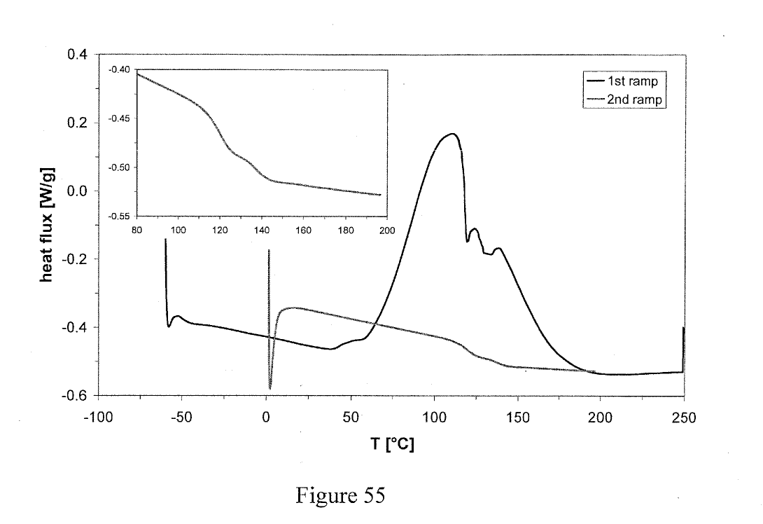

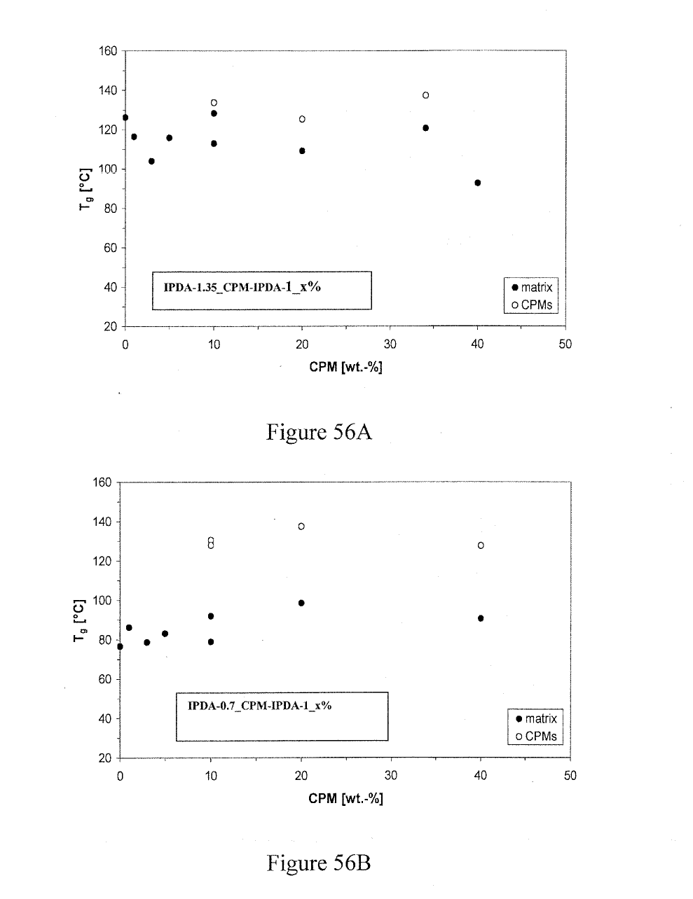

The second parameter obtained by DSC is the glass transition temperature of the cured thermoset cross-linked network, as taken from the second heating scan. In some eases (like different stoichiometry for the curable epoxy system and the cross-linked reactive polymer microparticles) and for content of cross-linked reactive polymer microparticles above 10 wt %, two glass transition can be observed on DSC thermograms and one example is presented in FIG. 55. The variation of Tg by changing the formulation and the cross-linked reactive polymer microparticles load are plotted in FIG. 56. From previous experiments, the Tg of post-cured IPDA-based cross-linked reactive polymer microparticles is around 130° C. and it is around this value that a second transition is found in the epoxy filled system (the first one originates from the cured matrix). The average values found for the curable epoxy system in the filled systems are close to the Tg of the neat curable epoxy system. They are scattered and are independent on the amount of filler added. The largest difference of Tg between curable epoxy system and cross-linked reactive polymer microparticles is the case where the curable epoxy system has an excess of epoxy (a/e ratio=0.7).

### Morphology of Thermoset Cross-Linked Networks

Visual Observation

Films of the thermoset cross-linked networks have a thickness about 100 μm and their width is 8.5 cm. All films are transparent, except for one highly filled network of Example 37 which appeared inhomogeneous and very brittle.

Optical Microscopy

Optical microscopy was used in order to assess the quality of the cross-linked reactive polymer microparticles dispersion in the thermoset cross-linked network. However, due to lack of contrast between the curable epoxy system and the thermoset cross-linked network (both are based on the same components (DGEBA+IPDA) and as a consequence have similar refractive index) it was difficult to observe individual particles. The cross-linked reactive polymer microparticles look homogeneously dispersed.

In order to observe better the presence of the cross-linked reactive polymer microparticles in the thermoset cross-linked network, formulations were cast on top of the glass slides. The thickness of dried films was about 30-50 pin. An increasing cross-linked reactive polymer microparticles density was observed from 1 to 10 wt % (FIG. 20).

When DAT-based cross-linked reactive polymer microparticles were utilized they were clearly visible in cured films using optical microscopy since the contrast between them and the curable epoxy system is higher. The cross-linked reactive polymer microparticles appear homogeneously dispersed but the thickness of the film hinders the identification of single particles. This analysis was only qualitative but it showed that no large agglomerates of the cross-linked reactive polymer microparticles presence in the thermoset cross-linked network.

Electron Microscopy

SEM observations of cryo-fractured surfaces were conducted in order to assess the presence of the cross-linked reactive polymer microparticles in the thermoset cross-linked networks and the quality of the interaction between the cross-linked reactive polymer microparticles and the curable epoxy system curable epoxy system.

The effect of the a/e ratio of the thermoset cross-linked network on the fracture surface is presented in FIGS. 57A-57C (thermoset cross-linked networks have a 10 wt % cross-linked reactive polymer microparticle loading). The fracture surface appears to be smooth if the curable epoxy system is prepared with a molar composition (IPDA-1) or with an excess of amine (IPDA-1.35): the cross-linked reactive polymer microparticles are not observable even at higher magnifications. Such surfaces are typical for brittle neat networks. On the contrary, the micrographs of the thermoset cross-linked network prepared with an excess of epoxy monomer (IPDA-0.7) showed a rough surface characterized by the presence of spherical shapes which is probably related to the propagation of fracture at the interface between the cross-linked reactive polymer microparticles and the curable epoxy system. It can be concluded that the a/e ratio of the curable epoxy system can have a strong effect on the morphology of the surface.

The effect of the cross-linked reactive polymer microparticles content on the fracture surface of the thermoset cross-linked networks was also investigated; two types of curable epoxy systems were considered, the first one based on a curable epoxy system prepared with an epoxy excess (IPDA-0.7), the second one based on a curable epoxy system prepared with an excess of amine (IPDA-1.35) which initially showed different fracture surfaces with 10 wt % cross-linked reactive polymer microparticle loading. The cross-linked reactive polymer microparticles were IPDA-based, with a/e ratio=1 in the initial feed of monomers.

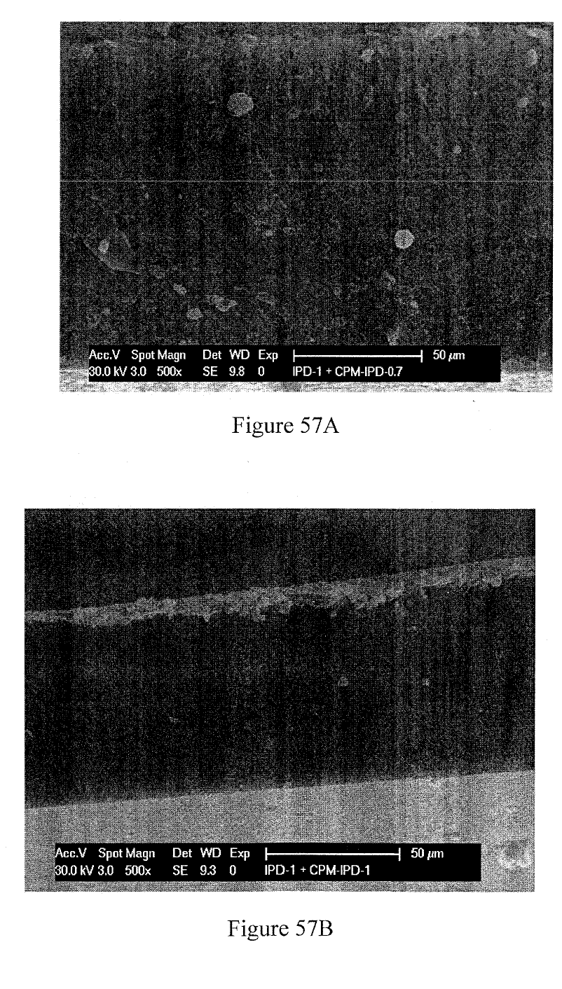

The micrographs obtained for the two highest contents of cross-linked reactive polymer microparticles are shown in FIGS. 58a-c for the curable epoxy system based on a/e ratio=0.7. For a cross-linked reactive polymer microparticle content of 20 wt %, more cross-linked reactive polymer microparticles and holes can be observed as compared to the thermoset cross-linked network filled with only 10 wt % of cross-linked reactive polymer microparticles. The fracture path follows mainly the cross-linked reactive polymer microparticle-curable epoxy system interface. Nevertheless, it is also possible to observe some features that seem related to a fracture through the cross-linked reactive polymer microparticles. For a cross-linked reactive polymer microparticle content of 40 wt %, the cross-linked reactive polymer microparticles (or the related holes) are present in abundance. It should be noted that the full special packing of network with cross-linked reactive polymer microparticles is not reached since the random packing of monodisperse spheres is of a factor of 50 vol %. The fracture propagates essentially through the curable epoxy system. In addition, the micrographs evidence a bad interaction between the cross-linked reactive polymer microparticles and the curable epoxy system. The interface between the cross-linked reactive polymer microparticles and the curable epoxy system is clearly defined. The surface of the cross-linked reactive polymer microparticles is wetted but is perfectly smooth (the corresponding holes as well): this can lead to the conclusion that the interaction between the cross-linked reactive polymer microparticles and 0.7 a/e ratio curable epoxy system is weak, although the curable epoxy system initially perfectly wetted these particles and the refracting index is the same.

When the thermoset cross-linked network is prepared with an excess of amine (a/e ratio=1.35) completely different fracture surfaces are observable. The cross-linked reactive polymer microparticles are no more so clearly visible, moreover they are no voids. The fracture travels through cross-linked reactive polymer microparticles, hence the interaction between cross-linked reactive polymer microparticles and the curable epoxy system appears to be very strong. In both cases (IPDA-0.7 and IPDA-1.5) the theoretical density of the cross-linked reactive polymer microparticles was calculated and compared to the experimental observation. The calculation was based on a homogeneous packing of spheres having a diameter of 4 μm. For a content of 40 wt % it gives 480 particles per a square of 100 μm. This value is close to the experimental ones. In addition the size of the cross-linked reactive polymer microparticles in the thermoset cross-linked networks is similar to their size at the end of the synthesis, meaning that no significant swelling of the cross-linked reactive polymer microparticles by the epoxy prepolymer or curing agent happens during the processing.

All filled thermoset cross-linked networks are transparent. The SEM experiments show that the cross-linked reactive polymer microparticles are well dispersed in the curable epoxy system; it is especially visible for high content of cross-linked reactive polymer microparticles, but it is believed that the situation is the same with low content of cross-linked reactive polymer microparticles. The molar ratio of the curable epoxy system (0.7 or 1.35) has a preponderant influence on the creation of a weak or strong interfacial interaction between the cross-linked reactive polymer microparticles and the curable epoxy system, and as a consequence the way the fracture propagates into the material is different. Since the composition of the cross-linked reactive polymer microparticles and the curable epoxy system is identical, the strong interaction between the curable epoxy system and the cross-linked reactive polymer microparticles can be viewed as embedding cross-linked reactive polymer microparticles into the curable epoxy system.

### Dynamic Mechanical Analysis

The dynamic solid state behavior modifications were studied depending on the cross-linked reactive polymer microparticle content and molar ratio of the curable epoxy system. Moreover the dynamic mechanical analysis allows a characterization of the degree of heterogeneity induced by the presence of the cross-linked reactive polymer microparticles in the curable epoxy system.

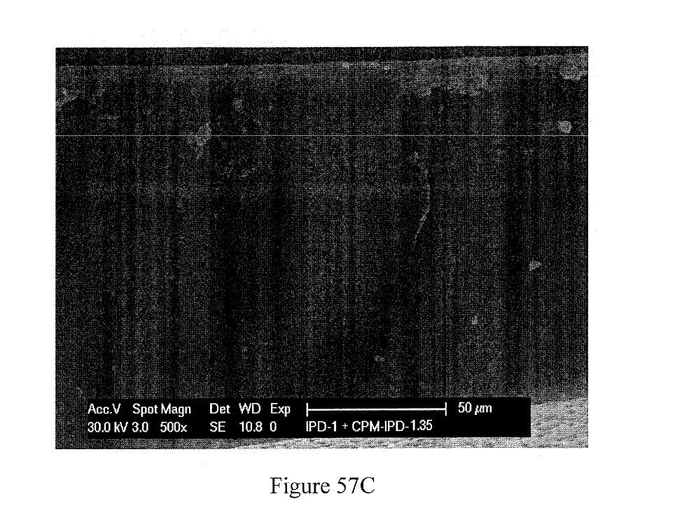

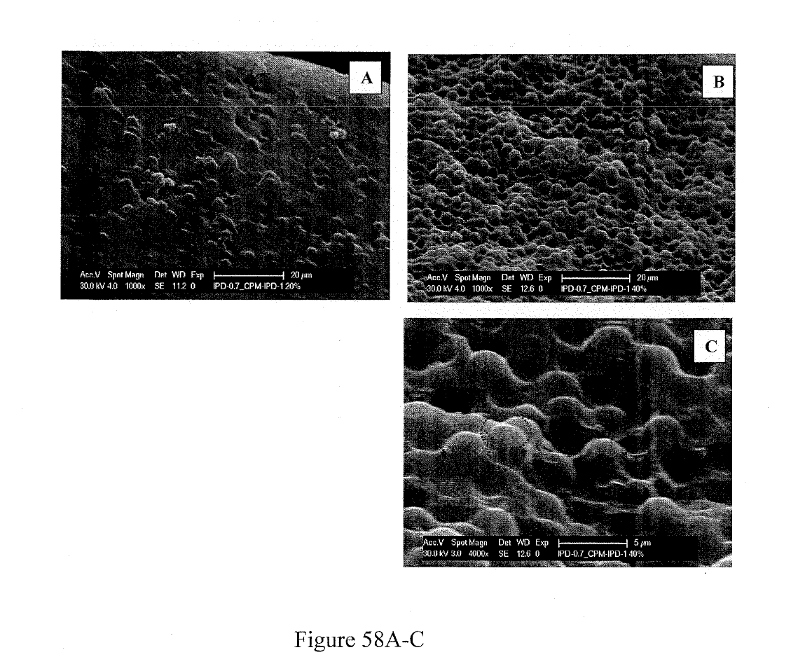

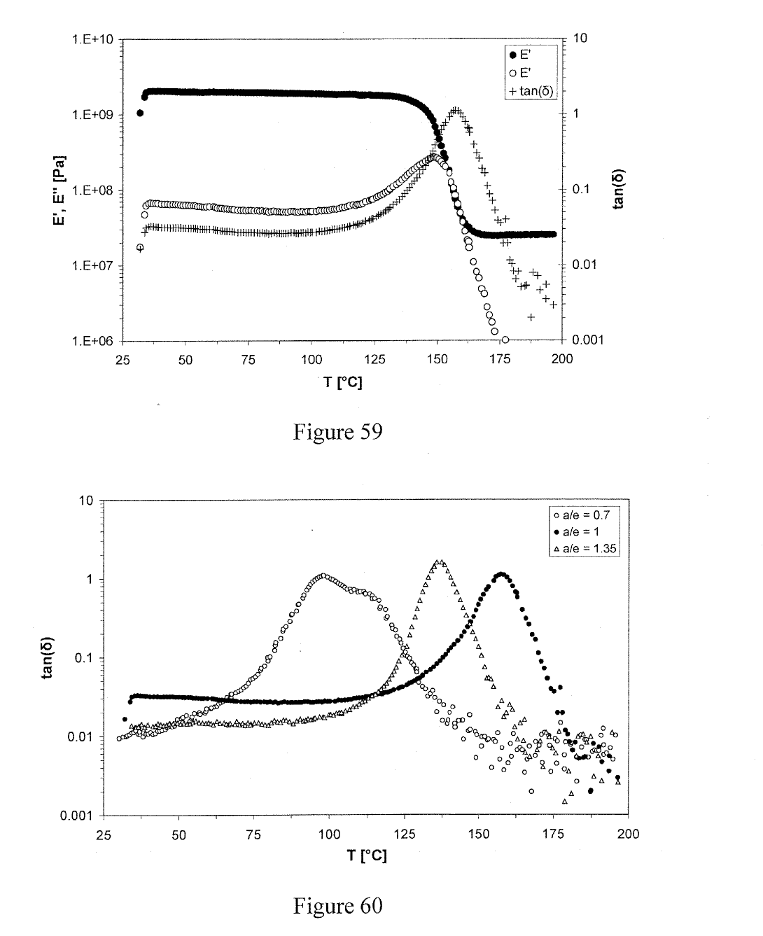

A typical example of such experiment is shown in FIG. 59 for a neat curable epoxy system (a/e ratio=1). Storage modulus (E′), loss modulus (E″) and loss factor (tan δ) are plotted as a function of temperature. The main transition, 6, corresponds to large molecular motions and is closely related to glass temperature region measured by DSC. Special interest is focused on the value of the temperature at the maximum of the loss factor, T_{δ}, and to the width of the loss factor measured at half height, ΔT which is related to the heterogeneity degree of the curable epoxy system.

Influence of stoichiometry on Neat Curable Epoxy Systems

As illustrated in FIG. 60 the a/e ratio of the curable epoxy system has a strong influence on the Tg transition. Analogous to the DSC data, Tg has a maximum for a molar composition, equal to 157° C., then it decreases and reaches 136° C. for an excess of amine (IPDA-1.35) and 98° C. for an excess of epoxy (IPDA-0.7). Moreover, in the latter case, the loss peak is broader because of a shoulder on the high temperature side, which is visible at 114° C. Such a behavior is not usual in neat epoxy networks which are homogeneous; indeed two peaks mean two distinct phases in the material as can be seen in thermoplastic/thermoset blends. What can be hypothesized is that with a high excess of DGEBA, all the amino groups react, then the residual epoxy may undergo etherification to a certain extent or epoxy homopolymerization during the curing cycle. This second type of reaction may lead to a formation of phase which has a different crosslink density as compared to the predominant epoxy-amine phase.

### Influence of Curable Epoxy System Stoichiometry in Thermoset Cross-Linked Networks

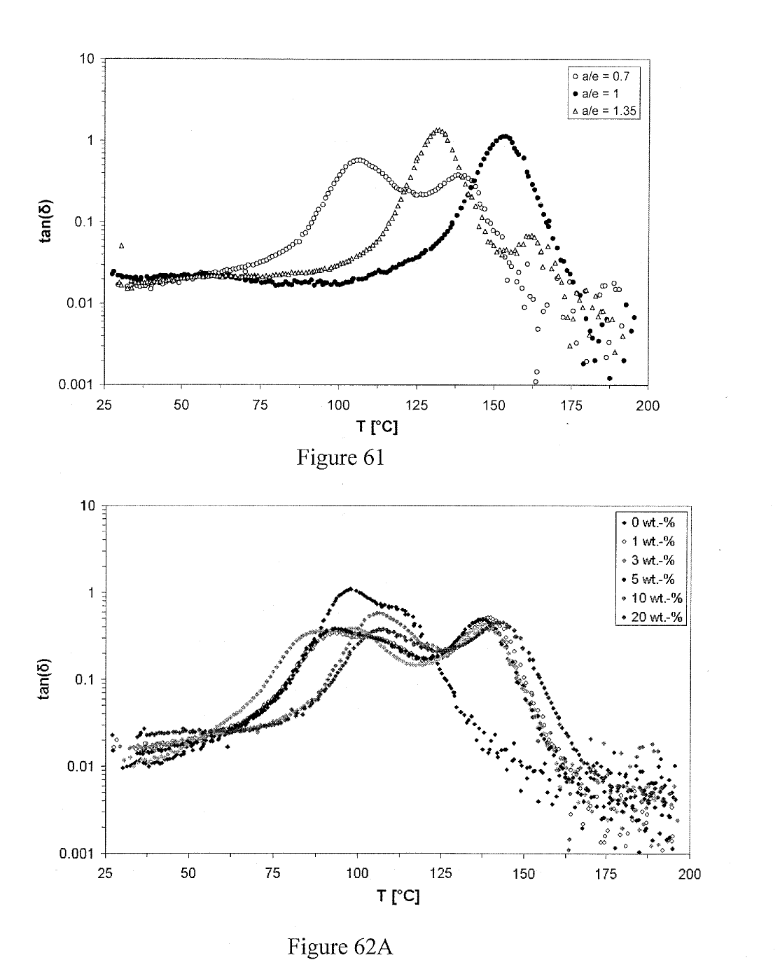

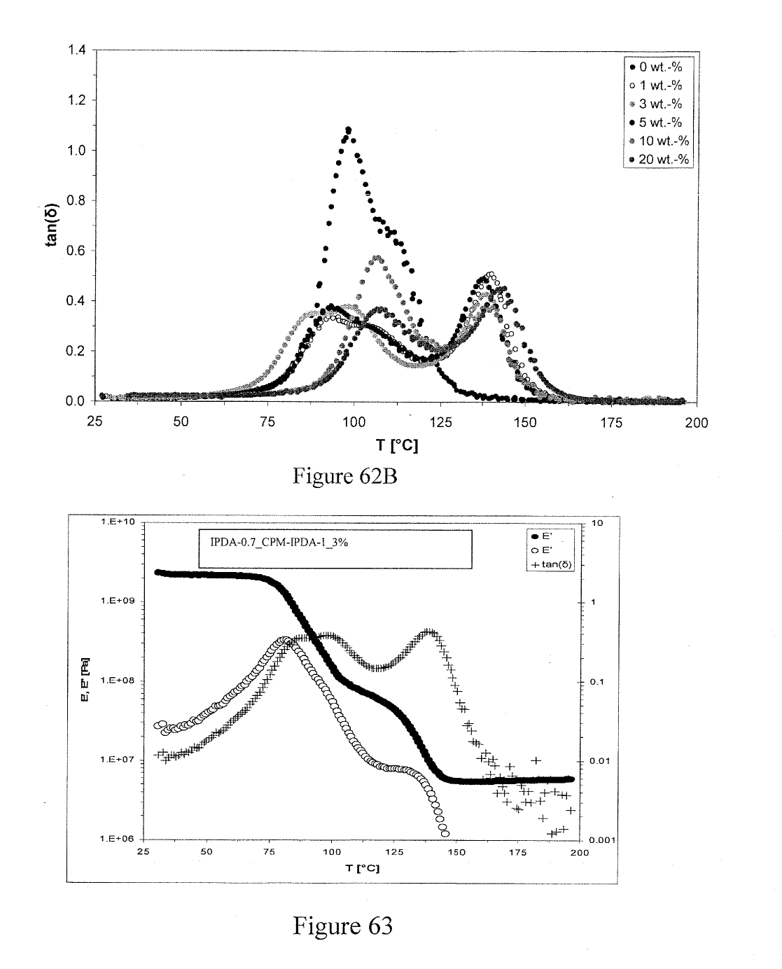

The influence of the addition of 10 wt % of cross-linked reactive polymer microparticles in the curable epoxy systems with the a/e ratio the same as neat epoxy networks is shown in FIG. 61. The initial value of Tg of these cross-linked reactive polymer microparticles is 51° C. and is 131° C. after full cure (as measured by DSC). When the curable epoxy system stoichiometry is 1, no significant effect of the cross-linked reactive polymer microparticles can be seen on the loss factor: the broadness of the transition looks similar to the neat curable epoxy system, probably due to the superimposing curable epoxy system transition to the transition of the cross-linked reactive polymer microparticles. When the curable epoxy system stoichiometry is 0.7, the transition due to cross-linked reactive polymer microparticles can be seen clearly as an additional peak appearing at T=138/139° C. while the main transition (originating from the curable epoxy system) remains very similar to the neat curable epoxy system. Interestingly, when the a/e ratio is 1.35 the Tg transition is expanded by a shoulder on the high temperature range. This transition is not visible for the neat curable epoxy system, thus it originates from the cross-linked reactive polymer microparticles.

Influence of the Content of Cross-Linked Reactive Polymer Microparticles added in the Thermoset Cross-Linked Network

The content of the cross-linked reactive polymer microparticles added in the thermoset cross-linked network was varied from 1 wt % to 40 wt %, in two types of curable epoxy systems: one prepared with an epoxy excess, the other one prepared with an amine excess. The results obtained by DMA are as follows.

IPDA-0.7 Based Formulation

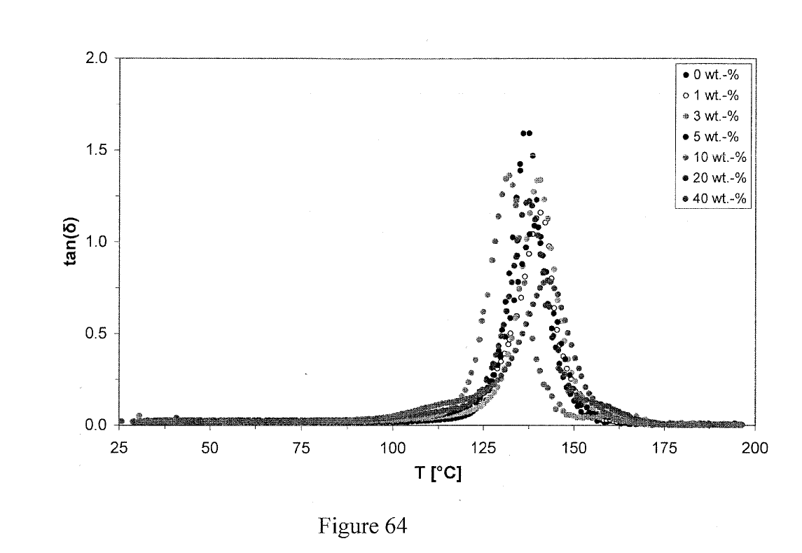

For the samples, the transition due to the cross-linked reactive polymer microparticles is visible on the graph of tan δ versus temperature (see FIGS. 64A-64B) always close to the same temperature. It is also very remarkable to see that the magnitude of these peaks is independent of the weight fraction of the cross-linked reactive polymer microparticles added. The same curves are shown on a linear scale too, the scale which is used to measure the width of the tan δ peak at mid-height. Even for low content of the cross-linked reactive polymer microparticles, the transition is visible. It is demonstrated in FIG. 63 for Example 33 in Table 15, which are also reported the variations of E′ and E″ as function of temperature. The drop of E′ shows two distinct steps, corresponding to the two transitions, before reaching the rubbery plateau at 5.5 MPa.

An additional feature in the spectra reported above is that in some cases the main transition (the one corresponding to the curable epoxy system) is modified. For low content of the cross-linked reactive polymer microparticles 5 wt %) the shape of the a peak looks like the one observed in the neat curable epoxy system, i.e. a broad peak with a shoulder. However its magnitude is strongly decreased, it is now close to 0.4 instead of 1.1 for the neat curable epoxy system. For higher content of the cross-linked reactive polymer microparticles (10 and 20 wt %) only a single and narrower transition is observed at T=106/107° C. For different networks of this series, the values of E′_{R}, T_{α}, ΔT_{α} and Tg are reported in Table 19. ΔTα reported in it correspond to the main a transition. Two groups can be distinguished: the group of the thermoset cross-linked network filled with a low content of the cross-linked reactive polymer microparticles which are the more heterogeneous, considering the ΔT_{α} of the main peak criteria; they have also low rubbery modulus (5.5 to 7.1 MPa), close to the value of the neat curable epoxy system, high content of the cross-linked reactive polymer microparticles narrows the main peak (even compared to the neat curable epoxy system), thermoset cross-linked networks they have high rubbery modulus (8.8 to 12.1 MPa) as compared to the neat curable epoxy system.

The increase of E′ with the weight fraction of the cross-linked reactive polymer microparticles was to be expected, since the cross-linked reactive polymer microparticles have a higher crosslink density than the curable epoxy system and therefore a higher rubbery modulus. The modulus of the thermoset cross-linked network is a result of combination of the two different phases (curable epoxy system and the cross-linked reactive polymer microparticles) and therefore two different Tα appear in DMA curves. Electron microscopy has also clearly demonstrated the existence of the two phases. Note that SEM of fracture surfaces show that the cross-linked reactive polymer microparticles were not fully embedded into curable epoxy system.

Looking at the heterogeneity of the filled network the most astonishing point is the strong effect of low amounts of cross-linked reactive polymer microparticles where the magnitude of the cross-linked reactive polymer microparticles transition seems independent on the wt %. Transitions as broad as ΔT=70° C. This is also extended to higher loading of the cross-linked reactive polymer microparticles.

TABLE 19
Characteristic parameters obtained from DMA curve
for Examples 32-37

| Cross-Linked | | | |
|---|---|---|---|
| Reactive Polymer | | | |
| Microparticles | Eᵣ | T_{α} | T_{g}, |
| [wt %] | [MPa] | [° C.] | [° C.] |
| 0 | 5.5 | 98.0 | / |
| 1 | 7.1 | 94.0 | 140.0 |
| 3 | 5.5 | 98.5 | 138.2 |
| 5 | 6.7 | 93.4 | 137.7 |
| 5 | 6.4 | 93.4 | 138.5 |
| 10 | 8.8 | 106.4 | 139.4 |
| 10 | 5.4 | 99.3 | 138.4 |
| 20 | 12.1 | 107.2 | 142.7 |

### IPDA-1.35 Based Formulation

The situation becomes very different when the curable epoxy system is prepared with an excess of amine. This curable epoxy system has a glass transition very close to the glass transition of the fully cured cross-linked reactive polymer microparticles, between 127 and 131° C. respectively (as determined by DSC). On the graphs shown in FIG. 64, one main transition can be seen, with a trend to a slight shift to higher temperature with an increasing amount of the cross-linked reactive polymer microparticles and simultaneously a decrease of the magnitude.

For the highest amount of cross-linked reactive polymer microparticles (20 and 40 wt % loading) an additional transition appears on the low temperature side of the loss factor peak, near T=110/112° C. which can be due to the presence of an interfacial zone around the cross-linked reactive polymer microparticles or of not fully cured thermoset cross-linked network. Electron microscopy of fracture surfaces has shown that the particles were broken and not de-bonded, meaning that only one phase is present in this case. With an amine excess in the curable epoxy system there is probably more diffusion of IPDA in the cross-linked reactive polymer microparticles and reaction with the epoxy group belonging to the cross-linked reactive polymer microparticles can take place. With higher loading level, the peak also appears to have a shoulder on the high Tg side as compared to the neat curable epoxy system (about T=160° C.) which can be attributed to swelling of the cross-linked reactive polymer microparticles and their reaction with epoxy and/or amine monomers resulting in the cross-linked reactive polymer microparticles embedding into the thermoset cross-linked network.

Values of E′_{R}, T_{α}, ΔT_{α} of the most prominent peak and Tg are reported in the Table 20. Except for the network filled with 40 wt % of the cross-linked reactive polymer microparticles, all networks show the same value of ΔTα of the main peak. In this series of cross-linked reactive polymer microparticle filled networks both curable epoxy system and cross-linked reactive polymer microparticles, as well as their interaction contribute to rubbery modulus. So the value of ˜10/12° C. must be compared to the values of 50 to 70° C. measured on the first series of filled networks (IPDA-0.7).

TABLE 20
Characteristic parameters obtained from DMA curve
for Examples 41-47

| Cross-Linked | | | |
|---|---|---|---|
| Reactive Polymer | | | |
| Microparticles | Eᵣ | T_{α} | ΔT_{α} |
| [wt %] | [MPa] | [° C.] | [° C.] |
| 0 | 15.1 | 136.7 | 10.0 |
| 1 | 20.0 | 140.7 | 11.0 |
| 3 | 13.7 | 140.1 | 11.1 |
| 5 | 15.5 | 139.5 | 8.8 |
| 10 | 14.8 | 132.0 | 11.1 |
| 20 | 17.1 | 137.5 | 12.0 |
| 40 | 15.0 | 142.5 | 16.3 |

Both formulations (with an excess of an amine and with an excess of the amine) show that the addition of the cross-linked reactive polymer microparticles has increased their modulus of elasticity. Additional peaks in the high Tg region for all cross-linked reactive polymer microparticles loaded thermoset cross-linked networks probably originate from the cross-linked reactive polymer microparticles. However, while in the case of epoxy excess, it is clear (also from SEM) that two distinct phases exist; the amine excess networks are consisting of only one phase. In addition, the high level of the cross-linked reactive polymer microparticles in the network brought about the a transition in the lower temperature range, probably due to uneven crosslinking (diffusion of monomers restricted due to high loading of the ‘filler’) as also shown via IR.

### Influence of the Cross-Linked Reactive Polymer Microparticle Composition on Mechanical Properties of Thermoset Cross-Linked Networks

Whether the procedure of cross-linked reactive polymer microparticles preparation has an influence on the thermoset cross-linked network properties and cure behavior has been studied. In this study, cross-linked reactive polymer microparticles were synthesized from DGEBA+IPDA in a mixture of solvents (PPG+10% dodecane) at different temperatures. The cross-linked reactive polymer microparticles synthesized from DGEBA+DAT in PPG at 130° C. were also utilized for this comparative study. The cross-linked reactive polymer microparticles were added in a curable epoxy system (IPDA-1).

### IPDA-Based Cross-Linked Reactive Polymer Microparticles

There is no strong effect of the addition of 10 wt % of the cross-linked reactive polymer microparticles in a thermoset cross-linked network, on the DMA spectra. Some parameters are given in Table 21. The cross-linked reactive polymer microparticles used in this set of experiments have an a/e ratio in the feed of the cross-linked reactive polymer microparticles of a/e ratio=1.35 (previously a/e ratio=1), the Tg of the cross-linked reactive polymer microparticles is close to 50° C. at the end of synthesis, and between 102° C. and 125° C. after post-curing.

For formulation with above described cross-linked reactive polymer microparticles (10 wt %) on a curable epoxy system with a/e ratio of 1, T_{α} is reduced of a few degrees as compared to the neat curable epoxy system and is between 149 to 153° C. This is the effect of the microparticles which have a lower Tg than the curable epoxy system.

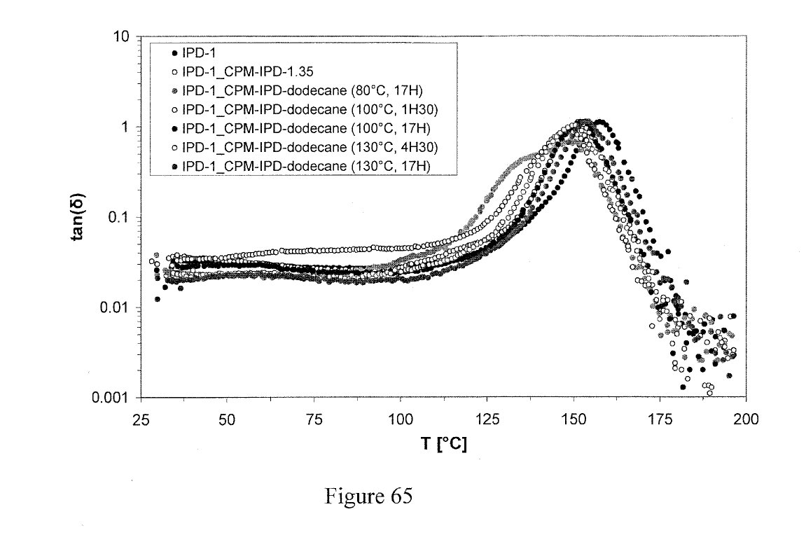

Overall impact of the cross-linked reactive polymer microparticles synthesis on the Tg transition of the curable epoxy system is reflected only in the modulus of elasticity. In addition, the FIG. 65 shows that if the cross-linked reactive polymer microparticles reacted at lower temperature and for shorter reaction time are utilized, the tan delta transition broadens.

TABLE 21
Characteristic parameters obtained from DMA curves,
network series IPDA-1, with different cross-linked
reactive polymer microparticles

| | Eᵣ | T_{α} | ΔT_{α} |
|---|---|---|---|
| Thermoset Cross-Linked Network | [MPa] | [° C.] | [° C.] |
| IPDA-1 (neat curable epoxy system) | 25 | 157 | 12 |
| IPDA-1 with cross-linked reactive polymer | 16 | 149 | 24 |
| microparticles of Example 19 | | | |
| IPDA-1 with cross-linked reactive polymer | 20.6 | 149 | 15 |
| microparticles of Example 21 | | | |
| IPDA-1 with cross-linked reactive polymer | 22.4 | 153 | 13.5 |
| microparticles of Example 23 | | | |
| IPDA-1 with cross-linked reactive polymer | 22.8 | 150 | 14.5 |
| microparticles of Example 22 | | | |
| IPDA-1 with cross-linked reactive polymer | 23.2 | 154 | 13 |
| microparticles of Example 24 | | | |
| IPDA-1 with cross-linked reactive polymer | 21.8 | 151 | 15.5 |
| microparticles of Example 10 | | | |
| IPDA-1 with cross-linked reactive polymer | 17.1 | 152 | 14.5 |
| microparticles of Example 12 | | | |

Cross-Linked Reactive Polymer Microparticles Synthesized from DAT

There is no strong effect of the addition of 10 wt % of DAT-based cross-linked reactive polymer microparticles on Tα of the thermoset cross-linked network, since the Tg of the cross-linked reactive polymer microparticles and of the curable epoxy system are very close: 153° C. and 157° C. (as determined via DSC). The tan delta transition is slightly broader: from 12° C. for the neat curable epoxy system to 14.5/15.5° C. for the thermoset cross-linked network of the mid peak height. Given that particles have a different composition from the curable epoxy system and are not fully integrated in the network structure it is interesting that there is no strong impact on the mechanical properties on epoxy network.

We claim:

1. A thermoset cross-linked network, comprising:
a reaction product of a curable epoxy system in a liquid phase and cross-linked reactive polymer microparticles in a solid phase, the cross-linked reactive polymer microparticles having a cross-link density and reactive groups that covalently react with the curable epoxy system to provide the thermoset cross-linked network in a single contiguous phase having a topological heterogeneity.

2. The thermoset cross-linked network of claim 1, where the curable epoxy system includes an epoxy resin and an amine hardener.

3. The thermoset cross-linked network of claim 2, where the reactive groups of the cross-linked reactive polymer microparticles are amine groups that react with the epoxy resin of the curable epoxy system.

4. The therrnoset cross-linked network of claim 1, where the topological heterogeneity includes a cross-link density of the reaction product of the curable epoxy system that is different than the cross-link density of the cross-linked reactive polymer microparticles.

5. The thermoset cross-linked network of claim 1, where the cross-linked reactive polymer microparticles and the curable epoxy system are formed from the epoxy resin and the amine hardener.

6. The thcrmoset cross-linked network of claim 1, where the thennoset cross-linked network includes 1 to 70 weight percent of the cross-linked reactive polymer microparticles.

7. The thermoset cross-linked network of claim 1, where the cross-linked reactive polymer microparticles are a reaction product of an epoxy resin and an amine curing agent reacted in dispersing media at a temperature of 50° C. to 120° C. for a reaction time of no greater than 17 hours, during which the cross-linked reactive polymer microparticles phase separate in a discrete non-agglomerated form from the dispersing media; and
dispersing media bound to the cross-linked reactive polymer microparticles of no greater than 0.001 weight percent based on the weight of the cross-linked reactive polymer microparticles.

8. The thermoset cross-linked network of claim 7, where the reaction product is formed with an excess of the amine curing agent or the epoxy resin as expressed in an equivalent weight ratio.

9. The composition of claim 8, where an excess of the amine curing agent is a 35 percent excess of amine curing agent to epoxy resin as expressed in the equivalent weight ratio.

10. The composition of claim 7, where the epoxy resin and the amine curing agent each have a concentration in the dispersing media of 5 to 30 weight percent based on the total weight of the dispersing media, the epoxy resin and the amine curing agent.

11. The composition of any one of the preceding claims, where the cross-linked reactive polymer mieroparticles include no surfactant.

12. A method of producing a thermoset cross-linked network, comprising:
reacting an epoxy resin with an amine curing agent in a dispersing media at a temperature of 50° C. to 120° C. for a reaction time of no greater than 17 hours so that the cross-linked reactive polymer micropartieles have no greater than 0.001 weight percent of the dispersing media bound to the cross-linked reactive polymer microparticles;
phase separating the cross-linked reactive polymer microparticles and the dispersing media; and
reacting a curable epoxy system in a liquid phase with the cross-linked reactive polymer microparticles in a solid phase, the cross-linked reactive polymer microparticles having a cross-link density and reactive groups that covalently react with the curable epoxy system to provide the thermosct cross-linked network in a single contiguous phase having a topological heterogeneity.

13. The method of claim 12, including removing the dispersing media from the cross-linked reactive polymer microparticles to leave no greater than 0.001 weight percent of the dispersing media bound to the cross-linked reactive polymer microparticles.

14. The method of claim 12, where reacting the epoxy resin with the amine curing agent includes forming the cross-linked reactive polymer micropartieles with an excess of the amine curing agent or the epoxy resin as expressed in an equivalent weight ratio.

15. The method of claim 12, where the curable epoxy system includes an epoxy resin and an amine hardener.

16. The method of claim 15, where the reactive groups of the cross-linked reactive polymer microparticles are amine groups that react with the epoxy resin of the curable epoxy system.

17. The method of claim 12, where forming the cross-linked reactive polymer microparticles is with a 35 percent excess of amine curing agent to epoxy resin as expressed in an equivalent weight ratio.

18. The method of claim 12, including using a solvent to remove the dispersing media from the cross-linked reactive polymer microparticles to leave no greater than 0.001 weight percent of the dispersing media bound to the cross-linked reactive polymer microparticles.

19. The method of claim 12, where each of the epoxy resin and the amine curing agent have a concentration in the dispersing media of 10 to 30 weight percent based on the total weight of the dispersing media, the epoxy resin and the amine curing agent.

20. The method of claim 12, including producing a bimodal size distribution of the cross-linked reactive polymer microparticles of a first diameter and a second diameter, the first diameter being from 100 to 300 nm and the second diameter being from 0.5 to 10 μm.

21. The method of claim 12, including not using a surfactant in producing the cross-linked reactive polymer microparticles.
